(19) United States
(12) Patent Application Publication
(10) Pub. No.: US 2025/0350720 A1
(43) Pub. Date: Nov. 13, 2025

(54) ENCODING METHOD, DECODING METHOD, BITSTREAM, ENCODER, DECODER AND STORAGE MEDIUM

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Fuzheng YANG, Dongguan (CN); Wenhan QIAO, Dongguan (CN); Ming LI, Dongguan (CN)

(21) Appl. No.: 19/269,624

(22) Filed: Jul. 15, 2025

Related U.S. Application Data
(63) Continuation of application No. PCT/CN2024/073348, filed on Jan. 19, 2024.

(30) Foreign Application Priority Data
Jan. 19, 2023 (CN) 202310141452.0

(51) Int. Cl. H04N 19/117; H04N 19/105; H04N 19/176; H04N 19/80

(52) U.S. Cl. CPC H04N 19/117; H04N 19/105; H04N 19/176; H04N 19/80

(57) ABSTRACT

A decoding method, applied to a decoder, includes: determining a first template of a current block, and determining a reference template and a reference block; in response to the reference template meeting a first preset condition, performing first processing on an adjacent region of the reference template to determine a matching template, and determining a model parameter according to the first template and the matching template; performing filtering processing on the reference block according to the model parameter to determine a filtered reference block; determining a prediction value of the current block according to the filtered reference block; and determining a reconstructed value of the current block according to the prediction value of the current block.

### CROSS-REFERENCE TO RELATED APPLICATIONS

This application is a Continuation application of International Application No. PCT/CN2024/073348 filed on Jan. 19, 2024, which claims priority to Chinese Patent Application No. 202310141452.0, filed with the China National Intellectual Property Administration on Jan. 19, 2023 and entitled “ENCODING AND DECODING METHOD, BITSTREAM, ENCODER, DECODER AND STORAGE MEDIUM”, the disclosure of which is incorporated herein by reference in its entirety.

### TECHNICAL FIELD

The present disclosure relates to the technical field of video encoding and decoding, and in particular, to an encoding and decoding method, a bitstream, an encoder, a decoder and a storage medium.

### BACKGROUND

An Intra Template Matching Prediction (Intra TMP) technique, through a template of a coding block, searches for a matching template that has the minimum cost relative to the template within a predefined search range in the current picture according to a preset cost function, and takes the best matched reconstructed block corresponding to the matching template as a prediction block of the current coding block.

However, in the actual coding process, typically, a reconstructed sample of the best matched reconstructed block is directly used as a prediction sample of the current coding block in the related art. Due to incomplete considerations, there may be a large deviation in some scenarios, resulting in low prediction accuracy.

### SUMMARY

The present disclosure provides an encoding and decoding method, a bitstream, an encoder, a decoder and a storage medium.

The technical solutions of the present disclosure may be implemented as follows.

In a first aspect, the embodiments of the present disclosure provide a decoding method. The decoding method is applied to a decoder and includes:
determining a first template of a current block, and determining a reference template and a reference block;
in response to the reference template meeting a first preset condition, performing first processing on an adjacent region of the reference template to determine a matching template, and determining a model parameter according to the first template and the matching template;
performing filtering processing on the reference block according to the model parameter to determine a filtered reference block;
determining a prediction value of the current block according to the filtered reference block; and
determining a reconstructed value of the current block according to the prediction value of the current block.

In a second aspect, the embodiments of the present disclosure provide an encoding method. The encoding method is applied to an encoder and includes:
determining a first template of a current block, and determining a reference template and a reference block;
in response to the reference template meeting a first preset condition, performing first processing on an adjacent region of the reference template to determine a matching template, and determining a model parameter according to the first template and the matching template;
performing filtering processing on the reference block according to the model parameter to determine a filtered reference block;
determining a prediction value of the current block according to the filtered reference block; and
determining a prediction residual of the current block according to the prediction value of the current block.

In a third aspect, the embodiments of the present disclosure provide a bitstream. The bitstream is generated by bit encoding according to information to be encoded; where the information to be encoded includes at least one of:
a prediction residual of a current block, a number of coefficients of a target filter, a shape of a target filter, a value of first syntax element flag information or a value of second syntax element flag information; where the first syntax element flag information is used for indicating whether intra template matching is applied to the current block, and the second syntax element flag information is used for indicating whether a filter model is applied to the current block.

In a fourth aspect, the embodiments of the present disclosure provide an encoder. The encoder includes a first determining unit, a first filtering unit and a first prediction unit; where
the first determining unit is configured to determine a first template of a current block, and determine a reference template and a reference block; and further configured to perform first processing on an adjacent region of the reference template in response to the reference template meeting a first preset condition, to determine a matching template, and determine a model parameter according to the first template and the matching template;
the first filtering unit is configured to perform filtering processing on the reference block according to the model parameter to determine a filtered reference block;
the first prediction unit is configured to determine a prediction value of the current block according to the filtered reference block; and
the first determining unit is further configured to determine a prediction residual of the current block according to the prediction value of the current block.

In a fifth aspect, the embodiments of the present disclosure provide an encoder. The encoder includes a first memory and a first processor; where
the first memory is configured to store a computer program executable on the first processor; and
the first processor is configured to perform the method as described in the second aspect when executing the computer program.

In a sixth aspect, the embodiments of the present disclosure provide a decoder. The decoder includes a second determining unit, a second filtering unit and a second prediction unit; where
the second determining unit is configured to determine a first template of a current block, and determine a reference template and a reference block; and further configured to perform first processing on an adjacent region of the reference template in response to the reference template meeting a first preset condition, to determine a matching template, and determine a model parameter according to the first template and the matching template;
the second filtering unit is configured to perform filtering processing on the reference block according to the model parameter to determine a filtered reference block;
the second prediction unit is configured to determine a prediction value of the current block according to the filtered reference block; and
the second determining unit is further configured to determine a reconstructed value of the current block according to the prediction value of the current block.

In a seventh aspect, the embodiments of the present disclosure provide a decoder. The decoder includes a second memory and a second processor; where
the second memory is configured to store a computer program executable on the second processor; and
the second processor is configured to perform the method described in the first aspect when executing the computer program.

In an eighth aspect, the embodiments of the present disclosure provide a non-transitory computer-readable storage medium, having a computer program stored thereon. The computer program, when executed, implements the method described in the first aspect, or implements the method described in the second aspect.

In a ninth aspect, the embodiments of the present disclosure provide a non-transitory computer-readable storage medium. The non-transitory computer-readable storage medium has a computer program and a bitstream stored thereon, and the computer program, when executed by a processor, enables the processor to perform the method described in the second aspect to generate the bitstream.

### BRIEF DESCRIPTION OF THE DRAWINGS

FIG. 1 is a schematic diagram of a prediction process of an Intra TMP technique.

FIG. 2 is a schematic flowchart diagram of an Intra TMP technique-based prediction.

FIG. 3A to FIG. 3F are schematic diagrams of template types of the Intra TMP technique.

FIG. 4A is a schematic block diagram of a composition of an encoder provided by the embodiments of the present disclosure.

FIG. 4B is a schematic block diagram of a composition of a decoder provided by the embodiments of the present disclosure.

FIG. 5 is a schematic diagram of a network architecture of a codec system provided by the embodiments of the present disclosure.

FIG. 6 is a schematic flowchart diagram of a decoding method provided by the embodiments of the present disclosure.

FIG. 7A to FIG. 7H are schematic diagrams of different sub-region partitions of a search region provided by the embodiments of the present disclosure.

FIG. 8 is a schematic flowchart diagram of an Intra Template Matching Prediction based on Filter-based Linear Model (Intra TMP-FLM) technique-based prediction provided by the embodiments of the present disclosure.

FIG. 9 is a schematic flowchart diagram of an Intra TMP technique-based search provided by the embodiments of the present disclosure.

FIG. 10A is a schematic diagram of a current block and parameter definition of its template provided by the embodiments of the present disclosure.

FIG. 10B is a schematic diagram of a reference block and padding of its template adjacent region provided by the embodiments of the present disclosure.

FIG. 11 is a schematic diagram of a template search region provided by the embodiments of the present disclosure.

FIG. 12 is a schematic diagram of a determining process for a specific search region provided by the embodiments of the present disclosure.

FIG. 13 is a schematic flowchart diagram of a search process provided by the embodiments of the present disclosure.

FIG. 14 is a schematic diagram of a shape of a filter provided by the embodiments of the present disclosure.

FIG. 15 is a schematic flowchart diagram of a process for calculating filter coefficients provided by the embodiments of the present disclosure.

FIG. 16A is a schematic diagram of a composition of filter coefficients provided by the embodiments of the present disclosure.

FIG. 16B is a schematic diagram of a composition of a prediction sample provided by the embodiments of the present disclosure.

FIG. 17 is a schematic diagram of another determining process for a specific search region provided by the embodiments of the present disclosure.

FIG. 18 is a schematic diagram of yet another determining process for a specific search region provided by the embodiments of the present disclosure.

FIG. 19 is a schematic diagram of still another determining process for a specific search region provided by the embodiments of the present disclosure.

FIG. 20 is a schematic flowchart diagram of an encoding method provided by the embodiments of the present disclosure.

FIG. 21 is a schematic diagram of a composition structure of an encoder provided by the embodiments of the present disclosure.

FIG. 22 is a schematic diagram of a specific hardware structure of an encoder provided by the embodiments of the present disclosure.

FIG. 23 is a schematic diagram of a composition structure of a decoder provided by the embodiments of the present disclosure.

FIG. 24 is a schematic diagram of a specific hardware structure of a decoder provided by the embodiments of the present disclosure.

FIG. 25 is a schematic diagram of a composition structure of an encoding and decoding system provided by the embodiments of the present disclosure.

### DETAILED DESCRIPTION

To provide a more detailed understanding of the features and technical content of the embodiments of the present disclosure, the implementations of the embodiments of the present disclosure will be described in detail below in conjunction with the accompanying drawings. The accompanying drawings are for reference and illustration only and not intended to limit the embodiments of the present disclosure.

Unless defined otherwise, all technical and scientific terms used herein have the same meaning as commonly understood by those skilled in the art belonging to technical field of the present disclosure. The terms used herein are for the purpose of describing the embodiments of the present disclosure only and not intended to limit the present disclosure.

In the following description, reference is made to “some embodiments”, which describe a subset of all possible embodiments. However, it is to be understood that “some embodiments” may be the same subset or different subsets of all possible embodiments and be combined with each other without conflict. It should also be noted that the terms “first\second\third” involved in the embodiments of the present disclosure are merely used to distinguish similar objects and do not represent a specific order for the objects. It is to be understood that “first\second\third” may, where permitted, interchange their specific order or sequence, so that the embodiments of the present disclosure described here can be implemented in an order other than that illustrated or described here.

Before further describing the embodiments of the present disclosure in detail, the nouns and terms involved in the embodiments of the present disclosure are described first. The nouns and terms involved in the embodiments of the present disclosure are applicable to the following interpretations:
Coding Block (CB);
Block Matching (BM);
Coding Unit (CU);
Block Vector (BV);
Sum of Absolute Difference (SAD);
Sum of Absolute Transformed Difference (SATD);
Mean Square Error (MSE);
Sum of Squared Differences (SSD);
Mean Absolute Deviation (MAD);
Mean Square Differences (MSD);
Normalized Correlation Coefficient (NCC);
H.266/Versatile Video Coding (VVC);
VVC reference software test platform (VVC test model, VTM);
Intra Template Matching Prediction (Intra TMP); and
Beyond VVC reference software test platform (enhanced compression model, ECM).

It is to be understood that in a video picture, a first color component, a second color component and a third color component are generally used to represent a coding block. The three color components are a luma component, a blue chroma component and a red chroma component, respectively. Exemplarily, the luma component is usually represented by a symbol Y, the blue chroma component is usually represented by a symbol Cb or U, and the red chroma component is usually represented by a symbol Cr or V. In this way, the video picture may be represented in YCbCr format or in YUV format.

It is also to be understood that Intra TMP is a special intra prediction mode, in which both an encoder and a decoder, through a template (T) of a coding block, search for a matching template (T_BEST) that has the minimum cost relative to the template (T) within a predefined search range in the current picture according to a preset cost function, where an offset of the best matched template relative to the template of the current coding block is the best block vector (BV_BEST), and then a reconstructed block (Ref Block) corresponding to the matching template is taken as a prediction block of the current coding block (Cur Block). The template of the coding block is usually selected from an adjacent reconstructed region of the current coding block.

For example, taking an adjacent reconstructed region of a current block as an example, as illustrated in FIG. 1, a region filled with dots represents the reconstructed region, a block filled with grids is the current block, and the adjacent region of the current block is a first template (T); a block filled with oblique lines is a reference block, and an adjacent region of the reference block is a second template (i.e., “reference template” or “matching template”, T_BEST); where an offset of the second template relative to the first template is the best block vector (BV_BEST), and then, block copying may be performed on the reference block to serve as a prediction block of the current block.

In the embodiments of the present disclosure, the preset cost function may be Sum of Absolute Difference (SAD), Sum of Absolute Transformed Difference (SATD), Mean Square Error (MSE), Sum of Squared Differences (SSD), Mean Absolute Deviation (MAD), Mean Square Differences (MSD), Normalized Correlation Coefficient (NCC) and so on, which is not specifically limited here.

For example, taking Sum of Absolute Difference (SAD) as an example, the cost function here is as follows:

$$S A D ( {T}_{i} ) = {\sum }_{m = 0}^{M - 1} \vert {T}_{i , m} - {T}_{m} \vert , m = 0 , 1 , … , M - 1 \qquad ( 1 )$$

Where Tᵢ is a template in a search process, and M represents the number of samples in the template.

The prediction process of the Intra TMP technique in the related art is introduced in detail below.

Input of the Intra TMP technique: a position of the current block (xTbCmp, yTbCmp), a width of the current block nTbW, and a height of the current block nTbH.

Output of the Intra TMP technique: a prediction value of the current block predSamples[x][y], where x=0 . . . nTbW−1, and y=0 . . . nTbH−1.

Exemplarily, the prediction process of the Intra TMP technique may be divided into four steps: determining a current template type, obtaining reconstructed samples (or referred to as pixels) of the current template, determining a block vector within a predefined search range, and generating a prediction value. In this way, the prediction value of the current block may be obtained through the above process. It should be noted that the Intra TMP technique may be used to predict the luma component, or may be used to predict the chroma component, which is not specifically limited here.

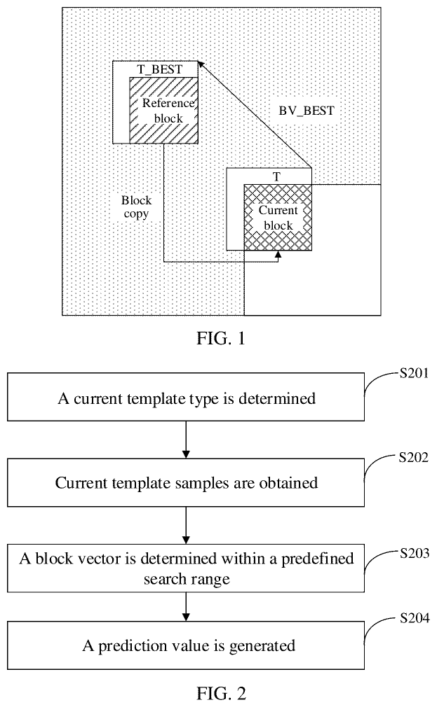

Referring to FIG. 2, a schematic flowchart diagram of an Intra TMP technique-based prediction process is illustrated. As illustrated in FIG. 2, the process may include the following.

In S201: a current template type is determined.

It should be noted that the Intra TMP technique searches for a matching template within a predefined search region using neighboring reconstructed samples of the current block as a template, where the neighboring reconstructed samples may be top reference samples, top-left reference samples, top-right reference samples, left reference samples and bottom-left reference samples of the current block, and so on. Therefore, according to the availability of the neighboring reconstructed samples, the template types could be classified and the corresponding template type could be determined.

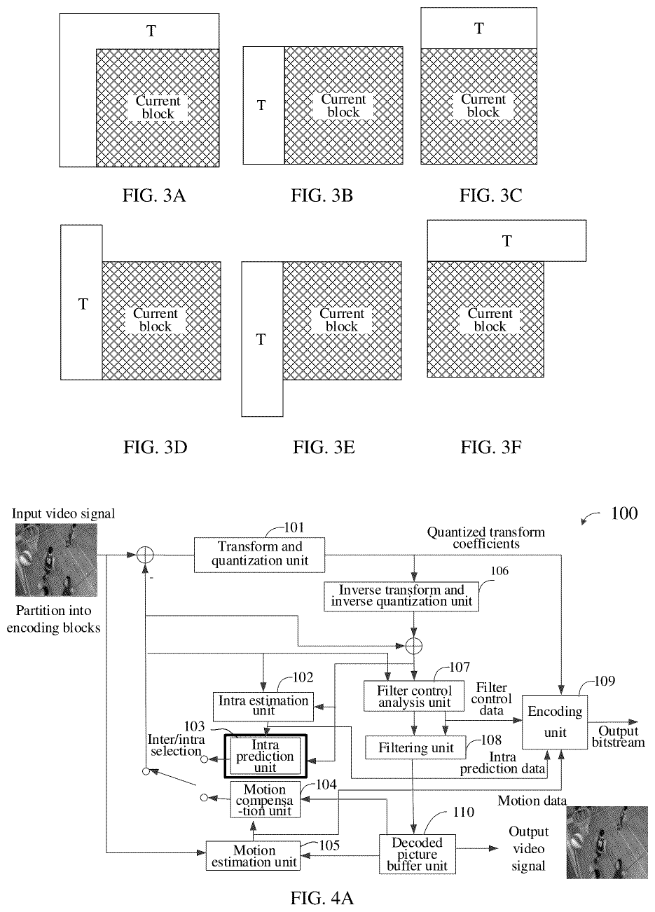

It should also be noted refTemplateType may be used to represent the template type. FIG. 3A to FIG. 3F illustrate schematic diagrams of template types of the Intra TMP technique. As illustrated in FIG. 3A to FIG. 3F, a block filled with grids is the current block, and an adjacent region of the current block is the template T, where six template types are illustrated here.

For example, the six template types are as follows:
when the top-left reference samples, the top reference samples and the left reference samples are all available, the value of refTemplateType is 1, and the template shape is as illustrated in FIG. 3A;
when only the left reference samples are available, the value of refTemplateType is 2, and the template shape is illustrated in FIG. 3B;
when only the top reference samples are available, the value of refTemplateType is 3, and the template shape is illustrated in FIG. 3C;
when only the left reference samples and the top-left reference samples are available, the value of refTemplateType is 4, and the template shape is illustrated in FIG. 3D;
when only the left reference samples and the bottom-left reference samples are available, the value of refTemplateType is 5, and the template shape is illustrated in FIG. 3E; or
when only the top reference samples and the top-right reference samples are available, the value of refTemplateType is 6, and the template shape is illustrated in FIG. 3F.

In S202: current template samples are obtained.

It should be noted that the template of the Intra TMP technique may be composed of reconstructed samples in one or more regions of the top side, top-right side, left side, bottom-left side and top-left side of the current block. In addition, the template size may be preset. For example, when obtaining the template at the left side, the template width templateW_size may be set to 4, and when obtaining the template at the top side, the template height templateH_size may be set to 4.

It should also be noted that which part of reconstructed samples to obtain may be determined according to the value of refTemplateType. For example, when the value of refTemplateType is 1, the reconstructed samples on the left, top-left and top sides of the current block are obtained; or when the value of refTemplateType is 2, only the reconstructed sample on the left four columns of the current block are obtained; or when the value of refTemplateType is 3, only the reconstructed sample on the top four rows of the current block are obtained.

In S203: a block vector is determined within a predefined search range.

It should be noted that the search process of the Intra TMP technique is mainly divided into: an initialization process, determining a search region of the template within the current picture (or frame), and searching and determining the best block vector in the search region.

It should also be noted that when searching for the best matched template in the search region, a search strategy of rough search followed by refined search may be adopted, or only refined search may be performed, or only rough search may be performed, which is not specifically limited here.

In the embodiments of the present disclosure, the rough search here may exemplarily be: determining the best rough matching template in the search region with a first preset step (e.g., 2), or determining the best rough matching template in the search region using a downsampling template (e.g., a downsampling factor of 2).

In the embodiments of the present disclosure, the refined search here may exemplarily be: determining the best refined matching template in the search region with a second preset step (e.g., 1), or determining the best refined matching template near the best rough matching template after completing the rough search.

In the embodiments of the present disclosure, the strategy of rough search followed by refined search may exemplarily be: determining the best rough matching template in the search region with a first preset step (e.g., 2), and then determining the best refined matching template with a second preset step (e.g., 1) near the best rough matching template.

In this way, after the above operations are completed, the best block vector BV_BEST (pX_BEST, pY_BEST) may be obtained, where pX_BEST and pY_BEST are the horizontal direction offset and the vertical direction offset of the best matched template relative to the template of the current block, respectively, and are also the horizontal direction offset and vertical direction offset of the best matched reconstructed block relative to the current block, respectively.

In S204: a prediction value is generated.

Here, this may be implemented with simple translation copy. The specific operation is as follows:

$$for x = 0 … nTbW - 1 , y = 0 … nTbH - 1 ; predSamples [ x ] [ y ] = recSamples [ x + pX\_BEST ] [ y + pY\_BEST ] \qquad ( 2 )$$

Where recSamples represents the reconstructed sample of the current picture.

In simple terms, in the related art, the Intra TMP technique, through the template of the current block, searches for the matching template that has the minimum cost relative to the template within the predefined search range in the current picture according to the preset cost function, and takes the best matched reconstructed block (Ref Block) corresponding to the matching template as the prediction block of the current block (Cur Block). The template of the current block may usually select from the adjacent reconstructed region of the current block.

However, in the actual coding process, in some cases, it is not an optimal solution in which the reconstructed sample of the best matched reconstructed block is directly used as the prediction sample of the current block in the related art. For example, when there is a linear illumination change between the best matched reconstructed block and the current block, if the reconstructed sample of the best matched reconstructed block is directly takes as the prediction sample of the current block, there will be a large deviation, resulting in low prediction accuracy and failure to achieve the best prediction effect.

Based on this, the embodiments of the present disclosure provides an encoding method, which includes: determining a first template of a current block and determining a matching template and a reference block; determining a model parameter according to the first template and the matching template; performing filtering processing on the reference block according to the model parameter to determine a filtered reference block; determining a prediction value of the current block according to the filtered reference block; and determining a prediction residual of the current block according to the prediction value of the current block.

The embodiments of the present disclosure also provides a decoding method, which includes: determining a first template of a current block and determining a matching template and a reference block; determining a model parameter according to the first template and the matching template; performing filtering processing on the reference block according to the model parameter to determine a filtered reference block; determining a prediction value of the current block according to the filtered reference block; and determining a reconstructed value of the current block according to the prediction value of the current block.

In this way, whether at the encoding side or the decoding side, the model parameter is determined by using the first template and the matching template, the model parameter fully reflects the correlation between the matching template and the first template of the current block, and the correlation is applied to the reference block, so that the reconstructed sample of the reference block is filtered and corrected, and then the filtered reconstructed sample is used as the predicted sample of the current block. As such, the prediction value of the intra template matching technique may be effectively corrected, so that the prediction accuracy is improved and bit rate is reduced, while the encoding and decoding efficiency may also be improved, thereby enhancing the encoding and decoding performance.

Various embodiments of the present disclosure will be described in detail below with reference to the accompanying drawings.

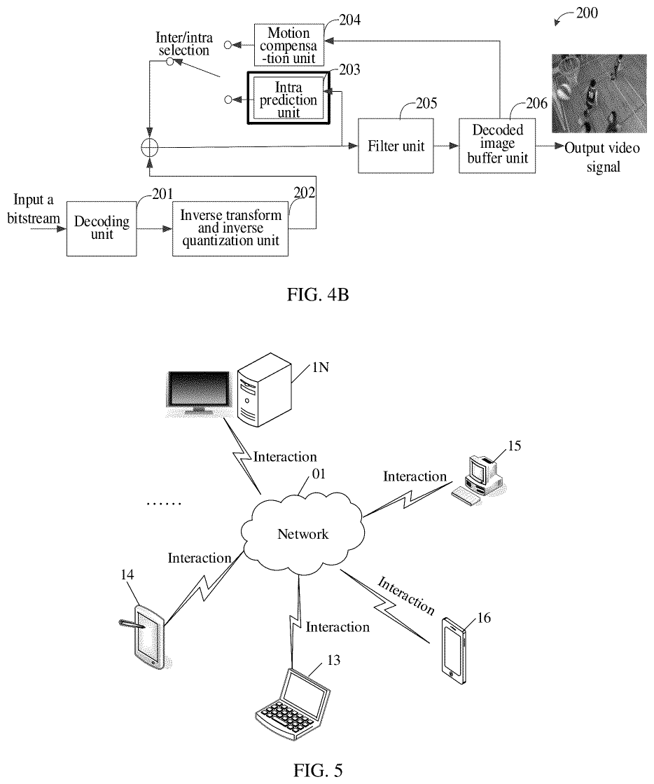

Referring to FIG. 4A, a schematic block diagram of a composition of an encoder according to the embodiments of the present disclosure is illustrated. As illustrated in FIG. 4A, the encoder (specifically, a “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, an encoding unit 109 and a decoded picture buffer unit 110, and so on. The filtering unit 108 may implement deblocking filtering and sample adaptive offset (SAO) filtering, and the encoding unit 109 may implement header information coding and context-based adaptive binary arithmetic coding (CABAC). For an input original video signal, one video coding block may be obtained through coding tree unit (CTU) partitioning, and then, residual pixel information of the video encoding block obtained through intra prediction or inter prediction may be transformed using the transform and quantization unit 101, which includes that residual information in a pixel domain is transformed into residual information in a transform domain, and an obtained transform coefficient is quantized to further reduce the bit rate. The intra estimation unit 102 and the intra prediction unit 103 are configured to perform intra prediction on the video encoding block. Exemplarily, the intra estimation unit 102 and the intra prediction unit 103 are configured to determine an intra prediction mode to be used to encode the video encoding block. The motion compensation unit 104 and the motion estimation unit 105 are configured to perform inter prediction encoding on a received video encoding block with respect to one or more blocks in one or more reference frames/pictures to provide time prediction information. The motion estimation performed by the motion estimation unit 105 is a process of generating a motion vector, and the motion vector may estimate the motion of the video encoding block, and then, the motion compensation unit 104 performs motion compensation based on the motion vector determined by the motion estimation unit 105. After the intra prediction mode has been determined, the intra prediction unit 103 is further configured to provide selected intra prediction data to the encoding unit 109, and the motion estimation unit 105 also transmits computed and determined motion vector data to the encoding unit 109. In addition, the inverse transform and inverse quantization unit 106 is configured to reconstruct the video encoding block, reconstruct a residual block in the pixel domain and provide the reconstructed residual block to the filter control analyzing unit 107 and the filtering unit 108, to remove a blocking artifact, and then, add the reconstructed residual block to a prediction block in a frame/picture in the decoded picture buffer 110, to produce a reconstructed video encoding block. The encoding unit 109 is configured to encode various coding parameters and quantized transform coefficients, context content in a CABAC-based coding algorithm may be based on a neighboring coding block, and the coding unit 109 may be further configured to encode information indicating the determined intra prediction mode and output a bitstream of the video signal. The decoded picture buffer 110 is configured to store the reconstructed video coding block for prediction reference. As video picture encoding progresses, new reconstructed video coding blocks are generated continuously, these reconstructed video coding blocks may all be stored in the decoded picture buffer 110.

Referring to FIG. 4B, a schematic block diagram of a composition of a decoder according to the embodiments of the present disclosure is illustrated. As illustrated in FIG. 4B, the decoder (specifically, a “video decoder”) 200 includes a decoding unit 201, an inverse transform and inverse quantization unit 202, an intra prediction unit 203, an motion compensation unit 204, a filtering unit 205, a decoded picture buffer unit 206, and so on. The decoding unit 201 may implement header information decoding and CABAC decoding. The filtering unit 205 may implement deblocking filtering and SAO filtering. After the input video signal has gone through encoding processing illustrated in FIG. 4A, a bitstream of the video signal is output. The bitstream is input to the decoder 200, and first goes through the decoding unit 201 to obtain decoded transform coefficients. The transform coefficients are processed by the inverse transform and inverse quantization unit 202, to generate a residual block in the pixel domain. The intra prediction unit 203 may be configured to generate prediction data of the current video decoding block based on the determined intra prediction mode and data of a decoded block from the current frame or picture. The motion compensation unit 204 is configured to determine prediction information used for the video decoding block by analyzing the motion vector and other associated syntax elements, and generate a prediction block of the video decoding block being decoded using the prediction information. The residual block from the inverse transform and inverse quantization unit 202 and the corresponding prediction block generated by the intra prediction unit 203 or the motion compensation unit 204 are summed to form a decoded video block. The decoded video signal is provided to the filtering unit 205 to remove a blocking artifact, which may improve video quality. Then, the decoded video block is stored in the decoded picture buffer unit 206, the decoded picture buffer unit 206 stores reference pictures used for subsequent intra prediction or motion compensation, and also is configured to output the video signal, that is, a recovering original video signal is obtained.

Further, the embodiments of the present disclosure further provide a network architecture of a codec system including an encoder and a decoder, and FIG. 5 is a schematic diagram of a network architecture of a codec system according to the embodiments of the present disclosure. As illustrated in FIG. 5, the network architecture includes one or more electronic devices 13 to 1N and a communication network 01, where the electronic devices 13 to 1N may perform video interaction through the communication network 01. During the implementation process, the electronic devices may be various types of devices having video encoding and decoding functions. For example, the electronic devices may include a smart phone, a tablet computer, a personal computer, a personal digital assistant, a navigator, a digital phone, a video phone, a television, a sensor device, a server, and so on, and the embodiments of the present disclosure do not impose specific limitations. Here, the decoder or encoder described in the embodiments of the present disclosure may be the electronic device mentioned above.

It should be noted that the methods in the embodiments of the present disclosure are mainly applied to the intra prediction unit 103 part as illustrated in FIG. 4A and the intra prediction unit 203 part as illustrated in FIG. 4B. That is, the embodiments of the present disclosure may be applied to the encoder, or may be applied to the decoder, or may even be applied to both the encoder and decoder at the same time; however, the embodiments of the present disclosure do not impose specific limitations.

It should also be noted that when the method is applied to the intra prediction unit 103 part, the “current block” exemplarily refers to an encoding block on which intra prediction is currently to be performed; and when the method is applied to the intra prediction unit 203 part, the “current block” exemplarily refers to a decoding block on which intra prediction is currently to be performed.

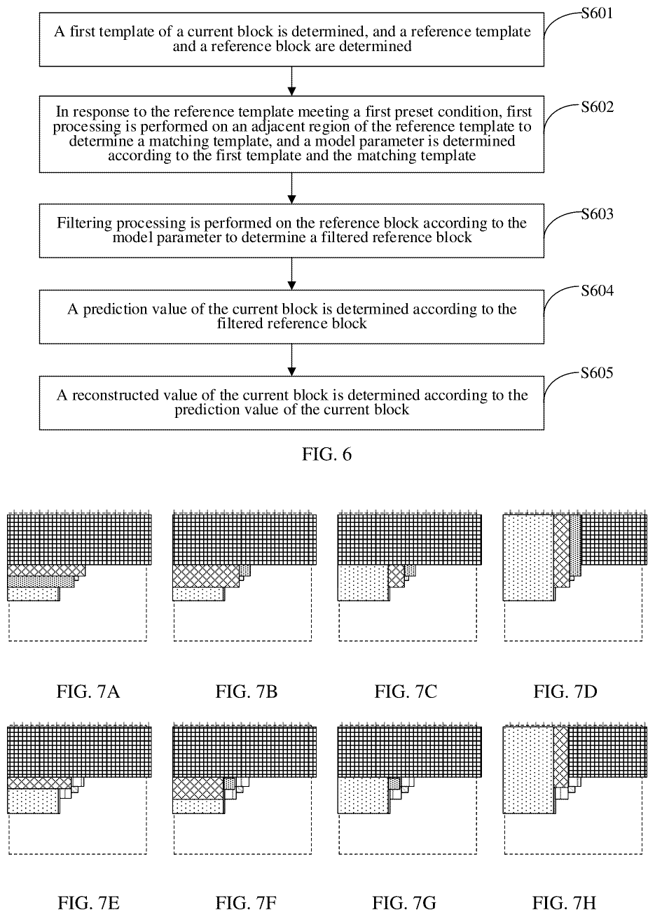

In an embodiment of the present disclosure, referring to FIG. 6, a schematic flowchart diagram of a decoding method provided by the embodiments of the present disclosure is illustrated. As illustrated in FIG. 6, the method may include the following.

In S601: a first template of a current block is determined, and a reference template and a reference block are determined.

It should be noted that the decoding method in the embodiments of the present disclosure is applied to a decoder. In addition, the decoding method may exemplarily refer to an intra prediction method, and more specifically, to an intra prediction method of an Intra Template Matching Prediction based on Filter-Based Linear Model (Intra TMP-FLM). A video picture may be partitioned into multiple decoding blocks, and the current block in the embodiments of the present disclosure refers to a decoding block in the video picture on which intra prediction is currently to be performed. In addition, the decoding method in the embodiments of the present disclosure may be used to predict both the luma component and the chroma component, which is not specifically limited here.

It should also be noted that, in the embodiments of the present disclosure, first, it is necessary to determine the first template of the current block, so as to determine the reference template and the reference block according to the first template. In some embodiments, the operation that the first template of the current block is determined may include:
determining a template type of the current block; and
determining the first template of the current block according to the template type of the current block.

The template type may be represented by refTemplateType. In some embodiments, determining the template type of the current block may include: determining the template type of the current block according to reference samples of the current block.

The reference samples of the current block include at least one of: left neighboring reference samples of the current block, top neighboring reference samples of the current block, top-left neighboring reference samples of the current block, bottom-left neighboring reference samples of the current block, or top-right neighboring reference samples of the current block.

That is, in the embodiments of the present disclosure, the reference samples of the current block are determined based on an adjacent reconstructed region of the current block. The adjacent reconstructed region of the current block includes at least one of: a left adjacent region, a top adjacent region, a top-left adjacent region, a bottom-left adjacent region or a top-right adjacent region. For example, the left neighboring reference samples of the current block may be determined by at least one column of reconstructed samples in the left adjacent region, the top neighboring reference samples of the current block may be determined by at least one row of reconstructed samples in the top adjacent region, the bottom-left neighboring reference samples of the current block may be determined by at least one column of reconstructed samples in the bottom-left adjacent region, and so on, which is not specifically limited here.

Further, according to the availability of the neighboring reference samples, the template types may be classified and the template type of the current block may be determined. In some embodiments, determining the template type of the current block may include:
determining that the template type of the current block is a first value in response to the left neighboring reference samples of the current block, the top neighboring reference samples of the current block and the top-left neighboring reference samples of the current block being all available;
determining that the template type of the current block is a second value in response to the left neighboring reference samples of the current block being available;
determining that the template type of the current block is a third value in response to the top neighboring reference samples of the current block being available;
determining that the template type of the current block is a fourth value in response to the left neighboring reference samples of the current block and the top-left neighboring reference samples of the current block being all available;
determining that the template type of the current block is a fifth value in response to the left neighboring reference samples of the current block and the bottom-left neighboring reference samples of the current block being all available; or
determining that the template type of the current block is a sixth value in response to the top neighboring reference samples of the current block and the top-right neighboring reference samples of the current block being all available.

In the embodiments of the present disclosure, the first value, the second value, the third value, the fourth value, the fifth value and the sixth value may be different. For example, the first value may be set to 1, the second value may be set to 2, the third value may be set to 3, the fourth value may be set to 4, the fifth value may be set to 5, and the sixth value may be set to 6. In addition, referring to FIG. 3A to FIG. 3F, these six template types are illustrated in detail.

In some embodiments, determining the first template of the current block according to the template type of the current block may include: obtaining template samples of the current block according to the template type of the current block and a corresponding template size; and determining the template samples of the current block as the first template of the current block.

In the embodiments of the present disclosure, the template size may be preset, or may be determined according to a size of the current block, or may even be related to the template type of the current block, which is not specifically limited here.

For example, if the template type indicates that only the left template is obtained, the template width templateW_size may be set to 4; and if the template type indicates that only the top template is obtained, the template height templateH_size may be set to 4.

In addition, it is possible to determine which part of the reconstructed samples may be obtained by the first template according to the value of the template type. For example, when the value of refTemplateType is 1, the reconstructed samples on the left, top-left and top sides of the current block are obtained; or when the value of refTemplateType is 2, only the reconstructed samples on the left four columns of the current block are obtained; when the value of refTemplateType is 3, only the reconstructed sample on the top four rows of the current block is obtained.

For the reference template and the reference block, in a possible implementation, the operation that the reference template and the reference block are determined may include: decoding a bitstream to determine a motion parameter; determining the reference block according to the motion parameter; and determining the reference template according to the first template and the reference block.

That is, the reference block of the current block may be determined according to the motion parameter (e.g., BV) obtained from decoding the bitstream, and the reference template may be determined by the reference block according to the first template of the current block.

For the reference template and the reference block, in another possible implementation, the operation that the reference template and the reference block are determined may include: performing template matching within a preset search region according to the first template to determine the reference template; and determining the reference block according to the reference template.

In some embodiments, performing the template matching within the preset search region according to the first template to determine the reference template may include: performing a search within the preset search region based on the first template to determine a target block vector, and determining the reference template according to the target block vector.

That is, the search may be performed within the preset search region according to the first template, and a matching template that has the minimum cost with the first template may be searched out according to a preset cost function. By traversing all search points within the preset search region, one or more candidate block vectors may be obtained, in which the one or more candidate block vectors may indicate one or more candidate matching templates; cost calculation is performed respectively on each of the one or more candidate matching templates with the first template of the current block; a search point with the minimum cost is obtained by comparison, in which its corresponding candidate block vector is the best block vector (i.e., the target block vector, BV_BEST); and its corresponding candidate matching template is the best matched template (i.e., the reference template described in the present embodiment, T_BEST); and the reference block may be determined according to the best matched template.

In the embodiments of the present disclosure, the preset cost function may be Sum of Absolute Difference (SAD), Sum of Absolute Transformed Difference (SATD), Mean Square Error (MSE), Sum of Squared Differences (SSD), Mean Absolute Deviation (MAD), Mean Square Differences (MSD), Normalized Correlation Coefficient (NCC) and so on, which is not specifically limited here.

It is to be understood that the search process within the preset search region may be implemented through rough search, or refined search, or rough search followed by refined search; and the details are as follows.

In a possible implementation manner, performing the search within the preset search region based on the first template to determine the target block vector may include: performing a first search within the preset search region to determine the target block vector.

In another possible implementation, performing the search within the preset search region based on the first template to determine the target block vector may include: performing a second search within the preset search region to determine the target block vector.

In yet another possible implementation, performing the search within the preset search region based on the first template to determine the target block vector may include: performing a first search within the preset search region to determine a first block vector, and determining an initial matching template according to the first block vector; and determining a first search region according to the initial matching template, and performing a second search within the first search region to determine the target block vector.

It is to be noted that, in the embodiments of the present disclosure, a search step corresponding to the first search is greater than a search step corresponding to the second search. For example, the search step corresponding to the first search is 2, and the search step corresponding to the second search is 1. Alternatively, a downsampling factor corresponding to the first search is greater than a downsampling factor corresponding to the second search. For example, the downsampling factor corresponding to the first search is 4, and the downsampling factor corresponding to the second search is 2. That is, the first search is the rough search, and the second search is the refined search. Any feature that as long as it can reflect that the first search is rougher than the second search is acceptable, which is not specifically limited here.

It should also be noted that when the first search is performed first and then the second search is performed, not only the search step corresponding to the first search is greater than the search step corresponding to the second search, but also the first search region is smaller than the preset search region. The first search region is a search region near the initial matching template. For example, a best rough matching template may be first determined in the preset search region with a step of 2; and then the best refined matching template (i.e., the final reference template) may be determined near the best rough matching template with a step of 1.

In yet another possible implementation, the preset search region may include at least one sub-search region, and performing the search within the preset search region based on the first template to determine the target block vector may include:
performing the search within each of the at least one sub-search region respectively, to determine a respective best block vector of each sub-search region and a respective matching cost value corresponding to each sub-search region;
determining a best block vector corresponding to a minimum matching cost value according to the respective best block vector of each sub-search region and the respective matching cost value corresponding to each sub-search region; and
taking the best block vector corresponding to the minimum matching cost value as the target block vector.

It should be noted that, in the embodiments of the present disclosure, the search region of the template of the current block may be a reconstructed part of the CTB where the current block is located, or may be other reconstructed CTB regions. The search region here is actually a set of all search points. Since a shape of the region is often not representable by a single rectangular region, in a specific implementation, the search may be performed in multiple rectangular regions, and then the final best reference block and best block vector are obtained by overall considering the search results of different regions.

Referring to FIG. 7A to FIG. 7H, schematic diagrams of different sub-region partitions of a search region provided by the embodiments of the present disclosure are illustrated. As illustrated in FIG. 7A to FIG. 7H, eight different sub-region partitioning manners are illustrated. The background block filled with back-diagonal is the current block; all the five partitioning manners in FIG. 7A to FIG. 7D and FIG. 7F illustrate that the search region is partitioned into four sub-search regions, and all the three partitioning manners in FIG. 7E, FIG. 7G and FIG. 7H illustrate that the search region is partitioned into three sub-search regions, where different filling patterns represent a sub-search region. All available search ranges are considered in FIG. 7A to FIG. 7D, and the regions directly above and directly left are not searched in FIG. 7E to FIG. 7H.

It should also be noted that, taking FIG. 7F as an example, the preset search region is partitioned into four sub-search regions, each sub-search region is represented by regionId, and a value of regionId may be equal to 0, 1, 2 and 3. According to a search point (iPosHor, iPosVer) in each sub-search region, that is, each block vector (BV) (consisting of horizontal and vertical components: (pX, pY), where pX=iPosHor-xTbCmp, pY=iPosVer-yTbCmp, then pX is between bvXMins and bvXMaxs, and pY is between bvYMins and bvYMaxs), the reference block that matches with the current block may be found in the reconstructed region, and the neighboring reconstructed samples of the reference block are the reference template. In this way, the matching cost between the first template of the current block and the reference template may be calculated, which is recorded as pDiff.

In this way, all search points in all search ranges (regionId=0, 1, 2, 3) are traversed, and a search point with the minimum matching cost pDiff is obtained by comparison, its corresponding matching cost is recorded as pDiff_BEST, its corresponding block vector is recorded as the best block vector BV_BEST (pX_BEST, pY_BEST), which is the target block vector described in the present embodiment, and its corresponding best matched template T_BEST is the reference template finally required.

In S602: in response to the reference template meeting a first preset condition, first processing is performed on an adjacent region of the reference template to determine a matching template, and a model parameter is determined according to the first template and the matching template.

It should be noted that, in the embodiments of the present disclosure, the model parameter may include coefficients of a target filter. In some embodiments, the method may further include: determining the coefficients of the target filter according to sample reference values in the first template and sample reference values in the matching template.

It should also be noted that, in the embodiments of the present disclosure, the matching template may include: samples in the reference template and samples in the adjacent region of the reference template.

In some embodiments, the method may further include: in response to samples outside the reference template being used, determining that the reference template meets the first preset condition. That is, if the reference template is at a boundary of a picture, then the samples outside the reference template need to be used, and specifically, for samples of the reference template close to the boundary, neighboring samples need to be used, where these neighboring samples may be outside the boundary. In this case, it is determined that the reference template meets the first preset condition, and then the first processing needs to be performed on the adjacent region of the reference template.

In some embodiments, in response to the reference template meeting the first preset condition, performing the first processing on the adjacent region of the reference template may include: in response to the samples outside the reference template being used, performing padding processing on samples in the adjacent region of the reference template.

In some embodiments, performing the padding processing on the samples in the adjacent region of the reference template may include:
determining whether the samples in the adjacent region of the reference template are available; and
in response to the samples in the adjacent region of the reference template being available, directly using the samples in the adjacent region of the reference template; or
in response to the samples in the adjacent region of the reference template being unavailable, performing the padding processing on the adjacent region of the reference template by copying reconstructed samples in a target matching template or a target reference block that are closest to the samples, to obtain samples in the adjacent region of the reference template.

In some embodiments, the samples in the adjacent region of the reference template being available may include at least one of:
the samples being within a boundary of a picture;
the samples being within a boundary of a tile; or
the samples having been reconstructed.

In some embodiments, performing the padding processing on the samples in the adjacent region of the reference template may include:
determining whether the samples in the adjacent region of the reference template exceed a preset search range; and
in response to the samples in the adjacent region of the reference template not exceeding the preset search range, directly using the samples in the adjacent region of the reference template; or
in response to the samples in the adjacent region of the reference template exceeding the preset search range, performing the padding processing on the adjacent region of the reference template by copying reconstructed samples in a target matching template or a target reference block that are closest to the samples, to obtain samples in the adjacent region of the reference template.

In some embodiments, the method may further include: in response to the reference template meeting a second preset condition, directly taking the reference template as the matching template, and performing the operation of determining the model parameter according to the first template and the matching template.

In some embodiments, the reference template meeting the second preset condition includes: the reference template not meeting the first preset condition.

In some embodiments, the reference template meeting the second preset condition includes at least one of:
the reference template not being at a boundary of a picture;
the reference template not exceeding a preset search range;
all samples in the reference template having been reconstructed;
samples in the reference template being in a same tile with the current block; or
no samples outside the reference template being used.

That is, in the embodiments of the present disclosure, if the samples in the adjacent region of the reference template need to be used, the padding processing needs to be performed on the samples in the adjacent region of the reference template.

It should also be noted that, in the embodiments of the present disclosure, the coefficients of the target filter may be determined by solving an optimization problem. Accordingly, in some embodiments, the method may further include: the coefficients of the target filter are coefficients used by the target filter when a first error between output values obtained after processing is performed on the sample reference values in the matching template by the target filter and the sample reference values in the first template meets a first condition.

It should be understood that, for the first error meeting the first condition, in a possible implementation, the first condition is that the first error is minimum. Alternatively, in another possible implementation, the first condition is that the first error is within a first preset threshold range. Alternatively, in yet another possible implementation, the first condition is that variation magnitude of the first error is within a second preset threshold range.

It should also be understood that both the first preset threshold range and the second preset threshold range are measurement criteria preset by the decoding side for determining whether the first error meets the first condition. In addition, the first error here may be Mean Square Error (MSE), or Sum of Square Error (SSE), or Sum of Absolute Difference (SAD), or Sum of Absolute Transformed Difference (SATD) after Hardman Variation, or Mean Absolute Error (MAE), and so on, which is not specifically limited in the embodiments of the present disclosure.

In some embodiments, determining the coefficients of the target filter according to the sample reference values in the first template and the sample reference values in the matching template may include:
determining an autocorrelation parameter according to the sample reference values in the matching template;
determining a cross-correlation parameter according to the sample reference values in the first template and the sample reference values in the matching template; and
determining the coefficients of the target filter according to the autocorrelation parameter and the cross-correlation parameter.

It should be noted that, in the embodiments of the present disclosure, a sample reference value includes at least one of: a sample reconstructed value, a sample gradient value or sample position information.

That is, in the embodiments of the present disclosure, the target filter serves as the filter model in the embodiments of the present disclosure, and the input information of the target filter is the sample reference values in the matching template. Here, the coefficients of the target filter may be represented by c_{k,l} which may also be called filter coefficients in the present embodiment. The input information for calculating the filter coefficients may be the available reconstructed samples in the matching template. Or, by calculating the gradient of each reconstructed sample in the matching template, including but not limited to the horizontal gradient, vertical gradient and so on, the calculated gradients may be used as the input information for calculating the filter coefficients. Or, the position information of each reconstructed sample may further be used as the input information for calculating the filter coefficients, where the position information may be absolute position information of each reconstructed sample in the entire picture, or relative position information of each reconstructed sample relative to a certain reference point, which is not specifically limited here.

In a specific embodiment, a reconstructed region R for calculating the filter coefficients is first determined, and then a set of filter coefficients may be derived by minimizing MSE between the reconstructed samples within the region R and the reconstructed samples within the first template, that is:

$$\begin{matrix}MSE = E [ {( predTemp [ i ] [ j ] - recTemp [ i ] [ j ] )}^{2} ] \\ = E [ {( {\sum }_{k , l = - 1 ∼ 1} {c}_{k , l} \cdot refTemp [ i + k ] [ j + 1 ] - recTemp [ i ] [ j ] )}^{2} ]\end{matrix} \qquad ( 3 )$$

Where refTemp[i][j] represents an input reconstructed sample value, recTemp[i][j] represents a reconstructed sample value of the template of the current block, (i, j) represents a coordinate position, (i, j)∈R, k and l represent a coordinate offset of the filter coefficient position relative to the filter center position, where k and l are between −1 and 1, a value of (k, l) may include (0, 0), (0, −1), (−1, 0), (0, 1), and (1, 0), and c_{k,l} represents a required filter coefficient. In addition, E represents an operation of calculating the mean, and then, the calculation equation is as follows:

$$MSE = \frac{1}{{N}_{p o s}} {\sum }_{i} {\sum }_{j} {\vert predTemp [ i ] [ j ] - recTemp [ i ] [ j ] \vert}^{2} \qquad ( 4 )$$

Where Nₚₒₛ refers to the number of pairs of (i, j) numbers participated in the calculation of |predTemp[i][j]−recTemp[i][j]|². For example, if there are 5 pairs of (i, j) numbers participated in the operation, then the value of Nₚₒₛ is equal to 5.

Further, the specific process of minimizing MSE to derive the filter coefficients is as follows.

First, find the partial derivative of c_{k,l} and set it to 0, that is:

$$\frac{\partial MSE}{\partial {c}_{m}} = E [ 2 ( {\sum }_{k , l = − 1 ∼ 1} {c}_{k , l} \cdot refTemp [ i + k ] [ j + l ] − recTemp [ i ] [ j ] ) \cdot refTemp [ i + m ] [ j + n ] ] \qquad ( 5 )$$

$$E [ 2 ( {\sum }_{k , l = − 1 ∼ 1} {c}_{k , l} \cdot refTemp [ i + k ] [ j + l ] − recTemp [ i ] [ j ] ) \cdot refTemp [ i + m ] [ j + n ] ] = 0 \qquad ( 6 )$$

Where k and l are between −1 and 1, and m and n are between −1 and 1.

Secondly, according to the equations (5) and (6), equation (7) is obtained as follows:

$${\sum }_{k , l = − 1 ∼ 1} {c}_{k , l} \cdot E ( repTemp [ i + k ] ⌈ j + l ] \cdot refTemp [ i + m ] [ j + n ] = E ( recTemp [ i ] [ j ] \cdot refTemp [ i + m ] [ j + n ] ) \qquad ( 7 )$$

Again, after determining the reconstructed region R, the obtained equation (7) is expanded into a matrix form as follows:

$$A \times [ \begin{matrix}{c}_{0 , 0} \\ {c}_{− 1 , 0} \\ ⋮ \\ {c}_{0 , 1}\end{matrix} ] = B \qquad ( 8 )$$

Where for A, the sample reference value in the matching template is represented by refTemp[i][j], and A represents the autocorrelation parameter of refTemp[i][j] as follows

$$( 9 )$$

$$A = [ \begin{matrix}\begin{matrix}E ( refTemp [ i ] [ j ] \cdot \\ refTemp [ i ] [ j ] )\end{matrix} & \begin{matrix}E ( refTemp [ i − 1 ] [ j ] \cdot \\ refTemp [ i ] [ j ] )\end{matrix} & … & \begin{matrix}E ( refTemp [ i ] [ j + 1 ] \cdot \\ refTemp [ i ] [ j ] )\end{matrix} \\ \begin{matrix}E ( refTemp [ i ] [ j ] \cdot \\ refTemp [ i − 1 ] [ j ] )\end{matrix} & \begin{matrix}E ( refTemp [ i − 1 ] [ j ] \cdot \\ refTemp [ i − 1 ] [ j ] )\end{matrix} & … & \begin{matrix}E ( refTemp [ i ] [ j + 1 ] \cdot \\ refTemp [ i − 1 ] [ j ] )\end{matrix} \\ ⋮ & ⋮ & ⋱ & ⋮ \\ \begin{matrix}E ( refTemp [ i ] [ j ] \cdot \\ refTemp [ i ] [ j + 1 ] )\end{matrix} & \begin{matrix}E ( refTemp [ i − 1 ] [ j ] \cdot \\ refTemp [ i ] [ j + 1 ] )\end{matrix} & … & \begin{matrix}E ( refTemp [ i ] [ j + 1 ] \cdot \\ refTemp [ i ] [ j + 1 ] )\end{matrix}\end{matrix} ]$$

For B, the sample reference value in the first template is represented by recTemp[i][j], and B represents the cross-correlation parameter between recTemp[i][j] and refTemp[i][j] as follows:

$$B = [ \begin{matrix}{\sum }_{i ∈ R} ( recTemp [ i ] [ j ] \cdot refTemp [ i ] [ j ] ) \\ {\sum }_{i ∈ R} ( recTemp [ i ] [ j ] \cdot refTemp [ i − 1 ] [ j ] ) \\ ⋮ \\ {\sum }_{i ∈ R} ( recTemp [ i ] [ j ] \cdot refTemp [ i ] [ j + 1 ] )\end{matrix} ] \qquad ( 10 )$$

That is, since the autocorrelation matrix of refTemp in the reconstructed region R and the cross-correlation vector between refTemp and recTemp are known quantities, the filter coefficients c_{k,l} may be calculated by solving the equation group shown in equation (7); and fixed-point quantization may be performed on the filter coefficients c_{k,l}, or fixed-point quantization may not be performed on the filter coefficients c_{k,l}.

In the embodiments of the present disclosure, for the target filter, it is further necessary to determine the number of the coefficients of the target filter and the shape of the target filter. The number of the coefficients of the target filter and the shape of the target filter may be preset fixed values or directly determined by decoding the bitstream.

In some embodiments, for the number of the coefficients of the target filter, the method may further include that the number of the coefficients of the target filter is equal to a first preset value.

In some embodiments, for the number of the coefficients of the target filter, the method may further include: decoding a bitstream to determine the number of the coefficients of the target filter.

It should be noted that the number of the coefficients of the target filter may be represented by nTap. For example, the value of nTap may be 4, 5, 6, 7, 8, 9 and so on, but is not specifically limited thereto.

It should also be noted that the number of the coefficients of the target filter may also be called the number of taps of the target filter. Here, the number of the coefficients of the target filter may be a preset constant value, or may be determined by decoding the bitstream, or may even be determined according to syntax element flag information of the current block.

In some embodiments, for the shape of the target filter, the method may further include that the target filter is a one-dimensional or two-dimensional filter with a preset shape.

In some embodiments, for the shape of the target filter, the method may further include: decoding a bitstream to determine a shape of the target filter.

In some embodiments, for the shape of the target filter, the method may further include: decoding a bitstream to determine a value of a filter shape parameter, where the filter shape parameter indicates the shape of the target filter.

It should be noted that the filter shape parameter may be represented by FilterIdx, and FilterIdx is used for indicating the shape of the target filter. For example, the shape of the target filter may be a diamond, a rectangle, a cross, a stripe, or even may be a one-dimensional filter, a two-dimensional filter and so on, but is not specifically limited thereto.

For example, if the value of FilterIdx is equal to 0, it is determined that the shape of the target filter is a diamond; if the value of FilterIdx is equal to 1, it is determined that the shape of the target filter is a cross; or if the value of FilterIdx is equal to 2, it is determined that the shape of the target filter is a rectangle.

It should also be noted that the shape of the target filter may be a preset shape, or may be determined by decoding the bitstream, or may even be determined according to the syntax element flag information of the current block.

In S603: filtering processing is performed on the reference block according to the model parameter to determine a filtered reference block.

In S604: a prediction value of the current block is determined according to the filtered reference block.

It should be noted that, in the embodiments of the present disclosure, after the model parameter is determined, the prediction value of the current block may be determined according to the model parameter and the reference block. Exemplarily, the filtering processing is performed on the reference block according to the model parameter, and then the prediction value of the current block is determined according to the filtered reference block.

In some embodiments, performing the filtering processing on the reference block according to the model parameter to determine the filtered reference block may include: performing the filtering processing on the reference block according to the model parameter to determine a first output value of the target filter; and determining the filtered reference block based on the first output value of the target filter.

In some embodiments, performing the filtering processing on the reference block according to the model parameter to determine the filtered reference block may include: in response to samples in the adjacent region of the reference block being used, performing padding processing on the samples in the adjacent region of the reference block. That is, in the embodiments of the present disclosure, the samples in the adjacent region of the reference block need to be used, then the padding processing needs to be performed on the samples in the adjacent region of the reference block.

In the embodiments of the present disclosure, the first output value of the target filter may be calculated according to the sample reconstructed values of the reference block and the coefficients of the target filter in the model parameter; then, according to the first output value of the target filter, the filtered reference block may be determined. The target filter here may be a linear filter model or a nonlinear filter model, which is not specifically limited.

In a possible implementation, determining, performing the filtering processing on the reference block according to the model parameter to determine the first output value of the target filter may include:
calculating a respective product of each sample reconstructed value of the reference block and a corresponding coefficient of the target filter; and
setting the first output value of the target filter to be equal to a sum of n products; where n represents the number of the coefficients of the target filter, and n is a positive integer.

It should be noted that, in the embodiments of the present disclosure, the target filter is a linear filter model. The first output value of the target filter may be calculated using the following equation:

$${Y}^{pred} [ i ] [ j ] = {\sum }_{k} {\sum }_{l} ref [ i + k ] [ j + l ] \times {C}_{k , l} \qquad ( 11 )$$

Where ref[i+k][j+1] represents the sample reconstructed value of the reference block, and C_{k,l} represents the coefficient of the target filter.

In another possible implementation, performing the filtering processing on the reference block according to the model parameter to determine the first output value of the target filter may include:
determining a respective first value of each sample reconstructed value of the reference block under a first mapping relationship;
calculating a respective product of the respective first value and a corresponding coefficient of the target filter; and
setting the first output value of the target filter to be equal to a sum of n products; where n represents the number of the coefficients of the target filter, and n is a positive integer.

It should be noted that, in the embodiments of the present disclosure, the target filter is a nonlinear filtering model. For example, when minimizing MSE of the filter coefficients, the calculation equation at this time is adjusted as follows:

$$\begin{matrix}MSE = E [ {( predTemp [ i ] [ j ] - recTemp [ i ] [ j ] )}^{2} \\ = E [ {( {\sum }_{k , l = - 1 ∼ 1} {c}_{k , l} \cdot {( refTemp [ i + k ] [ j + 1 ] )}^{2} - recTemp [ i ] [ j ] )}^{2} ]\end{matrix} \qquad ( 12 )$$

Then, the first output value of the target filter may be calculated by the following equation:

$${Y}^{pred} [ i ] [ j ] = {\sum }_{k} {\sum }_{l} {( ref [ i + k ] [ 1 + l ] )}^{2} \times {C}_{k , l} \qquad ( 13 )$$

Where ref[i+k][j+l] represents the sample reconstructed value of the reference block, and C_{k,l} represents the coefficient of the target filter.

It should also be noted that, in the embodiments of the present disclosure, determining the filtered reference block based on the first output value of the target filter may include: directly setting the first output value of the target filter as the filtered reference block; or may include: performing first filtering on the first output value of the target filter to obtain the filtered reference block. The first filtering here may be a low-pass filtering, an upsampling/downsampling filtering and so on, which is not specifically limited here.

It should also be noted that, in the embodiments of the present disclosure, after determining the first output value of the target filter, a first bias value (represented by bias) may be added to the first output value to determine the filtered reference block.

In some embodiments, determining the filtered reference block based on the first output value of the target filter may include: determining a first bias value; and performing addition operation according to the first output value and the first bias value to determine the filtered reference block.

In a possible implementation, determining the first bias value may include: setting the first bias value to be equal to a second preset value.

In another possible implementation, determining the first bias value may include: determining an (n+1)-th coefficient of the target filter in response to the number of the coefficients of the target filter being n; and determining the first bias value according to the (n+1)-th coefficient and a second bias value.

In the embodiments of the present disclosure, for the second bias value, the method may further include: setting the second bias value to be equal to a third preset value; or setting the second bias value to be equal to a value of a sample reconstructed value of the reference block under a second mapping relationship.

It should be noted that, in the embodiments of the present disclosure, the calculated filter coefficients are used as the number of taps corresponding to the filter template, that is, the number of filter coefficients is equal to the number of taps of the filter template (nTap). In addition, several biases may be added to the filter template, for example, in the embodiments of the present disclosure, when nTap=5, the filter coefficients are the tap coefficients corresponding to the filter template c₀ to c₄, and the prediction value of the position (i, j) in the filtered reference block is calculated as follows:

$${Y}^{pred} [ i ] [ j ] = {\sum }_{n = 0}^{4} ref [ k ] [ l ] \times {C}_{n} \qquad ( 14 )$$

And thus, the bias may be added as shown in the following equation:

$${Y}^{pred} [ i ] [ j ] = {\sum }_{n = 0}^{4} ref [ k ] [ l ] \times {C}_{n} + {C}_{5} \times Constant \qquad ( 15 )$$

In the embodiments of the present disclosure, cₙ=c_{i,j,k,l}. Here, Constant may be a fixed constant, such as Constant=1 (BitDepth−1), or may be a number related to the reconstructed sample value at the position (i, j) in the reference block, such as Constant=f(ref[i][j]), or may be a number related to the reconstructed sample value corresponding to a certain tap in the filter template other than position (i, j), such as Constant=f(ref[k][l]). Here, Constant=f(ref [i][j]) or Constant=f(ref[k][l]) may be a linear mapping relationship or a nonlinear mapping relationship. One or more biases may be added, which is not specifically limited here.

Further, in some embodiments, the operation that the prediction value of the current block is determining according to the filtered reference block may include: performing second processing on the filtered reference block to obtain the prediction value of the current block.

In the embodiments of the present disclosure, for the second processing, the second processing is to set the prediction value of the current block to be equal to the filtered reference block; or the second processing may be a clip operation of limiting the filtered reference block to a preset numerical range, or the second processing may be other operations, which are not specifically limited here.

Here, for the clip operation, the preset numerical range may be: a range between 0 and (1<<BitDepth)−1, where BitDepth represents a bit depth. If the value of the filtered reference block exceeds the preset numerical range, then a corresponding correction operation needs to be performed on the filtered reference block. For example, the filtered reference block may also be represented by Y^{pred}[i][j], and then, the correction operation may be performed on Y^{pred}[i][j]. The details are as follows:

```
  when the value of Y^{pred}[i][j] is less than 0, setting it to 0;
  when the value of Y^{pred}[i][j] is greater than or equal to 0 and less than or equal to
(1<<BitDepth)−1, setting it equal to Y^{pred}[i][j]; or
  when the value of Y^{pred}[i][j] is greater than (1<<BitDepth)−1, setting it to
(1<<BitDepth)−1.
```

In this way, after the correction operation is performed on Y^{pred}[i][j], it may be ensured that all sample values in the filtered reference block are between 0 and (1<<BitDepth)−1.

Further, the number of filter models may be expanded. In addition to establishing only one filter model, multiple filter models may also be established. Therefore, in some embodiments, the method may further include:
determining a plurality of groups of model parameters according to the first template and the matching template;
constructing a plurality of filter models according to the plurality of groups of model parameters, and performing the filtering processing on the reference block according to the plurality of filter models respectively, to determine a plurality of filtered reference blocks; and
determining the prediction value of the current block according to the plurality of filtered reference blocks.

In some embodiments, determining the plurality of groups of model parameters according to the first template and the matching template may include: classifying reconstructed samples in the first template and reconstructed samples in the matching template according to a preset manner respectively, to obtain a plurality of groups of sub-templates and a plurality of groups of sub-matching templates; and determining the plurality of groups of model parameters according to the plurality of groups of sub-templates and the plurality of groups of sub-matching templates.

It should be noted that, in the embodiments of the present disclosure, the preset manner here may be the magnitude of the reconstructed sample value, or may be the position information of the reconstructed sample, or may be the shape of the filter, and so on, which is not limited here. After classifying in the preset manner, a respective group of model parameters may be calculated according to each group of sub-templates and the corresponding sub-matching template, and each group of model parameters may determine one filter model, so that the multiple filter models may be constructed.

In a possible implementation, the method may further include: decoding a bitstream to determine a target model index value; determining a corresponding target filter from the plurality of filter models according to the target model index value; and performing the filtering processing on the reference block according to the target filter to determine the prediction value of the current block.

In another possible implementation, the filtering processing may be performed on the reference block according to the plurality of filter models respectively, to determine the plurality of filtered reference blocks. In some embodiments, determining the prediction value of the current block according to the plurality of filtered reference blocks may include: performing weighted calculation on the plurality of filtered reference blocks to determine the prediction value of the current block.

It should also be noted that, if the weight value of each filtered reference block is equal and equal to the reciprocal of the number of reference blocks, then the weighted calculation here may also be regarded as a mean calculation. In other words, mean operation is performed on the plurality of filtered reference blocks, to determine the prediction value of the current block.

For example, the input information for calculating the filter coefficients is classified, and a filter model is established for each category of input information, respectively. For example, when using the reconstructed information to establish a filter model, one possible implementation is to use the mean value of the reconstructed information for classification; and a filter model is established for the reconstructed information greater than the mean value and a filter model is established for the reconstructed information less than the mean value. Another possible implementation is to use the position of the reconstructed information for classification. For example, a first filter model may be established using the available reconstructed information on the left and top sides, and a second filter model may be established using the available reconstructed information on the left and top-left sides, and so on; and the encoder determines which model should be used. One possible decision implementation is that the encoder determines which model should be used by means of rate-distortion optimization and transmits the corresponding decoding parameter to the decoder, so that the decoder may clearly select which filter model to use. Another possible implementation is to use the shape of the filter for classification. Multiple filters with different shapes may be used and a respective filter model is established for each filter shape; and the encoder determines which filter shape should be used. One possible decision implementation is that the encoder determines which model should be used by means of rate-distortion optimization and transmits the corresponding decoding parameter to the decoder, so that the decoder may clearly select which filter model to use.

In S605: a reconstructed value of the current block is determined according to the prediction value of the current block.

It should be noted that, in the embodiments of the present disclosure, after determining the prediction value of the current block, the reconstructed value of the current block may further be restored. In some embodiments, the operation that the reconstructed value of the current block is determined according to the prediction value of the current block may include: decoding a bitstream to determine a prediction residual of the current block; and determining the reconstructed value of the current block according to the prediction value of the current block and the prediction residual of the current block.

In a specific embodiment, determining the reconstructed value of the current block according to the prediction value of the current block and the prediction residual of the current block may include: performing addition operation on the prediction value of the current block and the prediction residual of the current block, to determine the reconstructed value of the current block.

It should also be noted that, in the embodiments of the present disclosure, whether the intra template matching or the filter model is applied to the current block may be determined by different pieces of syntax element flag information. In some embodiments, the method may further include: decoding a bitstream to determine a value of first syntax element flag information; and
in response to the first syntax element flag information being used for indicating that intra template matching is applied to the current block, decoding the bitstream to determine a value of second syntax element flag information; and
in response to the second syntax element flag information being used for indicating that a filter model is applied to the current block, performing the operation of performing the filtering processing on the reference block according to the model parameter to determine the filtered reference block and the operation of determining the prediction value of the current block according to the filtered reference block.

Further, in some embodiments, the method may further include: in response to the second syntax element flag information being used for indicating that the filter model is not applied to the current block, taking the reconstructed sample value in the reference block as the prediction value of the current block.

In the embodiments of the present disclosure, for the first syntax element flag information, if the value of the first syntax element flag information is a first value, it is determined that the first syntax element flag information is used for indicating that the intra template matching is applied to the current block; or if the value of the first syntax element flag information is a second value, it is determined that the first syntax element flag information is used for indicating that the intra template matching is not applied to the current block.

In the embodiments of the present disclosure, for the second syntax element flag information, if the value of the second syntax element flag information is a first value, it is determined that the second syntax element flag information is used for indicating that the filter model is applied to the current block; or if the value of the second syntax element flag information is a second value, it is determined that the second syntax element flag information is used for indicating that the filter model is not applied to the current block.

It should be noted that, in the embodiments of the present disclosure, the first value and the second value are different, and the first value and the second value may be in a parameter form or in a digital form. Exemplarily, the first syntax element flag information and the second syntax element flag information may be parameters signalled (or referred to as written) into a profile, or may be the value of a flag, which is not specifically limited here.

For example, for the first value and the second value, the first value may be set to 1, and the second value may be set to 0; or the first value may be set to true, and the second value may be set to false, which is not specifically limited here.

It should also be noted that, in the embodiments of the present disclosure, it is determined whether the current block uses the filtered reference block as the final prediction value by certain conditions, but it is not limited to the following three manners. For example, the three manners may be as follows.

Manner 1: it is determined whether to perform filtering on the matching template by comparing the distortion between the matching template and the current block template (such as SAD, MSE, SATD, SSE) with a threshold T_Distortion1.

Manner 2: on the basis that Manner 1 meets the use of the filter model, it is determined whether to perform filtering on the reference block through the distortion between the filtered matching template and the template of the current block (such as SAD or MSE or SATD or SSE) and a threshold T_Distortion2.

Manner 3: the encoding side transmits a Flag to indicate whether to apply the filter model, in which tmpFlag indicates whether the intra template matching is applied to the current block, and filterFlag indicates whether the filter model is applied to the current block. When the value of tmpFlag is 1, the encoding side determines whether to perform filtering on the reference block by comparing the distortion between the filtered reference block (i.e., the reference block after filtering) and the current block and the distortion between the unfiltered reference block (i.e., reference block before filtering) and the current block, such as SAD or MSE or SATD or SSE. If the distortion after filtering is less than the distortion before filtering, the value of filterFlag is 1 and the filtered reference block is used as the prediction block of the current block; otherwise, the value of filterFlag is 0 and the unfiltered reference block is used as the prediction block of the current block, and the encoding side transmits filterFlag to the decoding side. There are many implementations for the encoding of filterFlag. One possible implementation is to use equal-probability encoding; and another possible implementation is to use context encoding, where a default context initial state and context update rate may be used, or the context initial state and context update rate may be determined by statistics.

The present embodiment provides a decoding method, which includes the following operations. The first template of the current block is determined, and the matching template and the reference block are determined; the model parameter is determined according to the first template and the matching template; the filtering processing is performed on the reference block according to the model parameter to determine the filtered reference block; the prediction value of the current block is determined according to the filtered reference block; and the reconstructed value of the current block is determined according to the prediction value of the current block. In this way, the model parameter is determined according to the first template and the matching template, the model parameter fully reflects the correlation between the matching template and the first template of the current block, the correlation is applied to the reference block, and then, by performing filtering and correction on the reconstructed sample of the reference block, the filtered reconstructed sample is used as the prediction sample of the current block. As such, the prediction accuracy may be improved and bit rate may be reduced, while the encoding and decoding efficiency may also be improved, thereby enhancing the encoding and decoding performance.

In another embodiment of the present disclosure, based on the decoding method described in the above embodiments, in the prediction process of the Intra TMP technique, it is proposed to correct the best matched reconstructed block (i.e., the reference block) and take the corrected reconstructed sample as the prediction sample of the current block. Exemplarily, a linear filtering model is established using the samples of the matching template and the samples of the template of the current block, and applied to the reference block, and the filtered samples are used as the final prediction sample. The technical solution of the embodiments of the present disclosure may be called Intra Template Matching based on Filter-based linear model (Intra TMP-FLM).

The prediction process of the Intra TMP-FLM technique is introduced in detail below.

Input of the Intra TMP-FLM technique: a position of the current block (xTbCmp, yTbCmp), a width of the current block nTbW, and a height of the current prediction block nTbH.

Output of Intra TMP-FLM technique: a prediction value of the current block predSamples[x][y], where x=0 . . . nTbW−1, and y=0 . . . nTbH−1.

Exemplarily, the prediction process of the Intra TMP-FLM technique may be devided into five steps: determining a current template type, obtaining reconstructed samples of the current template, determining a block vector within a predefined search range, establishing a linear filter model, and generating a prediction value. It should be noted that the Intra TMP-FLM technique may be used to predict the luma component, or may be used to predict the chroma component, which is not specifically limited here.

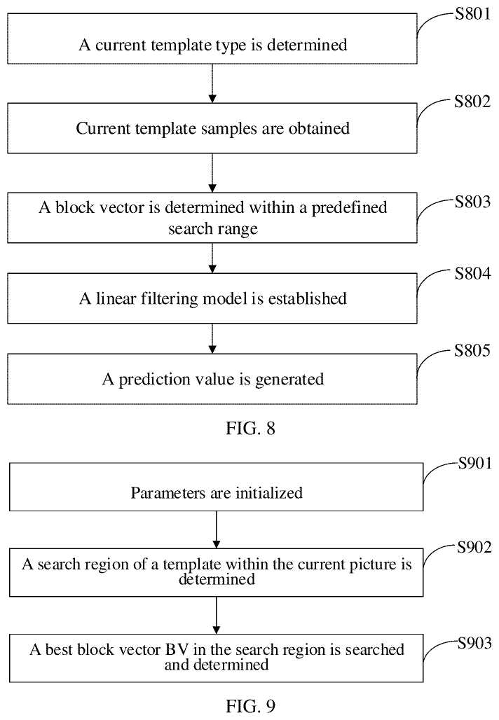

Referring FIG. 8, a schematic flowchart diagram of an Intra TMP-FLM technique-based prediction process provided by the embodiments of the present disclosure is illustrated. As illustrated in FIG. 8, the process may include the following.

In S801: a current template type is determined.

It should be noted that the Intra TMP-FLM technique searches for a matching template within a predefined search region using neighboring reconstructed samples of the current block as a template, where the neighboring reconstructed samples may be top reference samples, top-left reference samples, top-right reference samples, left reference samples and bottom-left reference samples of the current block, and so on. Therefore, according to the availability of the neighboring reconstructed samples, the template types could be classified and the corresponding template type could be determined.

It should also be noted that refTemplateType may be used to represent the template type. As illustrated in FIG. 3A to FIG. 3F, a block filled with grids is the current block, and an adjacent region of the current block is the template T. Six template types are shown here.

For example, the six template types are as follows:
when the top-left reference samples, the top reference samples and the left reference samples are all available, the value of refTemplateType is 1, and the template shape is as illustrated in FIG. 3A;
when only the left reference samples are available, the value of refTemplateType is 2, and the template shape is illustrated in FIG. 3B;
when only the top reference sample is available, the value of refTemplateType being 3, and the template shape is illustrated in FIG. 3C;
when only the left reference samples and the top-left reference samples are available, the value of refTemplateType is 4, and the template shape is illustrated in FIG. 3D;
when only the left reference samples and the bottom-left reference samples are available, the value of refTemplateType is 5, and the template shape is illustrated in FIG. 3E; or
when only the top reference samples and the top-right reference samples are available, the value of refTemplateType is 6, and the template shape is illustrated in FIG. 3F.

In S802: current template samples are obtained.

It should be noted that the template of Intra TMP-FLM technique may be composed of reconstructed samples in one or more regions of the top side, top-right side, left side, bottom-left side and top-left side of the current block. In addition, the template size may be preset. For example, when obtaining the template at the left side, the template width templateW_size may be set to 4, and when obtaining the template at the top side, the template height templateH_size may be set to 4.

It should also be noted that which part of reconstructed samples may be determined to obtain according to the value of refTemplateType. For example, when the value of refTemplateType is 1, the reconstructed samples on the left, top-left and top sides of the current block are obtained; or when the value of refTemplateType is 2, only the reconstructed sample on the left four columns of the current block are obtained; or when the value of refTemplateType is 3, only the reconstructed sample on the top four rows of the current block are obtained.

In S803: a block vector is determined within a predefined search range.

It should be noted that the search process of Intra TMP-FLM technique is mainly divided into: an initialization process, determining a search region of the template within the current picture (or frame), and searching and determining the best block vector in the search region.

It should also be noted that when searching for the best matched template in the search region, a search strategy of rough search followed by refined search may be adopted, or only refined search may be performed, or only rough search may be performed, which is not specifically limited here.

In the embodiments of the present disclosure, the rough search here may exemplarily be: determining the best rough matching template in the search region with a first preset step (e.g., 2), or determining the best rough matching template in the search region using a downsampling template (e.g., a downsampling factor of 2).

In the embodiments of the present disclosure, the refined search here may exemplarily be: determining the best refined matching template in the search region with a second preset step (e.g., 1), or determining the best refined matching template near the best rough matching template after completing the rough search.

Referring to FIG. 9, a schematic flowchart diagram of an Intra TMP technique-based search provided by the embodiments of the present disclosure is illustrated. As illustrated in FIG. 9, the process may include the following.

In S901: parameters are initialized.

It should be noted that uiPatchWidth is initialized to nTbW+templateW_size, and uiPatchHeight is initialized to nTbH+templateH_size. Where templateW_size and templateH_size may be fixed constants, or may be dynamically adjusted according to the size of the current block. In addition, templateW_size and templateH_size may be equal or unequal. For example, templateW_size=4 and templateH_size=4; or when the width of the current block is greater than 8, set templateW_size=4; when the width of the current block is less than or equal to 8, set templateW_size=2; when the height of the current block is greater than 8, set templateH_size=4; or when the height of the current block is less than or equal to 8, set templateH_size=2.

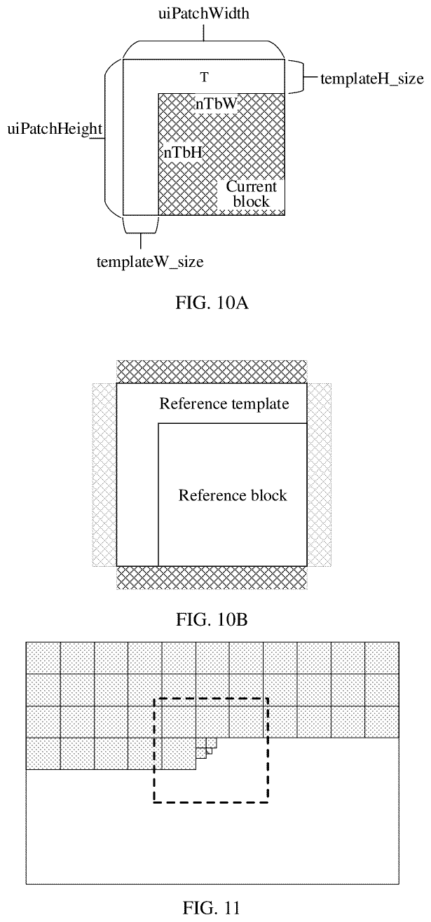

For example, FIG. 10A illustrates a schematic diagram of a current block and parameter definition of its template provided by the embodiments of the present disclosure. As illustrated in FIG. 10A, the specific meanings of the parameters are as follows: nTbW and nTbH represent the size of the current block, templateW_size and templateH_size represent the template size, and uiPatchWidth and uiPatchHeight represent the size of the block including the current block and its template.

In addition, FIG. 10B illustrates a schematic diagram of a reference block and padding of its template adjacent region provided in the embodiments of the present disclosure. As illustrated in FIG. 10B, the parts filled with grids are adjacent regions of the template. If the reference template is located in the boundary region, then padding processing needs to be performed on the samples of the adjacent regions of the template.

Further, a cost threshold between the templates is initialized, which is represented by diffThreshold. For example, when the cost function is SAD, the threshold may be: diffThreshold=((1<<bitDepth)>>2)×(uiPatchHeight×uiPatchWidth−nTbH×nTbW). When the picture bit depth (bitDepth) is 10, diffThreshold represents that the maximum distortion of each sample in the template region is 256.

Further, a position of a coding tree block (CTB) where the current block (CB) is located is initialized: ctbRsX, and ctbRsY

Further, a position offset of the current block (CB) in the current CTB is initialized: offsetLCBY=yTbCmp−ctbRsY, and offsetLCBX=xTbCmp−ctbRsX.

Further, iTemplateSizeH is initialized to templateH_size (i.e., iTemplateSizeH=templateH_size), and iTemplateSizeW is initialized to templateW_size (i.e., iTemplateSizeW=templateW_size)

Further, iBvShift is initialized, where iBvShift is the precision of the block vector (BV). For example, the precision of BV may be entire pixel precision, and in this case, the value of iBvShift is 0; the precision of BV may also be sub-pixel precision, for example, when the value of iBvShift is 1, it indicates ½ pixel precision, and when the value of iBvShift is 2, it indicates ¼ pixel precision, which is not specifically limited here.

Further, a preset search range of the template is initialized. The preset search range of the template may be set to a fixed size, or the search range may be dynamically adjusted according to the size of the coding block. For example, searchRangeWidth=TMP_SEARCH_RANGE_MULT_FACTOR×nTbW, and searchRangeHeight=TMP_SEARCH_RANGE_MULT_FACTOR×nTbH; where the value of TMP_SEARCH_RANGE_MULT_FACTOR may be a preset value (e.g. 5).

In S902: a search region of the template within the current picture is determined.

It should be noted that the search region of the Intra TMP technique is the reconstructed part of the current picture and is limited by the size of the search range. As illustrated in FIG. 11, the regions whose background regions are filled with dots are the reconstructed regions, the block whose background is filled with back-diagonal is the current block, and the dotted box is the search range window. Therefore, the search region of the Intra TMP technique is no larger than the overlapping portion of the reconstructed region represented by the dark background and the region marked by the dotted box.

It may be seen that the search region of the template of the current block may be the reconstructed part of the CTB where the current block is located, or may be other reconstructed CTB regions. The search region here is actually a set of all search points. Since the shape of the region is often not representable by a single rectangular region, in a specific implementation, the search may be performed in multiple rectangular regions, and then the final best matching block and best block vector are obtained by overall considering the search results of different regions.

For example, taking the above FIG. 7A to FIG. 7H as an example, eight different sub-region partitioning manners are illustrated. The background block filled with back-diagonal is the current block; all the five partitioning manners in FIG. 7A to FIG. 7D and FIG. 7F illustrate that the search region is partitioned into four sub-search regions, and all the three partitioning manners in FIG. 7E, FIG. 7G and FIG. 7H illustrate that the search region is partitioned into three sub-search regions, where different filling patterns represent a sub-search region.

All available search ranges are considered in FIG. 7A to FIG. 7D, and the regions directly above and directly left are not searched in FIG. 7E to FIG. 7H.

For example, assuming that different sub-search regions are represented by the different regionIds, considering that the template samples of the current block need to be obtained from the picture reconstructed region and the reconstructed block samples corresponding to the template also need to be obtained from the reconstructed region, it is necessary to further determine the positions that could be searched within the sub-search regions represented by different regionIds according to the position of the current block (xTbCmp, yTbCmp), the size of the current block (nTbW, nTbH), the size of the current picture (picWidth, picHeight), the size of the CTB where the current block is located (CtbSizeW, CtbSizeH), the preset search range of the template (searchRangeWidth, searchRangeHeight) and the position offset of the current block in the current CTB (offsetLCBY, offsetLCBX), so as to determine the block vector (BV). Exemplarily, iVerMin and iVerMax represent the absolute coordinate positions that could be searched at least and at most in the vertical direction, respectively, and iHorMin and iHorMax represent the absolute coordinate positions that could be searched at least and at most in the horizontal direction, respectively. The values of iVerMin, iVerMax, iHorMin and iHorMax are different in the search regions represented by different regionIds.

Taking FIG. 7F as an example, the search region is partitioned into four sub-search regions, and the implementation manner is as follows.

When the value of regionId is equal to 0, iVerMin, iVerMax, iHorMin and iHorMax may be calculated as follows:

```
  iHorMax₀ = min( (xTbCmp + searchRangeWidth) << iBvShift, ((picWidth − nTbW)
<< iBvShift) );
  iHorMin₀ = max( (iTemplateSizeW) << iBvShift, (xTbCmp − searchRangeWidth) <<
iBvShift );
  iVerMax₀ = (yTbCmp − nTbH − offsetLCBY) << iBvShift; and
  iVerMin₀ = max( ((iTemplateSizeH) << iBvShift), ((yTbCmp − searchRangeHeight) <<
iBvShift) ).
```

When the value of regionId is equal to 1, iVerMin, iVerMax, iHorMin and iHorMax may be calculated as follows:

```
  iHorMin₁ = max( (iTemplateSizeW) << iBvShift, (xTbCmp − searchRangeWidth) <<
iBvShift );
  iHorMax₁ = (xTbCmp − offsetLCBX − nTbW) << iBvShift;
  iVerMin₁ = (yTbCmp + 1) << iBvShift; and
  iVerMax₁ = min(picHeight − nTbH, (yTbCmp − offsetLCBY + CtbSizeH − nTbH) <<
iBvShift ).
```

When the value of regionId is equal to 2, iVerMin, iVerMax, iHorMin and iHorMax may be calculated as follows:

```
  iHorMax₂ = (xTbCmp − offsetLCBX − nTbW) << iBvShift;
  iHorMin₂ = max( (iTemplateSizeW) << iBvShift, (xTbCmp − searchRangeWidth) <<
iBvShift );
  iVerMin₂ = max( (iTemplateSizeH) << iBvShift, (yTbCmp − nTbH − offsetLCBY) <<
iBvShift );and
  iVerMax₂ = (yTbCmp) << iBvShift.
```

When the value of regionId is equal to 3, iVerMin, iVerMax, iHorMin and iHorMax may be calculated as follows:

```
  iHorMin₃ = max( (iTemplateSizeW) << iBvShift, (xTbCmp − offsetLCBX − nTbW + 1)
<< iBvShift );
  iHorMax₃ = (xTbCmp − nTbW) << iBvShift;
  iVerMin₃ = max( ((iTemplateSizeH) << iBvShift), (yTbCmp − offsetLCBY − nTbH + 1)
<< iBvShift ); and
  iVerMax₃ = (yTbCmp − nTbH) << iBvShift.
```

In actual applications, iHorMin_{regionId}, iHorMax_{regionId}, iVerMin_{regionId} and iVerMax_{regionId} here represent the left edge, right edge, top edge and bottom edge of different sub-search regions, respectively.

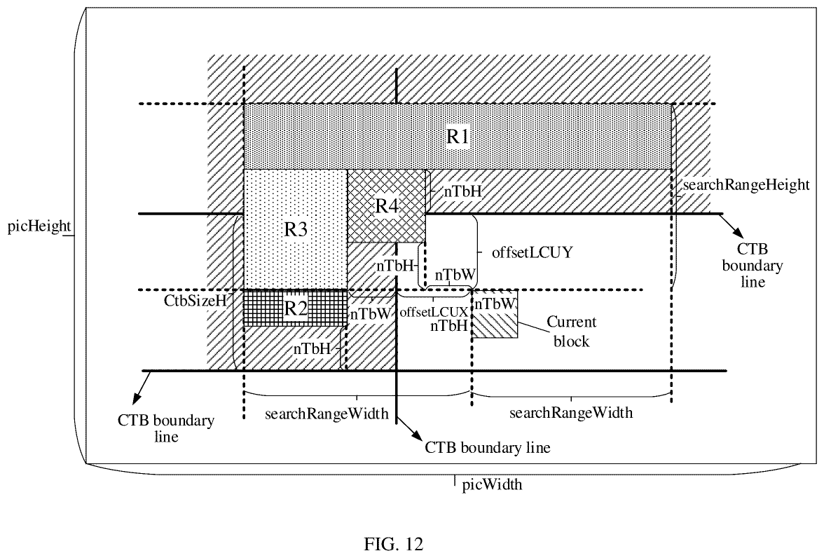

In order to intuitively describe the different sub-search regions corresponding to different regionIds, referring to FIG. 12, a schematic diagram of a determining process for a specific search region provided by the embodiments of the present disclosure is illustrated. As illustrated in FIG. 12, R1, R2, R3 and R4 represent four different sub-search regions. It should be noted that FIG. 12 is expressed in terms of a sample range within which a top-left corner sample of a block may be aligned.

S903: a best block vector BV in the search region is searched and determined.

It should be noted that bvXMins and bvXMaxs represent the minimum offset and maximum offset of the block vector in the horizontal direction, respectively; and bvYMins and bvYMaxs represent the minimum offset and maximum offset of the block vector in the vertical direction, respectively.

bvXMins_{regionId}, bvXMaxs_{regionId}, bvYMins_{regionId} and bvYMaxs_{regionId} may be calculated

by iVerMin_{regionId}, iVerMax_{regionId}, iHorMin_{regionId} and iHorMax_{regionId} determined in step S902:

bvXMins_{regionId} = iHorMin_{regionId} − xTbCmp;
bvXMaxs_{regionId} = iHorMax_{regionId} − xTbCmp;
bvYMins_{regionId} = iVerMin_{regionId} − yTbCmp; and
bvYMaxs_{regionId} = iVerMax_{regionId} − yTbCmp.

Where bvXMins_{regionId}, bvXMaxs_{regionId}, bvYMins_{regionId} and bvYMaxs_{regionId} determine the horizontal and vertical offset ranges of the search point relative to the current block, that is, the range of the block vector (BV).

It should also be noted that, according to a search point (iPosHor, iPosVer) in each search region, that is, each block vector (BV) (consisting of horizontal and vertical components: (pX, pY), where pX=iPosHor-xTbCmp, pY=iPosVer-yTbCmp, then pX is between bvXMins and bvXMaxs, and pY is between bvYMins and bvYMaxs). In this way, a matching reconstructed block of the current block may be found in the reconstructed region, and the neighboring reconstructed samples of the matching reconstructed block are the matching template (that is, the second template mentioned above). Thus, the matching cost value between the adjacent template of the current block and the adjacent template of the matching reconstructed block may be calculated, which is recorded as pDiff.

Further, all search points in all search ranges (regionId=0, 1, 2, 3) are traversed, and a search point with the minimum matching cost value pDiff is obtained by comparison, its corresponding matching cost value is recorded as pDiff_BEST, its corresponding block vector BV is recorded as the best block vector BV_BEST (pX_BEST, pY_BEST), and its corresponding matching template is the best matched template T_BEST.

In a possible implementation, if the search strategy is that: only the rough search is performed, the specific implementation is as follows.

Within each region, in the search range where pX is between bvXMins_{regionId} and bvXMaxs_{regionId} and pY is between bvYMins_{regionId} and bvYMaxs_{regionId}, a rough search is performed with a step greater than 1, for example, a rough search with a step of 2 is performed; and the best matched cost value obtained by template matching is recorded as pDiff_BEST, and its corresponding block vector BV is recorded as the best block vector BV_BEST (pX_BEST, pY_BEST).

In another possible implementation, if the search strategy is: only refined search is performed, the specific implementation is as follows.

Within each region, in the search range where pX is between bvXMins_{regionId} and bvXMaxs_{regionId} and pY is between bvYMins_{regionId} and bvYMaxs_{regionId}, for example, a refined search with a step of 1 is performed; and the best matched cost value obtained by template matching is recorded as pDiff_BEST, and its corresponding block vector BV is recorded as the best block vector BV_BEST (pX_BEST, pY_BEST).

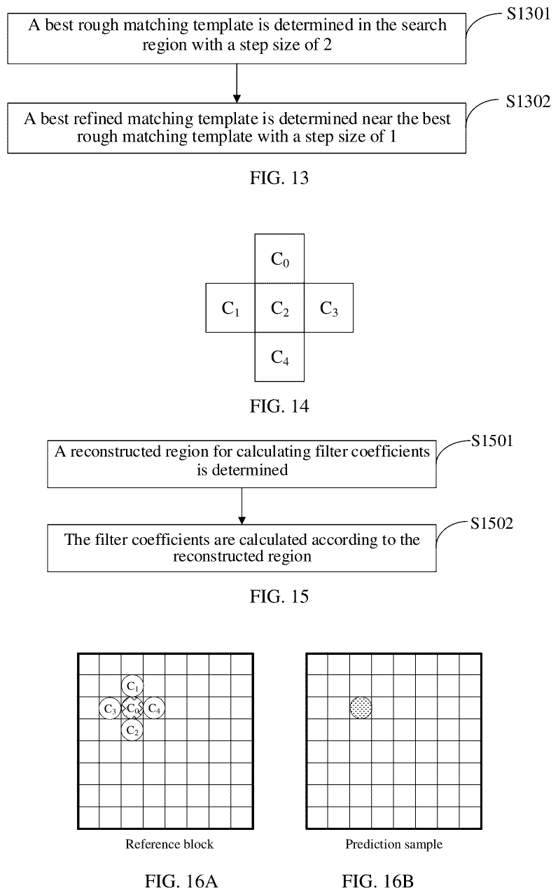

In another possible implementation, if the search strategy is: a rough search is performed first and then a refined search is performed. As illustrated in FIG. 13, the specific process is as follows.

In S1301: a best rough matching template is determined in the search region with a step of 2.

In S1302: a best refined matching template is determined near the best rough matching template with a step of 1.

It should be noted that, for the S1301, in the rough search stage:
within each region, in the search range where pX is between bvXMins_{regionId} and bvXMaxs_{regionId} and pY is between bvYMins_{regionId} and bvYMaxs_{regionId}, a rough search with a step greater than 1 is performed. For example, a rough search with a step of 2 is performed; and the best matched cost obtained by template matching is recorded as pDiff1_BEST, its corresponding block vector BV is recorded as the best block vector BV1_BEST (pX1_BEST, pY1_BEST), and the search region where the best matched search point is located is bestRegionId.

It should also be noted that, for the S1302, in the refined search stage:
the search is further performed near the best block vector BV1_BEST obtained by the rough search. Exemplarily, the refine search range TmpRefineRange is determined first, which may be a fixed size or related to the size of the current block. For example, the refined search range may be set to min(nTbW, nTbH)/2. Then, the position of the best matched reconstructed block obtained by the rough search is calculated to serve as a reference position of the refined search region: BestPosX=xTbCmp+pX1_BEST, BestPosY=yTbCmp+pY1_BEST.

First, the values of iVerMinbest_{RegionId}, iVerMaxbest_{RegionId}, iHorMinbest_{RegionId} and iHorMaxbest_{RegionId} calculated in step S902 are obtained according to the value of bestRegionId, and then the new search ranges iVerMin_{refine}, iVerMax_{refine}, iHorMin_{refine} and iHorMax_{refine} are obtained according to the position of the best matched block obtained by the rough search. The obtaining method is as follows:

iHorMin_{refine} = max(iHorMin_{bestRegionId}, BestPosX − TmpRefineRange);
iHorMax_{refine} = min(iHorMax_{bestRegionId}, BestPosX + TmpRefineRange);
iVerMin_{refine} = max(iVerMin_{bestRegionId}, BestPosY − TmpRefineRange); and
iVerMax_{refine} = min(iVerMax_{bestRegionId}, BestPosY + TmpRefineRange).

Then, the adjusted block vectors BVbvXMins, bvXMaxs, bvYMins and bvYMaxs may be calculated by iVerMin_{refine}, iVerMax_{refine}, iHorMin_{refine} and iHorMax_{refine}:

bvXMins = iHorMin_{refine} − xTbCmp;
bvXMaxs = iHorMax_{refine} − xTbCmp;
bvYMins = iVerMin_{refine} − yTbCmp; and
bvYMaxs = iVerMax_{refine} − yTbCmp.

In this way, the refined search is performed within the block vector range where pX is between bvXMins_{refine} and bvXMaxs_{refine} and pY is between bvYMins_{refine} and bvYMaxs_{refine}. For example, the search with a step of 1 is performed, and the best matched cost obtained by template matching is recorded as pDiff_BEST, and its corresponding block vector BV is recorded as the best block vector BV_BEST (pX_BEST, pY_BEST).

After completing the above operations, the best block vector BV_BEST (pX_BEST, pY_BEST) may be obtained, where pX_BEST and pY_BEST are the horizontal direction offset and vertical direction offset of the best matched template relative to the template of the current block, respectively, and are also the horizontal direction offset and vertical direction offset of the best matched reconstructed block relative to the current block, respectively.

In S804: a linear filtering model is established.

It should be noted that the linear filtering model is established using the best matched template searched in the S803 and the template of the current block. It mainly includes the following two processes: determining a reconstructed region for calculating filter coefficients, and calculating the filter coefficients.

It should also be noted that the number of taps of the filter is defined as nTap. nTap may be a constant or a variable. For example, the number of taps of the filter may be dynamically adjusted according to the size of the current block. In the embodiments of the present disclosure, filters of multiple shapes may be selected. For example, a fixed-shape filter as illustrated in FIG. 14 may be selected, where the number of taps of the filter nTap is 5, and the filter coefficients are C₀, C₁, C₂, C₃ and C₄.

Referring to FIG. 15, a schematic flowchart diagram of a process for calculating filter coefficients provided by the embodiments of the present disclosure is illustrated. As illustrated in FIG. 15, the process may include the following.

In S1501: a reconstructed region for calculating filter coefficients is determined.

It should be noted that, in the embodiments of the present disclosure, the available reconstructed samples are determined according to the template type refTemplateType. For example, when the value of the template type refTemplateType is 1, as illustrated in the FIG. 10, it indicates that the left neighboring reconstructed samples, the top-left neighboring reconstructed samples and the top neighboring reconstructed samples are all available, thus the number of available reconstructed samples on the left side is templateW_size×nTbH, the number of available reconstructed samples on the top side is templateH_size×nTbW, and the number of available reconstructed samples on the top-left side is templateW_sizextemplateH_size.

It should also be noted that, in the embodiments of the present disclosure, in response to the samples outside the reference template being used, padding processing is performed on the samples in the adjacent region of the reference template. Alternatively, in response to the samples in the adjacent region of the reference block being used, padding processing is performed on the samples in the adjacent region of the reference block.

In a possible implementation, performing the padding processing on the samples in the adjacent region of the reference template may include:
determining whether the samples in the adjacent region of the reference template are available; and
in response to the samples in the adjacent region of the reference template being available, directly using the samples in the adjacent region of the reference template; or
in response to the samples in the adjacent region of the reference template being unavailable, performing the padding processing on the adjacent region of the reference template by copying reconstructed samples in a target matching template or a target reference block that are closest to the samples, to obtain samples in the adjacent region of the reference template.

In the embodiments of the present disclosure, the samples in the adjacent region of the reference template being available may include at least one of:
the samples being within a boundary of a picture;
the samples being within boundaries of the tile; or
the samples having been reconstructed.

In another possible implementation, performing the padding processing on the samples in the adjacent region of the reference template may include:
determining whether the samples in the adjacent region of the reference template exceed a preset search range; and
in response to the samples in the adjacent region of the reference template not exceeding the preset search range, directly using the samples in the adjacent region of the reference template; or
in response to the samples in the adjacent region of the reference template exceeding the preset search range, performing the padding processing on the adjacent region of the reference template by copying reconstructed samples in a target matching template or a target reference block that are closest to the samples, to obtain samples in the adjacent region of the reference template.

That is, in the embodiments of the present disclosure, considering that the filter may use reconstructed samples outside the reference template and the reference block, it is necessary to perform the padding processing on the boundary samples. A boundary padding implementation is illustrated in FIG. 10B, and the grid regions are the regions that need to be padded.

In an embodiment, the padding manner is to determine whether the samples of the grid region are available one by one. If available, the reconstructed samples are directly used. If not available, the reconstructed samples of the nearest reference template or reference block are copied to pad the grid region.

The determination manner of whether it is available includes but is not limited to one or more of the following conditions being met:
the samples being within a boundary of a picture;
the samples being within a boundary of a Tile; or
the samples having been reconstructed.

In an embodiment, the padding manner is determined according to search range of BV (i.e., the “preset search region” in the above embodiments). It is determined whether the position of the padding region exceeds the search range of BV, if it does not exceed the search range, the reconstructed samples are directly used, or if it exceeds the search range, the reconstructed samples of the adjacent reference template or reference block are copied to pad the grid region. Exemplarily, it is determined whether the boundary needs to be padded according to iVerMin, iVerMax, iHorMin, and iHorMax derived in the S902.

The leftPadding, rightPadding, topPadding and bottomPadding are used for indicating whether the left grid region, the right grid region, the top grid region and the bottom grid region copy the nearest reconstructed samples, that is:

leftPadding = !(pX_Best > iHorMin);
rightPadding = !( pX_Best < iHorMax);
topPadding = !( pY_Best > iVerMin); and
bottomPadding = !(pY_Best < iverMax).

If the value of leftPadding is true, it indicates that the samples in the left grid region are beyond the BV search range, and the reconstructed samples of the nearest adjacent reference template are copied; otherwise, the reconstructed samples at that position are used directly. If the value of rightPadding is true, it indicates that the samples in the right grid region are beyond the BV search range, and the reconstructed samples of the nearest adjacent reference template or reference block are copied; otherwise, the reconstructed samples at that position are directly used. If the value of topPadding is true, it indicates that the samples in the top grid region are beyond the BV search range, and the reconstructed samples of the nearest adjacent reference template are copied; otherwise, the reconstructed samples at that position are directly used. If the value of bottomPadding is true, it indicates that the samples in the bottom grid region are beyond the BV search range, and the reconstructed samples of the adjacent reference template or reference block are copied; otherwise, the reconstructed samples at that position are directly used.

It should be noted that, in the embodiments of the present disclosure, whether the boundary samples are padding has a great influence on the coding performance. Taking KristenAndSara and CatRobot sequences in the CTC test as examples, the boundary samples using available reconstructed samples obtain a bdrate gain of −0.09% compared to the boundary samples padded by the neighboring nearest samples. For FourPeople and RitualDance sequences, the boundary samples using available reconstructed samples obtain a bdrate gain of −0.08% compared to the boundary samples padded by the neighboring nearest sample, that is, for a 300 Mbps video sequence, about 250 Kbps bandwidth may be saved.

It should also be noted that, in the embodiments of the present disclosure, after determining the number of available reconstructed samples, the reconstructed region for calculating filter coefficients is determined based on the available reconstructed samples. This region may be referred to as R, and R generally includes all available reconstructed samples in the template. For example, when the value of refTemplateType is 1, R may include all available reconstructed samples on the left side, the top-left side and the top side.

In S1502: the filter coefficients are calculated according to the reconstructed region.

It should be noted that, in the embodiments of the present disclosure, after determining the reconstructed region R for calculating the filter coefficients, a set of filter coefficients may be derived by minimizing MSE between the reconstructed samples within the reconstructed region R and the reconstructed samples within the template of the current block, that is:

$$MSE = E [ {( predTemp [ i ] [ j ] - recTemp [ i ] [ j ] )}^{2} ] \qquad ( 16 )$$

$$= E [ {( {\sum }_{k , l = - 1 \sim 1} {c}_{k , l} \cdot refTemp [ i + k ] [ j + l ] - recTemp [ i ] [ j ] )}^{2} ]$$

Where refTemp[i][j] represents an input reconstructed sample value, recTemp[i][j] represents a reconstructed sample value of the template of the current block, (i, j) represents a coordinate position, (i, j)∈R, k and/represent a coordinate offset of the filter coefficient position relative to the filter center position. Taking FIG. 14 as an example, k and l are between −1 and 1, the value of (k,l) may include (0, 0), (0, −1), (−1, 0), (0, 1), (1, 0), and c_{k,l} represents a required filter coefficient. In addition, E represents an operation of calculating the mean, and then, the calculation equation is as follows:

$$MSE = \frac{1}{{N}_{pos}} {\sum }_{i} {\sum }_{j} {\vert predTemp [ i ] [ j ] - recTemp [ i ] [ j ] \vert}^{2} \qquad ( 17 )$$

Where Npos refers to the number of pairs of (i, j) numbers participated in the calculation of |predTemp[i][j]−recTemp[i][j]|². For example, still taking FIG. 14 as an example, if there are 5 pairs of (i, j) numbers participated in the operation, then the value of Nₚₒₛ is equal to 5.

Further, the specific process of minimizing MSE to derive the filter coefficients is as follows.

First, find the partial derivative of c_{k,l} and set it equal to 0, that is:

$$\frac{\partial MSE}{\partial {c}_{m}} = E [ 2 ( {\sum }_{k , l = - 1 \sim 1} {c}_{k , l} \cdot refTemp [ i + k ] [ j + l ] - recTemp [ i ] [ j ] ) \cdot refTemp [ i + m ] [ j + n ] ] \qquad ( 18 )$$

$$E [ 2 ( {\sum }_{k , l = - 1 \sim 1} {c}_{k , l} \cdot refTemp [ i + k ] [ j + l ] - recTemp [ i ] [ j ] ) \cdot refTemp [ i + m ] [ j + n ] ] = 0 \qquad ( 19 )$$

Where k and l are between −1 and 1, and m and n are between −1 and 1.

Here, according to equations (18) and (19), it may obtain equation (20) as follows:

$${\sum }_{k , l = - 1 \sim 1} {c}_{k , l} \cdot E ( refTemp [ i + k ] [ j + l ] \cdot refTemp [ i + m ] [ j + n ] ) = E ( recTemp [ i ] [ j ] \cdot refTemp [ i + m ] [ j + n ] ) \qquad ( 20 )$$

Secondly, after determining the reconstructed region R, the obtained equation (20) is expanded into a matrix form as follows:

$$[ \begin{matrix}E ( refTemp [ i ] [ j ] \cdot refTemp [ i ] [ j ] ) & E ( refTemp [ i - 1 ] [ j ] \cdot refTemp [ i ] [ j ] ) & ⋯ & E ( refTemp [ i ] [ j + 1 ] \cdot refTemp [ i ] [ j ] ) \\ E ( refTemp [ i ] [ j ] \cdot refTemp [ i - 1 ] [ j ] ) & E ( refTemp [ i - 1 ] [ j ] \cdot refTemp [ i - 1 ] [ j ] ) & ⋯ & E ( refTemp [ i ] [ j + 1 ] \cdot refTemp [ i - 1 ] [ j ] ) \\ ⋮ & ⋮ & ⋱ & ⋮ \\ E ( refTemp [ i ] [ j ] \cdot refTemp [ i ] [ j + 1 ] ) & E ( refTemp [ i - 1 ] [ j ] \cdot refTemp [ i ] [ j + 1 ] ) & ⋯ & E ( refTemp [ i ] [ j + 1 ] \cdot refTemp [ i ] [ j + 1 )\end{matrix} ] \times [ \begin{matrix}{c}_{0 , 0} \\ {c}_{- 1 , 0} \\ ⋮ \\ {c}_{0 , 1}\end{matrix} ] = [ \begin{matrix}{\sum }_{i ∈ R} ( recTemp [ i ] [ j ] \cdot refTemp [ i ] [ j ] ) \\ {\sum }_{i ∈ R} ( recTemp [ i ] [ j ] \cdot refTemp [ i - 1 ] [ j ] ) \\ ⋮ \\ {\sum }_{i ∈ R} ( recTemp [ i ] [ j ] \cdot refTemp [ i ] [ j + 1 ] )\end{matrix} ] \qquad ( 21 )$$

Again, since the autocorrelation matrix of refTemp in the reconstructed region R and the cross-correlation vector between refTemp and recTemp are known quantities, the filter coefficients c_{k,l} may be calculated by solving the equation set of equation (20), and fixed-point quantization may be performed on the filter coefficients c_{k,l}, or fixed-point quantization may not be performed on the filter coefficients c_{k,l}.

It should also be noted that, in the process of solving the equation set, the autocorrelation matrix of the reconstructed sample refTemp in the reconstructed region R is first calculated; secondly, the cross-correlation vector between refTemp and the reconstructed sample recTemp of the current template is calculated; then, Cholesky decomposition or LDL decomposition is performed on the autocorrelation matrix; and finally, each filter coefficient cₙ is calculated in sequence by reverse recursion, in which fixed-point quantization may be performed on this set of filter coefficients, or fixed-point quantization may not be performed on this set of filter coefficients.

In S805: a prediction value is generated.

It should be noted that, for each current block, a set of filter coefficients may be obtained in the above manner, and the set of filter coefficients is c₀, c₁, c₂ . . . c_{nTap-1}. Then, filtering is performed on the best matched reconstructed block according to the filter shape and filter coefficients, that is, weighted sum is performed on the filter coefficients and the reference samples at the corresponding positions to obtain the current samples to be predicted. ref is denoted as the best matched reconstructed block, which is defined as follows:

$$ref [ i ] [ j ] = recSamples [ i + pX\_BEST ] [ j + pY\_BEST ] \qquad ( 22 )$$

Where i=0, . . . , nTbW−1, j=0, . . . , nTbH−1, recSamples is the reconstructed sample of the current picture, and pX_BEST and pY_BEST are the horizontal and vertical components of the best block vector, respectively.

It should also be noted that, in the embodiments of the present disclosure, the samples in the adjacent region of the reference block need to be used, that is, the padding needs to be performed on the samples in the adjacent region of the reference block.

It should also be noted that the specific calculation process of the prediction value is as follows.

It is assumed that the number of filter taps nTap is 5, the shape of the filter (or called “filter template”) is illustrated in FIG. 16A, C₀ to C₄ are the tap coefficients of the filter, respectively. Here, the dot filled with the grids corresponding to the tap coefficient C₀ is the reconstructed sample ref[i][j] at the corresponding position of the current sample to be predicted Y^{pred}[i][j] in the best matched block (i.e., the above reference block); the remains dots filled with white are the reconstructed samples adjacent to the current spatial position in the best matched block. Thus, according to the filter in FIG. 16A, the prediction sample Y^{pred}[i][j] finally obtained is illustrated as the dot filled with dots in FIG. 16B.

The specific prediction value calculation process is as follows.

For each current sample to be predicted (i, j), the sample position in the filter template is defined as (k, l), then the corresponding reconstructed sample in the best matched block during filtering is defined as ref[i+k][j+l], and each filter coefficient at the position (k, l) in the filter template is defined as:

$${c}_{k , l} = {c}_{n} \qquad ( 23 )$$

Where n=0, . . . , nTap−1, and k and l are between −1 and 1.

For i=0, . . . , nTbW−1, and j=0, . . . , nTbH−1:

$${Y}^{pred} [ i ] [ j ] = {\sum }_{k} {\sum }_{l} ref [ i + k ] [ j + l ] \times {c}_{k , l} \qquad ( 24 )$$

Further, a clip operation may also be performed on Y^{pred}[i][j] within the preset numerical range to obtain a final prediction sample. The details are as follows:

$$predSamples [ i ] [ j ] = Clip 3 ( 0 , ( 1 << BitDepth ) - 1 , {Y}^{pred} [ i ] [ j ] ) \qquad ( 25 )$$

Where, for the clip function, the details are as follows:

$$Clip 3 ( x , y , z ) = \{ \begin{matrix}x ; & z < x \\ y ; & z > y \\ z ; & otherwise\end{matrix} \qquad ( 26 )$$

It may be understood that, in the embodiments of the present disclosure, a linear filtering model is established between the best matched template obtained by search and the template of the current block, the filter coefficients are calculated and obtained by minimizing MSE between the prediction template (prediction template=filter coefficients×matching template) and the template of the current block, the best matched block is filtered and corrected, and the filtered reconstructed samples are used as the final prediction samples.

In some embodiments, the input information used for calculating the filter coefficients in the above embodiments may be expanded. Where, the input information for calculating the filter coefficients may be the available reconstructed samples in the matching template. Or, by calculating the gradient of each sample in the matching template, including but not limited to the horizontal gradient, vertical gradient and so on, the calculated gradients are used as the input information for calculating the filter coefficients. Or, the position information of each sample may be used as the input information for calculating the filter coefficients, where the position information may be the absolute position information of each sample in the entire picture, or the relative position information of each sample relative to a certain reference point.

In some embodiments, the implementations for calculating the filter coefficients in the above embodiments may be expanded. The finally calculated filter coefficients are the tap coefficients corresponding to the filter template, that is, the number of filter coefficients is equal to the number of taps of the filter template (nTap). In addition, several bias may be added to the filter template, for example, in the above embodiments, when nTap=5, the filter coefficients are the tap coefficients corresponding to the filter template c₀ and c₄, and the prediction value obtained by calculating the position (i, j) is:

$${Y}^{pred} [ i ] [ j ] = {\sum }_{n = 0}^{4} ref [ k ] [ l ] \times {c}_{n} \qquad ( 27 )$$

And thus, the biases may be added as shown in the following equation:

$${Y}^{pred} [ i ] [ j ] = {\sum }_{n = 0}^{4} ref [ k ] [ l ] \times {c}_{n} + {C}_{5} \times Constant \qquad ( 28 )$$

Where cₙ=c_{i,j,k,l}. In addition, Constant may be a fixed constant, such as Constant=1 (BitDepth−1); or may also be a number related to the reconstructed sample value at the position(i, j) in the reference block, such as Constant=f(ref[i][j]); or may also be a number related to the reconstructed sample value corresponding to a certain tap in the filter template other than position(i, j), such as Constant=f(ref[k][i]). Here, Constant=f(ref [i][j]) or Constant=f(ref[k][Z]) may be a linear mapping relationship or a nonlinear mapping relationship. One or more biases may be added.

In some embodiments, the number of filtering models in the above embodiments may be expanded. Only one linear filter model may be established, or multiple linear filter models may be established. Here, the input information for calculating the filter coefficients is classified, and a filter model is established for each category of the input information, respectively. For example, when using reconstructed information to establish a filter model, one possible implementation is to use the mean value of the reconstructed information for classification, and a filter model is established for the reconstructed information greater than the mean value and a filter model is established for the reconstructed information less than the mean value.

Another possible implementation is to use the position of the reconstructed information for classification. For example, a first model may be established using the available reconstructed information on the left and top sides, and a second model may be established using the available reconstructed information on the left and top-left sides, and so on; and the encoder determines which model should be used. One possible decision implementation is that the encoder determines which model should be used by means of rate-distortion optimization and transmits the corresponding decoding parameter (e.g., flag) to the decoder.

Another possible implementation is to use the shape of filters for classification. Multiple filters with different shapes may be used and a respective filter model is established for each filter shape; and the encoder determines which filter shape should be used. One possible decision implementation is that the encoder determines which filter should be used by means of rate-distortion optimization and transmits the corresponding decoding parameter (e.g., flag) to the decoder.

In some embodiments, the type of filtering model in the above embodiments may be expanded. The linear filter model may be established, and the nonlinear filter model may also be established for filtering. One possible implementation is to introduce a quadratic term to establish a nonlinear filtering model. For example, when minimizing MSE of the filter coefficients, the calculation equation is modified to the following:

$$MSE = E [ {( predTemp [ i ] [ j ] - recTemp [ i ] [ j ] )}^{2} ]$$

$$= E [ {( {\sum }_{k , l = - 1 \sim 1} {c}_{k , l} \cdot {( refTemp [ i + k ] [ j + l ] )}^{2} - recTemp [ i ] [ j ] )}^{2} ] \qquad ( 29 )$$

And then, the calculation equation for calculating the prediction value is modified as follows:

$${Y}^{pred} [ i ] [ j ] = {\sum }_{k} {\sum }_{l} {( ref [ i + k ] [ j + l ] )}^{2} \times {C}_{k , l} \qquad ( 30 )$$

In some embodiments, the portion for calculating the prediction value in the above embodiments may be expanded. It is determined whether the current block uses the filtered reference block as the final prediction value by certain conditions. For example, there are several manners as follows.

Manner 1: it is determined whether to perform filtering on the matching template by comparing the distortion between the matching template and the current block template (such as SAD, MSE, SATD, SSE) with a threshold T_Distortion1.

Manner 2: on the basis that Manner 1 meets the use of the filter model, it is determined whether to perform filtering on the reference block through the distortion between the filtered matching template and the template of the current block (such as SAD or MSE or SATD or SSE) and a threshold T_Distortion2.

Manner 3: the encoding side transmits a Flag to indicate whether to apply the filter model, in which tmpFlag indicates whether the intra template matching is applied to the current coding block, and filterFlag indicates whether the filter model is applied to the current block. When the value of tmpFlag is 1, the encoding side determines whether to perform filtering on the reference block by comparing the distortion between the filtered reference block (i.e., the reference block after filtering) and the original block and the distortion between the unfiltered reference block (i.e., reference block before filtering) and the original block, such as SAD or MSE or SATD or SSE. If the distortion after filtering is less than the distortion before filtering, the value of filterFlag is 1 and the filtered reference block is used as the prediction block of the current block; otherwise, the value of filterFlag is 0 and the unfiltered reference block is used as the prediction block of the current block, and the encoding side transmits filterFlag to the decoding side. There are many implementations for encoding of filterFlag. One possible implementation is to use equal-probability encoding; and another possible implementation is to use context encoding, where a default context initial state and context update rate may be used, or the context initial state and context update rate may be determined by statistics.

In some embodiments, for an implementation in FIG. 7A, the search region is partitioned into four sub-search regions, and the implementation manner is as follows.

When the value of regionId is equal to 0, iVerMin, iVerMax, iHorMin and iHorMax may be calculated as follows:

```
  iHorMax = min( (xTbCmp + searchRangeWidth) << iBvShift, ((picWidth − nTbW) <<
iBvShift) );
  iHorMin = max( (iTemplateSizeW) << iBvShift, (xTbCmp − searchRangeWidth) <<
iBvShift );
  iVerMax = (yTbCmp − nTbH − offsetLCBY) << iBvShift; and
  iVerMin = max( ((iTemplateSizeH) << iBvShift), ((yTbCmp − searchRangeHeight) <<
iBvShift) ).
```

When the value of regionId is equal to 1, iVerMin, iVerMax, iHorMin and iHorMax may be calculated as follows:

```
  iHorMin = max( (iTemplateSizeW) << iBvShift, (xTbCmp −
  searchRangeWidth) <<
iBvShift );
  iHorMax = (xTbCmp − offsetLCBX − nTbW) << iBvShift;
  iVerMin = (yTbCmp + 1) << iBvShift; and
  iVerMax = min(picHeight − nTbH, (yTbCmp − offsetLCBY +
  CtbSizeH − nTbH) <<
iBvShift ).
```

When the value of regionId is equal to 2, iVerMin, iVerMax, iHorMin and iHorMax may be calculated as follows:

```
  iHorMax = (xTbCmp − nTbW) << iBvShift;
  iHorMin = max( (iTemplateSizeW) << iBvShift, (xTbCmp −
  searchRangeWidth) <<
iBvShift );
  iVerMin = max( (iTemplateSizeH) << iBvShift, (yTbCmp −
  nTbH) << iBvShift ); and
  iVerMax = (yTbCmp) << iBvShift.
```

When the value of regionId is equal to 3, iVerMin, iVerMax, iHorMin and iHorMax may be calculated as follows:

```
  iHorMin = max( (iTemplateSizeW) << iBvShift, (xTbCmp −
  searchRangeWidth) <<
iBvShift );
  iHorMax = (xTbCmp) << iBvShift;
  iVerMin = max( ((iTemplateSizeH) << iBvShift), (yTbCmp −
  offsetLCBY − nTbH + 1)
<< iBvShift ); and
  iVerMax = (yTbCmp − nTbH) << iBvShift.
```

In actual applications, iHorMin, iHorMax, iVerMin and iVerMax here represent the left edge, right edge, top edge and bottom edge of different search regions, respectively.

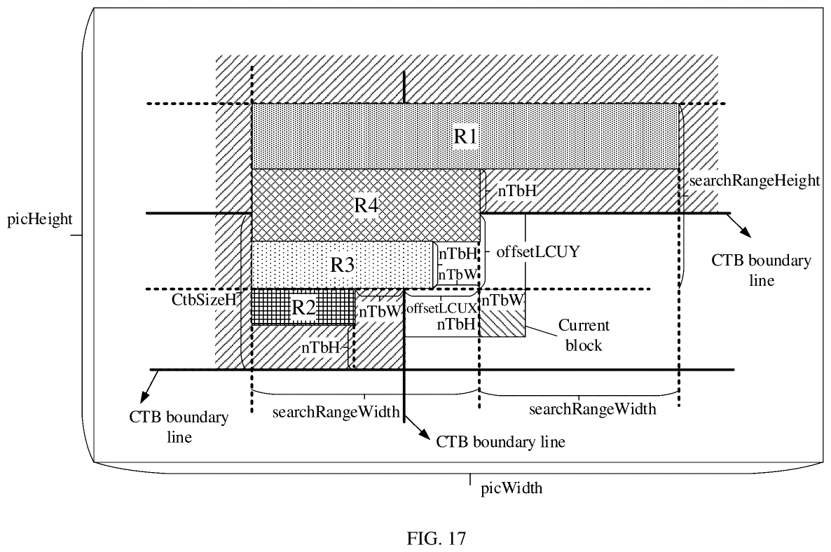

In order to intuitively describe the different sub-search regions corresponding to different regionIds, referring to FIG. 17, a schematic diagram of another determining process for a specific search region provided by the embodiments of the present disclosure is illustrated. As illustrated in FIG. 17, R1, R2, R3, and R4 represent four different sub-search regions. It should be noted that FIG. 17 is expressed in terms of a sample range within which a top-left corner sample of a block may be aligned.

In some embodiments, it is provided here that the search region of the template within the current picture may be different from the search region of the template within the current picture determined based on the existing Intra TMP technique. For another implementation in FIG. 7B, the search region is partitioned into four sub-search regions, and the implementation manner is as follows.

When the value of regionId is equal to 0, iVerMin, iVerMax, iHorMin and iHorMax may be calculated as follows:

```
  iHorMax = min( (xTbCmp + searchRangeWidth) << iBvShift,
  ((picWidth − nTbW) <<
iBvShift) );
  iHorMin = max( (iTemplateSizeW) << iBvShift, (xTbCmp −
  searchRangeWidth) <<
iBvShift );
  iVerMax = (yTbCmp − nTbH − offsetLCBY) << iBvShift; and
  iVerMin = max( ((iTemplateSizeH) << iBvShift), ((yTbCmp −
  searchRangeHeight) <<
iBvShift) ).
```

When the value of regionId is equal to 1, iVerMin, iVerMax, iHorMin and iHorMax may be calculated as follows:

```
  iHorMin = max( (iTemplateSizeW) << iBvShift, (xTbCmp −
  searchRangeWidth) <<
iBvShift );
  iHorMax = (xTbCmp − offsetLCBX − nTbW) << iBvShift;
  iVerMin = (yTbCmp + 1) << iBvShift; and
  iVerMax = min(picHeight − nTbH, (yTbCmp − offsetLCBY +
  CtbSizeH − nTbH) <<
iBvShift ).
```

When the value of regionId is equal to 2, iVerMin, iVerMax, iHorMin and iHorMax may be calculated as follows:

```
  iHorMax = (xTbCmp − nTbW) << iBvShift;
  iHorMin = max( (iTemplateSizeW) << iBvShift, (xTbCmp −
  searchRangeWidth) <<
iBvShift );
  iVerMin = max( (iTemplateSizeH) << iBvShift, (yTbCmp −
  nTbH − offsetLCBY) <<
iBvShift ); and
  iVerMax = (yTbCmp) << iBvShift.
```

When the value of regionId is equal to 3, iVerMin, iVerMax, iHorMin and iHorMax may be calculated as follows:

```
  iHorMin = max( (iTemplateSizeW) << iBvShift, (xTbCmp −
  nTbW + 1) << iBvShift);
  iHorMax = (xTbCmp) << iBvShift;
  iVerMin = max( ((iTemplateSizeH) << iBvShift), (yTbCmp −
  offsetLCBY − nTbH + 1)
<< iBvShift ); and
  iVerMax = (yTbCmp − nTbH) << iBvShift.
```

In actual applications, iHorMin, iHorMax, iVerMin and iVerMax here represent the left edge, right edge, top edge and bottom edge of different search regions, respectively.

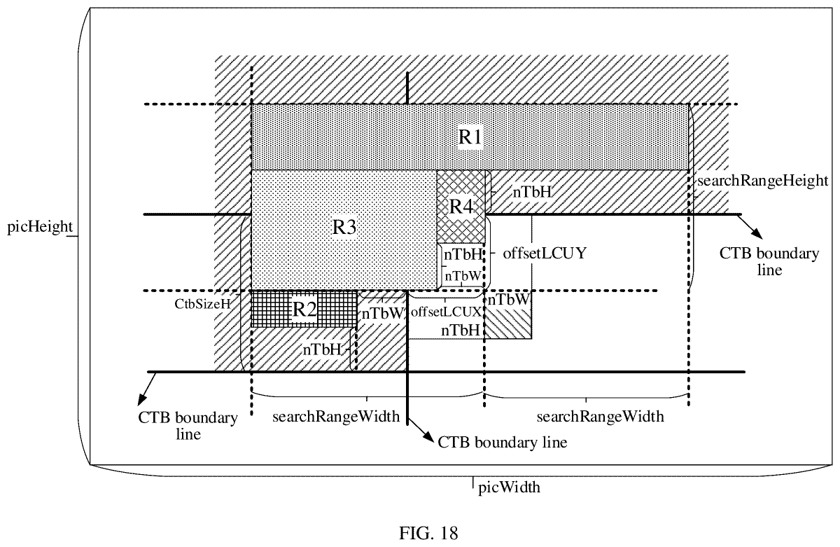

In order to intuitively describe the different sub-search regions corresponding to different regionIds, referring to FIG. 18, a schematic diagram of yet another determining process for a specific search region provided by the embodiments of the present disclosure is illustrated. As illustrated in FIG. 18, R1, R2, R3, and R4 represent four different sub-search regions. It should be noted that FIG. 18 is expressed in terms of a sample range within which a top left corner sample of a block may be aligned.

In some embodiments, the description on the rough search process may be consistent with that in the above embodiments. For the refined search process, it can be performed based on a method that crosses boundaries of each region, that is, the technical solution allowing cross-boundary refined search among various search regions is expanded here. In the embodiments of the present disclosure, the method may further include:
performing a first search within each of the at least one sub-search region respectively, to determine a respective best block vector of each sub-search region and a respective second search region corresponding to each sub-search region;
performing region determination according to the respective best block vector of each sub-search region and the respective second search region corresponding to each sub-search region, to determine at least two target sub-search regions participating in a second search;
performing the second search within the at least two target sub-search regions to determine a best block vector corresponding to the at least two target sub-search regions; and
taking the best block vector corresponding to the at least two target sub-search regions as the target block vector.

For example, taking FIG. 7A as an example, another implementation is provided here, which is implemented by partitioning the search region into four sub-search regions.

When the value of regionId is equal to 0, iVerMin, iVerMax, iHorMin and iHorMax may be calculated as follows:

```
  iHorMax₀ = min( (xTbCmp + searchRangeWidth) << iBvShift,
  ((picWidth − nTbW)
<< iBvShift) );
  iHorMin₀ = max( (iTemplateSizeW) << iBvShift, (xTbCmp −
  searchRangeWidth) <<
iBvShift );
  iVerMax₀ = (yTbCmp − nTbH − offsetLCBY) << iBvShift; and
  iVerMin₀ = max( ((iTemplateSizeH) << iBvShift), ((yTbCmp −
  searchRangeHeight) <<
iBvShift) ).
```

When the value of regionId is equal to 1, iVerMin, iVerMax, iHorMin and iHorMax may be calculated as follows:

```
  iHorMin₁ = max( (iTemplateSizeW) << iBvShift, (xTbCmp −
  searchRangeWidth) <<
iBvShift );
  iHorMax₁ = (xTbCmp − offsetLCBX − nTbW) << iBvShift;
  iVerMin₁ = (yTbCmp + 1) << iBvShift; and
  iVerMax₁ = min(picHeight − nTbH, (yTbCmp − offsetLCBY +
  CtbSizeH − nTbH) <<
iBvShift ).
```

When the value of regionId is equal to 2, iVerMin, iVerMax, iHorMin and iHorMax may be calculated as follows:

```
  iHorMax₂ = (xTbCmp − nTbW) << iBvShift;
  iHorMin₂ = max( (iTemplateSizeW) << iBvShift, (xTbCmp −
  searchRangeWidth) <<
iBvShift );
  iVerMin₂ = max( (iTemplateSizeH) << iBvShift, (yTbCmp −
  nTbH) << iBvShift ); and
  iVerMax₂ = (yTbCmp) << iBvShift.
```

When the value of regionId is equal to 3, iVerMin, iVerMax, iHorMin and iHorMax may be calculated as follows:

```
  iHorMin₃ = max( (iTemplateSizeW) << iBvShift, (xTbCmp −
  searchRangeWidth) <<
iBvShift );
  iHorMax₃ = (xTbCmp) << iBvShift;
  iVerMin₃ = max( ((iTemplateSizeH) << iBvShift), (yTbCmp −
  offsetLCBY − nTbH + 1)
<< iBvShift ); and
  iVerMax₃ = (yTbCmp − nTbH) << iBvShift.
```

In actual applications, iHorMin, iHorMax, iVerMin and iVerMax here represent the left edge, right edge, top edge and bottom edge of different search regions, respectively.

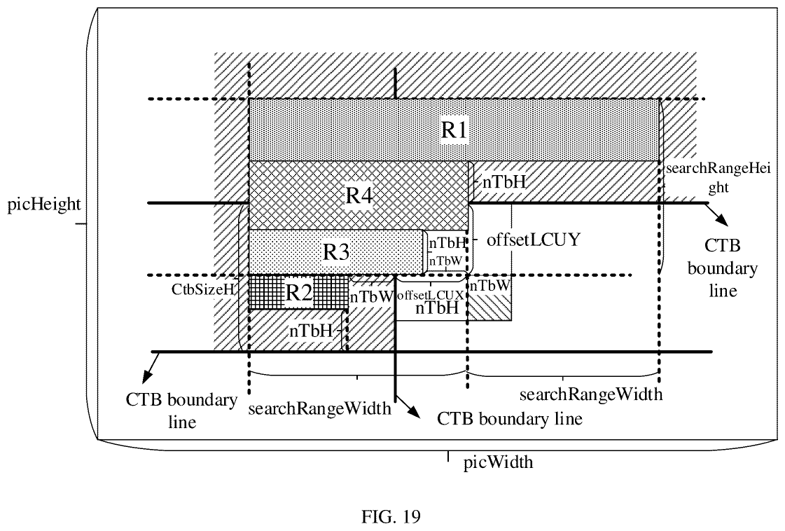

In order to intuitively describe the different sub-search regions corresponding to different regionIds, referring to FIG. 19, a schematic diagram of still another determining process for a specific search region provided by the embodiments of the present disclosure is illustrated. As illustrated in FIG. 19, R1, R2, R3, and R4 represent four different sub-search regions, and refined searches are performed across boundaries among various sub-search regions. It should be noted that FIG. 19 is expressed in terms of a sample range within which a top left corner sample of a block may be aligned.

In the refined search stage, the search is performed near each block vector obtained by the rough search.

Further, the search is performed near the best block vector BV1_BESTₖ obtained by the rough search. Exemplarily, the refined search range TmpRefineRange is determined first, which may be a fixed size or related to the size of the current block. For example, the refined search range may be set to min(nTbW, nTbH)/2. Then, the position of the best matched reconstructed block obtained by the rough search is calculated to serve as a reference position of the refined search region: BestPosXₖ=xTbCmp+pX1_BESTₖ, BestPosYₖ=yTbCmp+pY1_BESTₖ.

Further, the refined search performed according to each BestPosXₖ may be performed across multiple regions.

The value of bestRegionId participating in the operation is determined: for regionId=0, 1, 2, 3, a determination is made sequentially:

```
  if BestPosYₖ − TmpRefineRange>= iVerMin_{regionId}, and BestPosYₖ −
TmpRefineRange<= iVerMax_{regionId},
  or BestPosYₖ+ TmpRefineRange >= iVerMin_{regionId}, and BestPosYₖ+
TmpRefineRange<= iVerMax_{regionId},
  or BestPosYₖ− TmpRefineRange<= iVerMin_{regionId}, and BestPosYₖ+
TmpRefineRange>= iVerMax_{regionId},
```

then, the value of the bestSearchFlag_{regionId} is set to 1 for the corresponding regionId.

Here, for each search region with the value of bestSearchFlag_{regionId} being 1, bestRegionId is set to the regionId of the region in turn, and the refined search is performed as follows.

First, according to the value of bestRegionId, the values of iVerMin_{bestRegionId}, iVerMax_{bestRegionId}, iHorMin_{bestRegionId} and iHorMax_{bestRegionId} calculated above are obtained, and then the new search ranges iVerMin_{refine}, iVerMax_{refine}, iHorMin_{refine} and iHorMax_{refine} are obtained according to the position of the best matched block obtained by the rough search. The acquisition method is as follows:

iHorMin_{refine} = max(iHorMin_{bestRegionId}, BestPosX − TmpRefineRange);
iHorMax_{refine} = min(iHorMax_{bestRegionId}, BestPosX + TmpRefineRange);
iVerMin_{refine} = max(iVerMin_{bestRegionId}, BestPosY − TmpRefineRange);
and
iVerMax_{refine} = min(iVerMax_{bestRegionId}, BestPosY + TmpRefineRange).

Then, the adjusted block vectors BVbvXMins, bvXMaxs, bvYMins and bvYMaxs may be calculated by iVerMin_{refine}, iVerMax_{refine}, iHorMin_{refine} and iHorMax_{refine}:

bvXMins = iHorMin_{refine} − xTbCmp;
bvXMaxs = iHorMax_{refine} − xTbCmp;
bvYMins = iVerMin_{refine} − yTbCmp; and
bvYMaxs = iVerMax_{refine} − yTbCmp.

In this way, the refined search is performed within the block vector range where pX is between bvXMins_{refine} and bvXMaxs_{refine} and pY is between bvYMins_{refine} and bvYMaxs_{refine}. For example, the search with a step of 1 is performed, the best matched cost obtained by template matching is recorded as pDiff_BEST, and its corresponding block vector BV is recorded as the best block vector BV_BEST (pX_BEST, pY_BEST), to obtain the total best block vector of multiple regions participating in the search.

After completing the above operations, the best block vector BV_BEST (pX_BEST, pY_BEST) may be obtained, where pX_BEST and pY_BEST are the horizontal direction offset and vertical direction offset of the best matched template relative to the template of the current block, respectively, and are also the horizontal direction offset and vertical direction offset of the best matched block relative to the current block, respectively.

In summary, the embodiments of the present disclosure propose an intra template matching prediction based on filter-based liner model (Intra TMP-FLM) technique, in which a linear filtering model is established using the template information of the matching template and the current block, the correlation between the matching template and the template of the current coding block is fully utilized, filtering and correction are performed on the reconstructed sample of the best matched block (i.e., the reference block), and the filtered reconstructed sample is taken as prediction sample, which improves the prediction accuracy to a certain extent, and effectively solves the problem of linear changes between the best matched block and the current block.

In the embodiments of the present disclosure, the specific implementation of the above embodiments is described in detail through the above embodiments, from which it may be seen that according to the technical solutions of the above embodiments, the prediction value based on the intra template matching technology may be effectively corrected, thereby improving the prediction accuracy. Exemplarily, a linear filtering model is established between the best matched template obtained by search and the template of the current block; the filter coefficients are calculated and obtained by minimizing MSE between the prediction template (prediction template=filter coefficients×matching template) and the template of the current coding block, where the filter coefficients fully reflect the correlation between the matching template and the template of the current block; then, the correlation is applied to the best matched block, and the reconstructed samples of the best matched block are filtered and corrected; and finally, the filtered reconstructed samples are taken as prediction samples, thereby improving the prediction accuracy.

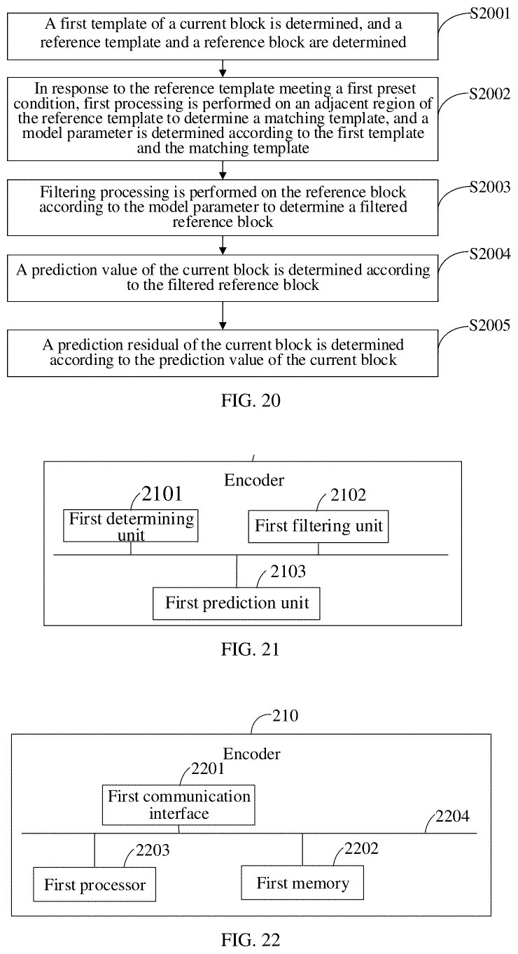

In another embodiment of the present disclosure, referring to FIG. 20, a schematic flowchart diagram of an encoding method provided by the embodiments of the present disclosure is illustrated. As illustrated in FIG. 20, the method may include the following.

In S2001: a first template of a current block is determined, and a reference template and a reference block are determined.

It should be noted that the encoding method in the embodiments of the present disclosure is applied to an encoder. In addition, the encoding method may exemplarily refer to an intra prediction method, and more specifically, to an Intra TMP-FLM technique-based intra prediction method. A video picture may be partitioned into multiple coding blocks, and the current block in the embodiments of the present disclosure refers to a coding block in the video picture on which intra prediction is currently to be performed. In addition, the encoding method in the embodiments of the present disclosure may be used to predict both the luma component and the chroma component, which is not specifically limited here.

It should also be noted that, in the embodiments of the present disclosure, first, it is necessary to determine the first template of the current block. In some embodiments, the operation that the first template of the current block is determined may include:
determining a template type of the current block; and
determining the first template of the current block according to the template type of the current block.

The template type may be represented by refTemplateType. In some embodiments, determining the template type of the current block may include: determining the template type of the current block according to reference samples of the current block.

The reference samples of the current block include at least one of: left neighboring reference samples of the current block, top neighboring reference samples of the current block, top-left neighboring reference samples of the current block, bottom-left neighboring reference samples of the current block, or top-right neighboring reference samples of the current block.

Further, according to the availability of the neighboring reference samples, the template types may be classified and the template type of the current block may be determined. In some embodiments, determining the template type of the current block may include:
determining that the template type of the current block is a first value in response to the left neighboring reference samples of the current block, the top neighboring reference samples of the current block and the top-left neighboring reference samples of the current block being all available;
determining that the template type of the current block is a second value in response to the left neighboring reference samples of the current block being available;
determining that the template type of the current block is a third value in response to the top neighboring reference samples of the current block being available;
determining that the template type of the current block is a fourth value in response to the left neighboring reference samples of the current block and the top-left neighboring reference samples of the current block being all available;
determining that the template type of the current block is a fifth value in response to the left neighboring reference samples of the current block and the bottom-left neighboring reference samples of the current block being all available; or
determining that the template type of the current block is a sixth value in response to the top neighboring reference samples of the current block and the top-right neighboring reference samples of the current block being all available.

In the embodiments of the present disclosure, the first value, the second value, the third value, the fourth value, the fifth value and the sixth value may be different. For example, the first value may be set to 1, the second value may be set to 2, the third value may be set to 3, the fourth value may be set to 4, the fifth value may be set to 5, and the sixth value may be set to 6. In addition, referring to FIG. 3A to FIG. 3F, these six template types are illustrated in detail.

In some embodiments, determining the first template of the current block according to the template type of the current block may include: obtaining template samples of the current block according to the template type of the current block and a corresponding template size; and determining the template samples of the current block as the first template of the current block.

In the embodiments of the present disclosure, the template size may be preset, or may be determined according to a size of the current block, or may even be related to the template type of the current block, which is not specifically limited here. For example, if the template type indicates that only the left template is obtained, the template width templateW_size may be set to 4; and if the template type indicates that only the top template is obtained, the template height templateH_size may be set to 4.

In the embodiments of the present disclosure, it is possible to determine which part of the reconstructed samples may be obtained by the first template according to the value of the template type. For example, when the value of refTemplateType is 1, the reconstructed samples on the left, top-left and top sides of the current block are obtained; or when the value of refTemplateType is 2, only the reconstructed samples on the left four columns of the current block are obtained; when the value of refTemplateType is 3, only the reconstructed sample on the top four rows of the current block is obtained.

For the reference template and the reference block, in a possible implementation, the operation that the reference template and the reference block are determined may include may include: determining a motion parameter and a corresponding reference block; and determining the reference template according to the first template and the reference block.

Accordingly, in some embodiments, the method may further include: encoding the motion parameter, and signalling an obtained encoded bit into a bitstream. That is, after determining the motion parameter (e.g., BV), the encoding side may signal the motion parameter into the bitstream; and subsequently, the decoding side may directly determine the motion parameter by decoding the bitstream, then, determine the reference block of the current block, and finally, determine the reference template based on the first template of the current block and the reference block.

For the reference template and the reference block, in another possible implementation, the operation that the reference template and the reference block are determined may include: performing template matching within a preset search region according to the first template to determine the reference template; and determining the reference block according to the reference template.

In some embodiments, performing the template matching within the preset search region according to the first template to determine the reference template may include: performing a search within the preset search region based on the first template to determine a target block vector, and determining the reference template according to the target block vector.

That is, the search may be performed within the preset search region according to the first template, and a matching template that has the minimum cost with the first template may be searched out according to a preset cost function. By traversing all search points within the preset search region, one or more candidate block vectors may be obtained, in which the one or more candidate block vectors may indicate one or more candidate matching templates; cost calculation is performed respectively on each of the one or more candidate matching templates with the first template of the current block; a search point with the minimum cost is obtained by comparison, in which its corresponding candidate block vector is the best block vector (i.e., the target block vector, BV_BEST); and its corresponding candidate matching template is the best matched template (i.e., the reference template described in the present embodiment, T_BEST); and the reference block may be determined according to the best matched template.

In the embodiments of the present disclosure, the preset cost function may be Sum of Absolute Difference (SAD), Sum of Absolute Transformed Difference (SATD), Mean Square Error (MSE), Sum of Squared Differences (SSD), Mean Absolute Deviation (MAD), Mean Square Differences (MSD), Normalized Correlation Coefficient (NCC) and so on, which is not specifically limited here.

It is to be understood that the search process within the preset search region may be implemented through rough search, or refined search, or rough search followed by refined search; and the details are as follows.

In a possible implementation manner, performing the search within the preset search region based on the first template to determine the target block vector may include: performing a first search within the preset search region to determine the target block vector.

In another possible implementation, performing the search within the preset search region based on the first template to determine the target block vector may include: performing a second search within the preset search region to determine the target block vector.

In yet another possible implementation, performing the search within the preset search region based on the first template to determine the target block vector may include: performing a first search within the preset search region to determine a first block vector, and determining an initial matching template according to the first block vector; and determining a first search region according to the initial matching template, and performing a second search within the first search region to determine the target block vector.

It is to be noted that, in the embodiments of the present disclosure, a search step corresponding to the first search is greater than a search step corresponding to the second search. For example, the search step corresponding to the first search is 2, and the search step corresponding to the second search is 1. Alternatively, a downsampling factor corresponding to the first search is greater than a downsampling factor corresponding to the second search. For example, the downsampling factor corresponding to the first search is 4, and the downsampling factor corresponding to the second search is 2. That is, the first search is the rough search, and the second search is the refined search. Any feature that as long as it can reflect that the first search is rougher than the second search is acceptable, which is not specifically limited here.

It should also be noted that when the first search is performed first and then the second search is performed, not only the search step corresponding to the first search is greater than the search step corresponding to the second search, but also the first search region is smaller than the preset search region. The first search region is a search region near the initial matching template. For example, a best rough matching template may be first determined in the preset search region with a step of 2; and then the best refined matching template (i.e., the final reference template) may be determined near the best rough matching template with a step of 1.

In yet another possible implementation, the preset search region may include at least one sub-search region, and performing the search within the preset search region based on the first template to determine the target block vector may include:
performing the search within each of the at least one sub-search region respectively, to determine a respective best block vector of each sub-search region and a respective matching cost value corresponding to each sub-search region;
determining a best block vector corresponding to a minimum matching cost value according to the respective best block vector of each sub-search region and the respective matching cost value corresponding to each sub-search region; and
taking the best block vector corresponding to the minimum matching cost value as the target block vector.

In still another possible implementation, the preset search region may include at least one sub-search region, and performing the search within the preset search region based on the first template to determine the target block vector may include:
performing a first search within each of the at least one sub-search region respectively, to determine a respective best block vector of each sub-search region and a respective second search region corresponding to each sub-search region;
performing region determination according to the respective best block vector of each sub-search region and the respective second search region corresponding to each sub-search region, to determine at least two target sub-search regions participating in a second search;
performing the second search within the at least two target sub-search regions to determine a best block vector corresponding to the at least two target sub-search regions; and
taking the best block vector corresponding to the at least two target sub-search regions as the target block vector.

It should be noted that, in the embodiments of the present disclosure, the search region of the template of the current block may be a reconstructed part of the CTB where the current block is located, or may be other reconstructed CTB regions. The search region here is actually a set of all search points. Since a shape of the region is often not representable by a single rectangular region, in a specific implementation, the search may be performed in multiple rectangular regions, and then the final best reference block and best block vector are obtained by overall considering the search results of different regions.

It should also be noted that, in the embodiments of the present disclosure, still taking FIG. 7F as an example, the preset search region is partitioned into four sub-search regions, each sub-search region is represented by regionId, and a value of regionId may be equal to 0, 1, 2, and 3. According to a search point (iPosHor, iPosVer) in each sub-search region, that is, each block vector (BV) (consisting of horizontal and vertical components: (pX, pY), where pX=iPosHor-xTbCmp, pY=iPosVer-yTbCmp, then pX is between bvXMins and bvXMaxs, and pY is between bvYMins and bvYMaxs), the reference block that matches with the current block may be found in the reconstructed region, and the neighboring reconstructed samples of the reference block are the reference template. In this way, the matching cost between the first template of the current block and the reference template may be calculated, which is recorded as pDiff.

In this way, all search points in all search ranges (regionId=0, 1, 2, 3) are traversed, and a search point with the minimum matching cost pDiff is obtained by comparison, its corresponding matching cost is recorded as pDiff_BEST, its corresponding block vector is recorded as the best block vector BV_BEST (pX_BEST, pY_BEST), which is the target block vector described in the present embodiment, and its corresponding best matched template T_BEST is the reference template finally required.

In S2002: in response to the reference template meeting a first preset condition, first processing is performed on an adjacent region of the reference template to determine a matching template, and a model parameter is determined according to the first template and the matching template.

It should be noted that, in the embodiments of the present disclosure, the model parameter may include coefficients of a target filter. In some embodiments, the method may further include: determining the coefficients of the target filter according to sample reference values in the first template and sample reference values in the matching template.

It should also be noted that, in the embodiments of the present disclosure, the matching template may include: samples in the reference template and samples in the adjacent region of the reference template.

In some embodiments, the method may further include: in response to samples outside the reference template being used, determining that the reference template meets the first preset condition. That is, if the reference template is at a boundary of a picture, then the samples outside the reference template need to be used, and specifically, for samples of the reference template close to the boundary, neighboring samples need to be used, where these neighboring samples may be outside the boundary. In this case, it is determined that the reference template meets the first preset condition, and then the first processing needs to be performed on the adjacent region of the reference template.

In some embodiments, in response to the reference template meeting the first preset condition, performing the first processing on the adjacent region of the reference template may include: in response to the samples outside the reference template being used, performing padding processing on samples in the adjacent region of the reference template.

In some embodiments, performing the padding processing on the samples in the adjacent region of the reference template may include:
determining whether the samples in the adjacent region of the reference template are available; and
in response to the samples in the adjacent region of the reference template being available, directly using the samples in the adjacent region of the reference template; or
in response to the samples in the adjacent region of the reference template being unavailable, performing the padding processing on the adjacent region of the reference template by copying reconstructed samples in a target matching template or a target reference block that are closest to the samples, to obtain samples in the adjacent region of the reference template.

In some embodiments, the samples in the adjacent region of the reference template being available may include at least one of:
the samples being within a boundary of a picture;
the samples being within a boundary of a tile; or
the samples having been reconstructed.

In some embodiments, performing the padding processing on the samples in the adjacent region of the reference template may include:
determining whether the samples in the adjacent region of the reference template exceed a preset search range; and
in response to the samples in the adjacent region of the reference template not exceeding the preset search range, directly using the samples in the adjacent region of the reference template; or
in response to the samples in the adjacent region of the reference template exceeding the preset search range, performing the padding processing on the adjacent region of the reference template by copying reconstructed samples in a target matching template or a target reference block that are closest to the samples, to obtain samples in the adjacent region of the reference template.

In some embodiments, the method may further include: in response to the reference template meeting a second preset condition, directly taking the reference template as the matching template, and performing the operation of determining the model parameter according to the first template and the matching template.

In some embodiments, the reference template meeting the second preset condition includes: the reference template not meeting the first preset condition.

In some embodiments, the reference template meeting the second preset condition includes at least one of:
the reference template not being at a boundary of a picture;
the reference template not exceeding a preset search range;
all samples in the reference template having been reconstructed;
samples in the reference template being in a same tile with the current block; or
no samples outside the reference template being used.

That is, in the embodiments of the present disclosure, if the samples in the adjacent region of the reference template need to be used, the padding processing needs to be performed on the samples in the adjacent region of the reference template.

It should also be noted that, in the embodiments of the present disclosure, the coefficients of the target filter may be determined by solving an optimization problem. Accordingly, in some embodiments, the method may further include: the coefficients of the target filter are coefficients used by the target filter when a first error between output values obtained after processing is performed on the sample reference values in the matching template by the target filter and the sample reference values in the first template meets a first condition.

It should be understood that, for the first error meeting the first condition, in a possible implementation, the first condition is that the first error is minimum. Alternatively, in another possible implementation, the first condition is that the first error is within a first preset threshold range. Alternatively, in yet another possible implementation, the first condition is that variation magnitude of the first error is within a second preset threshold range.

It should also be understood that both the first preset threshold range and the second preset threshold range are measurement criteria preset by the decoding side for determining whether the first error meets the first condition. In addition, the first error here may be Mean Square Error (MSE), or Sum of Square Error (SSE), or Sum of Absolute Difference (SAD), or Sum of Absolute Transformed Difference (SATD) after Hardman Variation, or Mean Absolute Error (MAE), and so on, which is not specifically limited in the embodiments of the present disclosure.

In some embodiments, determining the coefficients of the target filter according to the sample reference values in the first template and the sample reference values in the matching template may include:
determining an autocorrelation parameter according to the sample reference values in the matching template;
determining a cross-correlation parameter according to the sample reference values in the first template and the sample reference values in the matching template; and
determining the coefficients of the target filter according to the autocorrelation parameter and the cross-correlation parameter.

It should be noted that, in the embodiments of the present disclosure, a sample reference value includes at least one of: a sample reconstructed value, a sample gradient value or sample position information.

That is, in the embodiments of the present disclosure, the target filter serves as the filter model in the embodiments of the present disclosure, and the input information of the target filter is the sample reference values in the matching template. Here, the coefficients of the target filter may be represented by c_{k,l}, which may also be called filter coefficients in the present embodiment. The input information for calculating the filter coefficients may be the available reconstructed samples in the matching template. Or, by calculating the gradient of each reconstructed sample in the matching template, including but not limited to the horizontal gradient, vertical gradient and so on, the calculated gradients may be used as the input information for calculating the filter coefficients. Or, the position information of each reconstructed sample may further be used as the input information for calculating the filter coefficients, where the position information may be absolute position information of each reconstructed sample in the entire picture, or relative position information of each reconstructed sample relative to a certain reference point, which is not specifically limited here.

In a specific embodiment, a reconstructed region R for calculating the filter coefficients is first determined, and then a set of filter coefficients may be derived by minimizing MSE between the reconstructed samples within the region R and the reconstructed samples within the first template, as shown in the above equations (3) and (4).

Further, the specific process of minimizing MSE to derive the filter coefficients is as follows.

First, find the partial derivative of c_{k,l} and set it to 0, which is shown in the above equations (5) and (6); where k and/are between −1 and 1, and m and n are between −1 and 1.

Secondly, according to the equations (5) and (6), equation shown in the equation (7) is obtained.

Again, after determining the reconstructed region R, the equation (7) is expanded into a matrix form, as shown in above equations (8) to (10).

In this way, since the autocorrelation matrix of refTemp in the reconstructed region R and the cross-correlation vector between refTemp and recTemp are known quantities, the filter coefficients c_{k,l} may be calculated by solving the equation group shown in equation (7); and fixed-point quantization may be performed on the filter coefficients c_{k,l}, or fixed-point quantization may not be performed on the filter coefficients c_{k,l}.

In addition, in the embodiments of the present disclosure, for the target filter, it is further necessary to determine the number of the coefficients of the target filter and the shape of the target filter. The number of the coefficients of the target filter and the shape of the target filter may be preset fixed values or have an association relationship with the size of the current block.

In some embodiments, for the number of the coefficients of the target filter, the method may further include that the number of the coefficients of the target filter is equal to a first preset value.

In some embodiments, for the number of the coefficients of the target filter, the method may further include: determining the number of the coefficients of the target filter; encoding the number of the coefficients of the target filter, and signalling an obtained encoded bit into the bitstream.

It should be noted that the number of the coefficients of the target filter may be represented by nTap. For example, the value of nTap may be 4, 5, 6, 7, 8, 9 and so on, but is not specifically limited thereto.

It should also be noted that the number of the coefficients of the target filter may also be called the number of taps of the target filter. Here, the number of the coefficients of the target filter may be a preset constant value, or may be determined according to the size of the current block, which is not specifically limited here.

In some embodiments, for the shape of the target filter, the method may further include that the target filter is a one-dimensional or two-dimensional filter with a preset shape.

In some embodiments, for the shape of the target filter, the method may further include: determining the shape of the target filter; encoding the shape of the target filter, and signalling an obtained encoded bit into the bitstream.

In some embodiments, the method may further include: determining a value of a filter shape parameter, where the filter shape parameter indicates the shape of the target filter. Further, the method may further include: encoding the value of the filter shape parameter, and signalling an obtained encoded bit into the bitstream.

It should be noted that the filter shape parameter may be represented by FilterIdx, and FilterIdx is used for indicating the shape of the target filter. For example, the shape of the target filter may be a diamond, a rectangle, a cross, a stripe, or even may be a one-dimensional filter, a two-dimensional filter and so on, but is not specifically limited thereto.

For example, if the value of FilterIdx is equal to 0, it is determined that the shape of the target filter is a diamond; if the value of FilterIdx is equal to 1, it is determined that the shape of the target filter is a cross; or if the value of FilterIdx is equal to 2, it is determined that the shape of the target filter is a rectangle.

It should also be noted that the shape of the target filter may be a preset shape, or may be determined by the value of the filter shape parameter, or may even be determined according to the size of the current block, which is not specifically limited here.

In S2003: filtering processing is performed on the reference block according to the model parameter to determine a filtered reference block.

In S2004: a prediction value of the current block is determined according to the filtered reference block.

It should be noted that, in the embodiments of the present disclosure, after the model parameter is determined, the prediction value of the current block may be determined according to the model parameter and the reference block. Exemplarily, the filtering processing is performed on the reference block according to the model parameter, and then the prediction value of the current block is determined according to the filtered reference block.

In some embodiments, performing the filtering processing on the reference block according to the model parameter to determine the filtered reference block may include: in response to samples in the adjacent region of the reference block being used, performing padding processing on the samples in the adjacent region of the reference block. That is, in the embodiments of the present disclosure, the samples in the adjacent region of the reference block need to be used, then the padding processing needs to be performed on the samples in the adjacent region of the reference block.

In some embodiments, performing the filtering processing on the reference block according to the model parameter to determine the filtered reference block may include: performing the filtering processing on the reference block according to the model parameter to determine a first output value of the target filter; and determining the filtered reference block based on the first output value of the target filter.

In an embodiment of the present disclosure, the first output value of the target filter may be calculated according to the sample reconstructed values of the reference block and the coefficients of the target filter in the model parameter; then, according to the first output value of the target filter, the filtered reference block may be determined. The target filter here may be a linear filter model or a nonlinear filter model, which is not specifically limited.

In a possible implementation, performing the filtering processing on the reference block according to the model parameter to determine the first output value of the target filter may include:
calculating a respective product of each sample reconstructed value of the reference block and a corresponding coefficient of the target filter; and
setting the first output value of the target filter to be equal to a sum of n products; where n represents the number of the coefficients of the target filter, and n is a positive integer.

It should be noted that, in the embodiments of the present disclosure, the target filter is a linear filter model. The first output value of the target filter may be calculated using the above equation (11).

In another possible implementation, performing the filtering processing on the reference block according to the model parameter to determine the first output value of the target filter may include:
determining a respective first value of each sample reconstructed value of the reference block under a first mapping relationship;
calculating a respective product of the respective first value and a corresponding coefficient of the target filter; and
setting the first output value of the target filter to be equal to a sum of n products; where n represents the number of the coefficients of the target filter, and n is a positive integer.

It should be noted that, in the embodiments of the present disclosure, the target filter is a nonlinear filtering model. For example, when minimizing MSE of the filter coefficients, it may be calculated using the above equations (12) and (13).

It should also be noted that, in the embodiments of the present disclosure, determining the filtered reference block based on the first output value of the target filter may include: directly setting the first output value of the target filter as the filtered reference block; or may include: performing first filtering on the first output value of the target filter to obtain the filtered reference block. The first filtering here may be a low-pass filtering, an upsampling/downsampling filtering and so on, which is not specifically limited here.

It should also be noted that, in the embodiments of the present disclosure, after determining the first output value of the target filter, a first bias value (represented by bias) may be added to the first output value to determine the filtered reference block.

In some embodiments, determining the filtered reference block based on the first output value of the target filter may include: determining a first bias value; and performing addition operation according to the first output value and the first bias value to determine the filtered reference block.

In a possible implementation, determining the first bias value may include: setting the first bias value to be equal to a second preset value.

In another possible implementation, determining the first bias value may include: determining an (n+1)-th coefficient of the target filter in response to the number of the coefficients of the target filter being n; and determining the first bias value according to the (n+1)-th coefficient and a second bias value.

In the embodiments of the present disclosure, for the second bias value, the method may further include: setting the second bias value to be equal to a third preset value; or setting the second bias value to be equal to a value of a sample reconstructed value of the reference block under a second mapping relationship.

It should be noted that, in the embodiments of the present disclosure, the calculated filter coefficients are used as the number of taps corresponding to the filter template, that is, the number of filter coefficients is equal to the number of taps of the filter template (nTap). In addition, several biases may be added to the filter template, for example, in the embodiments of the present disclosure, when nTap=5, the filter coefficients are the tap coefficients corresponding to the filter template c₀ to c₄, and the prediction value of the position (i, j) in the filtered reference block is calculated according to the above equations (14) and (15).

Further, in some embodiments, the operation that the prediction value of the current block is determining according to the filtered reference block may include: performing second processing on the filtered reference block to obtain the prediction value of the current block.

In the embodiments of the present disclosure, for the second processing, the second processing is to set the prediction value of the current block to be equal to the filtered reference block; or the second processing may be a clip operation of limiting the filtered reference block to a preset numerical range, or the second processing may be other operations, which are not specifically limited here.

Here, for the clip operation, the preset numerical range may be: a range between 0 and (1<<BitDepth)−1, where BitDepth represents a bit depth. If the value of the filtered reference block exceeds the preset numerical range, then a corresponding correction operation needs to be performed on the filtered reference block. For example, the filtered reference block may also be represented by Y^{pred}[i][j], and then, the correction operation may be performed on Y^{pred}[i][j]. The details are as follows:

```
  when the value of Y^{pred}[i][j] is less than 0, setting it to 0;
  when the value of Y^{pred}[i][j] is greater than or equal to 0 and less
  than or equal to
(1<<BitDepth)−1, setting it equal to Y^{pred}[i][j]; or
  when the value of Y^{pred}[i][j] is greater than (1<<BitDepth)−1,
  setting it to
(1<<BitDepth)−1.
```

In this way, after the correction operation is performed on Y^{pred}[i][j], it may be ensured that all sample values in the filtered reference block are between 0 and (1<<BitDepth)−1.

Further, the number of filter models may be expanded. In addition to establishing only one filter model, multiple filter models may also be established. Therefore, in some embodiments, the method may further include:
determining a plurality of groups of model parameters according to the first template and the matching template;
constructing a plurality of filter models according to the plurality of groups of model parameters, and performing the filtering processing on the reference block according to the plurality of filter models respectively, to determine a plurality of filtered reference blocks; and
determining the prediction value of the current block according to the plurality of filtered reference blocks.

In some embodiments, determining the plurality of groups of model parameters according to the first template and the matching template may include: classifying reconstructed samples in the first template and reconstructed samples in the matching template according to a preset manner respectively, to obtain a plurality of groups of sub-templates and a plurality of groups of sub-matching templates; and determining the plurality of groups of model parameters according to the plurality of groups of sub-templates and the plurality of groups of sub-matching templates.

It should be noted that, in the embodiments of the present disclosure, the preset manner here may be the magnitude of the reconstructed sample value, or may be the position information of the reconstructed sample, or may be the shape of the filter, and so on, which is not limited here. After classifying in the preset manner, a respective group of model parameters may be calculated according to each group of sub-templates and the corresponding sub-matching template, and each group of model parameters may determine one filter model, so that the multiple filter models may be constructed.

In a possible implementation, the method may further include: determining a target filter from the plurality of filter models; and performing the filtering processing on the reference block according to the target filter to determine the prediction value of the current block.

Further, in some embodiments, the method may further include: determining a target model index value, where the target model index value is used for indicating an index number of the target filter in the plurality of filter models; and encoding the target model index value, and signalling an obtained encoded bit into the bitstream.

Further, in some embodiments, determining the target filter from the plurality of filter models may include: determining an original value of the current block; performing rate-distortion cost calculation according to the original value of the current block and a plurality of initial prediction values of the current block respectively, to determine a respective rate-distortion cost value of each of the plurality of initial prediction values; determining a minimum rate-distortion cost value from the respective rate-distortion cost values of each of the plurality of initial prediction values; and taking a filter model corresponding to the minimum rate-distortion cost value as the target filter.

In another possible implementation, the filtering processing may be performed on the reference block according to the plurality of filter models respectively, to determine the plurality of filtered reference blocks. In some embodiments, determining the prediction value of the current block according to the plurality of filtered reference blocks may include: performing weighted calculation on the plurality of filtered reference blocks to determine the prediction value of the current block.

It should be noted that, if the weight value of each filtered reference block is equal and equal to the reciprocal of the number of reference blocks, then the weighted calculation here may also be regarded as a mean calculation. In other words, mean operation is performed on the plurality of filtered reference blocks, to determine the prediction value of the current block.

For example, the input information for calculating the filter coefficients is classified, and a filter model is established for each category of input information, respectively. For example, when using the reconstructed information to establish a filter model, one possible implementation is to use the mean value of the reconstructed information for classification; and a filter model is established for the reconstructed information greater than the mean value and a filter model is established for the reconstructed information less than the mean value. Another possible implementation is to use the position of the reconstructed information for classification. For example, a first filter model may be established using the available reconstructed information on the left and top sides, and a second filter model may be established using the available reconstructed information on the left and top-left sides, and so on; and the encoder determines which model should be used. One possible decision implementation is that the encoder determines which model should be used by means of rate-distortion optimization and transmits the corresponding decoding parameter to the decoder, so that the decoder may clearly select which filter model to use. Another possible implementation is to use the shape of the filter for classification. Multiple filters with different shapes may be used and a respective filter model is established for each filter shape; and the encoder determines which filter shape should be used. One possible decision implementation is that the encoder determines which model should be used by means of rate-distortion optimization and transmits the corresponding decoding parameter to the decoder, so that the decoder may clearly select which filter model to use.

In S2005: a prediction residual of the current block is determined according to the prediction value of the current block.

It should be noted that, in the embodiments of the present disclosure, after determining the prediction value of the current block, the prediction residual of the current block may further be calculated. In some embodiments, the operation that the prediction residual of the current block is determined according to the prediction value of the current block may include: determining an original value of the current block; and determining the prediction residual of the current block according to the original value of the current block and the prediction value of the current block.

In a specific embodiment, determining the prediction residual of the current block according to the original value of the current block and the prediction value of the current block may include: performing subtraction operation on the original value of the current block and the prediction value of the current block, to determine the reconstructed value of the current block.

It should also be noted that, in the embodiments of the present disclosure, whether the intra template matching or the filter model is applied to the current block may be determined by different pieces of syntax element flag information. In some embodiments, the method may further include: determining a value of first syntax element flag information, where the first syntax element flag information is used for indicating whether intra template matching is applied to the current block; and encoding the value of the first syntax element flag information, and signalling an obtained encoded bit into a bitstream.

In the embodiments of the present disclosure, determining the value of the first syntax element flag information may include: in response to the intra template matching being applied to the current block, determining that the value of the first syntax element flag information is a first value; or in response to the intra template matching not being applied to the current block, determining that the value of the first syntax element flag information is a second value.

Further, in some embodiments, in response to the first syntax element flag information being used for indicating that the intra template matching is applied to the current block, the method may further include: determining a value of second syntax element flag information, where the second syntax element flag information is used for indicating whether a filter model is applied to the current block; and encoding the value of the second syntax element flag information, and signalling an obtained encoded bits into the bitstream.

In the embodiments of the present disclosure, determining the value of the second syntax element flag information may include: in response to the filter model being applied to the current block, determining that the value of the second syntax element flag information is a first value; or in response to the filter model being not applied to the current block, determining that the value of the second syntax element flag information is a second value.

Further, in some embodiments, the method may further include:
in response to the filter model being applied to the current block, performing the operation of performing the filtering processing on the reference block according to the model parameter to determine the filtered reference block and the operation of determining the prediction value of the current block according to the filtered reference block; or
in response to the filter model being not applied to the current block, using the reconstructed sample value in the reference block as the prediction value of the current block.

It should be noted that, in the embodiments of the present disclosure, the first value and the second value are different, and the first value and the second value may be in a parameter form or in a digital form. Exemplarily, the first syntax element flag information and the second syntax element flag information may be parameters signalled into a profile, or may be the value of a flag, which is not specifically limited here. For example, for the first value and the second value, the first value may be set to 1, and the second value may be set to 0; or the first value may be set to true, and the second value may be set to false, which is not specifically limited here.

It should also be noted that, in the embodiments of the present disclosure, it is determined whether the current block uses the filtered reference block as the final prediction value by certain conditions, but it is not limited to the following three manners. For example, the three manners may be as follows.

Manner 1: it is determined whether to perform filtering on the matching template by comparing the distortion between the matching template and the current block template (such as SAD, MSE, SATD, SSE) with a threshold T_Distortion1.

Manner 2: on the basis that Manner 1 meets the use of the filter model, it is determined whether to perform filtering on the reference block through the distortion between the filtered matching template and the template of the current block (such as SAD or MSE or SATD or SSE) and a threshold T_Distortion2.

Manner 3: the encoding side transmits a Flag to indicate whether to apply the filter model, in which tmpFlag indicates whether the intra template matching is applied to the current block, and filterFlag indicates whether the filter model is applied to the current block. When the value of tmpFlag is 1, the encoding side determines whether to perform filtering on the reference block by comparing the distortion between the filtered reference block (i.e., the reference block after filtering) and the current block and the distortion between the unfiltered reference block (i.e., reference block before filtering) and the current block, such as SAD or MSE or SATD or SSE. If the distortion after filtering is less than the distortion before filtering, the value of filterFlag is 1 and the filtered reference block is used as the prediction block of the current block; otherwise, the value of filterFlag is 0 and the unfiltered reference block is used as the prediction block of the current block, and the encoding side transmits filterFlag to the decoding side. There are many implementations for the encoding of filterFlag. One possible implementation is to use equal-probability encoding; and another possible implementation is to use context encoding, where a default context initial state and context update rate may be used, or the context initial state and context update rate may be determined by statistics.

Further, the embodiments of the present disclosure further provides a bitstream, which is generated by bit encoding according to information to be encoded; where the information to be encoded includes at least one of: a prediction residual of a current block, a number of coefficients of a target filter, a shape of a target filter, a value of first syntax element flag information or a value of second syntax element flag information.

In the embodiments of the present disclosure, the first syntax element flag information is used for indicating whether intra template matching is applied to the current block, and the second syntax element flag information is used for indicating whether a filter model is applied to the current block.

The present embodiment of the present disclosure provides an encoding method, which includes: determining a first template of a current block and determining a matching template and a reference block; determining a model parameter according to the first template and the matching template; performing filtering processing on the reference block according to the model parameter to determine a filtered reference block; determining a prediction value of the current block according to the filtered reference block; and determining a prediction residual of the current block according to the prediction value of the current block. In this way, the model parameter is determined according to the first template and the matching template, the model parameter fully reflects the correlation between the matching template and the first template of the current block, the correlation is applied to the reference block, and then, by performing filtering and correction on the reconstructed sample of the reference block, the filtered reconstructed sample is used as the prediction sample of the current block. As such, the prediction accuracy may be improved and bit rate may be reduced, while the encoding and decoding efficiency may also be improved, thereby enhancing the encoding and decoding performance.

In yet another embodiment of the present disclosure, based on the same inventive concept as the above embodiments, referring to FIG. 21, a schematic diagram of a composition structure of an encoder provided by the embodiments of the present disclosure is illustrated. As illustrated in FIG. 21, the encoder 210 may include: a first determining unit 2101, a first filtering unit 2102 and a first prediction unit 2103; where
the first determining unit 2101 is configured to determine a first template of a current block, and determine a reference template and a reference block; and is further configured to perform first processing on an adjacent region of the reference template in response to the reference template meeting a first preset condition, to determine a matching template, and determine a model parameter according to the first template and the matching template;
the first filtering unit 2102 is configured to perform filtering processing on the reference block according to the model parameter to determine a filtered reference block;
the first prediction unit 2103 is configured to determine a prediction value of the current block according to the filtered reference block; and
the first determining unit 2101 is further configured to determine a prediction residual of the current block according to the prediction value of the current block.

In some embodiments, the matching template includes: samples in the reference template and samples in the adjacent region of the reference template.

In some embodiments, the first determining unit 2101 is further configured to determine that the reference template meets the first preset condition in response to samples outside the reference template being used.

In some embodiments, the first determining unit 2101 is further configured to perform padding processing on samples in the adjacent region of the reference template in response to the samples outside the reference template being used.

In some embodiments, the first determination unit 2101 is further configured to determine whether the samples in the adjacent region of the reference template are available; and in response to the samples in the adjacent region of the reference template being available, directly use the samples in the adjacent region of the reference template; or in response to the samples in the adjacent region of the reference template being unavailable, perform the padding processing on the adjacent region of the reference template by copying reconstructed samples in a target matching template or a target reference block that are closest to the samples, to obtain samples in the adjacent region of the reference template.

In some embodiments, the samples in the adjacent region of the reference template being available includes at least one of:
the samples being within a boundary of a picture;
the samples being within a boundary of a tile; or
the samples having been reconstructed.

In some embodiments, the first determining unit 2101 is further configured to determine whether the samples in the adjacent region of the reference template exceed a preset search range; and in response to the samples in the adjacent region of the reference template not exceeding the preset search range, directly use the samples in the adjacent region of the reference template; or in response to the samples in the adjacent region of the reference template exceeding the preset search range, perform the padding processing on the adjacent region of the reference template by copying reconstructed samples in a target matching template or a target reference block that are closest to the samples, to obtain samples in the adjacent region of the reference template.

In some embodiments, the first determining unit 2101 is further configured to directly take, in response to the reference template meeting a second preset condition, the reference template as the matching template, and perform the operation of determining the model parameter according to the first template and the matching template.

In some embodiments, the reference template meeting the second preset condition includes: the reference template not meeting the first preset condition.

In some embodiments, the reference template meeting the second preset condition includes at least one of:
the reference template not being at a boundary of a picture;
the reference template not exceeding a preset search range;
all samples in the reference template having been reconstructed;
samples in the reference template being in a same tile with the current block; or
no samples outside the reference template being used.

In some embodiments, the first determining unit 2101 is further configured to perform padding processing on samples in the adjacent region of the reference block in response to the samples in the adjacent region of the reference block being used.

In some embodiments, the first determining unit 2101 is further configured to determine a template type of the current block; and determine the first template of the current block according to the template type of the current block.

In some embodiments, the first determining unit 2101 is further configured to determine the template type of the current block according to reference samples of the current block; where the reference samples of the current block include at least one of: left neighboring reference samples of the current block, top neighboring reference samples of the current block, top-left neighboring reference samples of the current block, bottom-left neighboring reference samples of the current block, or top-right neighboring reference samples of the current block.

In some embodiments, the first determining unit 2101 is further configured to determine that the template type of the current block is a first value in response to the left neighboring reference samples of the current block, the top neighboring reference samples of the current block and the top-left neighboring reference samples of the current block being all available; determine that the template type of the current block is a second value in response to the left neighboring reference samples of the current block being available; determine that the template type of the current block is a third value in response to the top neighboring reference samples of the current block being available; determine that the template type of the current block is a fourth value in response to the left neighboring reference samples of the current block and the top-left neighboring reference samples of the current block being all available; determine that the template type of the current block is a fifth value in response to the left neighboring reference samples of the current block and the bottom-left neighboring reference samples of the current block being all available; or determine that the template type of the current block is a sixth value in response to the top neighboring reference samples of the current block and the top-right neighboring reference samples of the current block being all available.

In some embodiments, the first determining unit 2101 is further configured to perform template matching within a preset search region according to the first template to determine the reference template; and determine the reference block according to the reference template.

In some embodiments, the first determining unit 2101 is further configured to perform a search within the preset search region based on the first template to determine a target block vector, and determine the reference template according to the target block vector.

In some embodiments, the first determining unit 2101 is further configured to determine a motion parameter and a corresponding reference block; determine the reference template according to the first template and the reference block; and encode the motion parameter, and signal an obtained encoded bit into a bitstream.

In some embodiments, the first determining unit 2101 is further configured to perform a first search within the preset search region to determine the target block vector; or perform a second search within the preset search region to determine the target block vector; where a search step corresponding to the first search is greater than a search step corresponding to the second search.

In some embodiments, the first determining unit 2101 is further configured to perform a first search within the preset search region to determine a first block vector, and determine an initial matching template according to the first block vector; and determine a first search region according to the initial matching template, and perform a second search within the first search region to determine the target block vector; where a search step corresponding to the first search is greater than a search step corresponding to the second search, and the first search region is smaller than the preset search region.

In some embodiments, the preset search region includes at least one sub-search region; and the first determining unit 2101 is further configured to perform the search within each of the at least one sub-search region respectively, to determine a respective best block vector of each sub-search region and a respective matching cost value corresponding to each sub-search region; determine a best block vector corresponding to a minimum matching cost value according to the respective best block vector of each sub-search region and the respective matching cost value corresponding to each sub-search region; and take the best block vector corresponding to the minimum matching cost value as the target block vector.

In some embodiments, the first determining unit 2101 is further configured to perform a first search within each of the at least one sub-search region respectively, to determine a respective best block vector of each sub-search region and a respective second search region corresponding to each sub-search region; perform region determination according to the respective best block vector of each sub-search region and the respective second search region corresponding to each sub-search region to determine at least two target sub-search regions participating in a second search; perform the second search within the at least two target sub-search regions to determine a best block vector corresponding to the at least two target sub-search regions; and take the best block vector corresponding to the at least two target sub-search regions as the target block vector.

In some embodiments, the model parameter includes coefficients of a target filter.

In some embodiments, the first determining unit 2101 is further configured to determine the coefficients of the target filter according to sample reference values in the first template and sample reference values in the matching template.

In some embodiments, the first determining unit 2101 is further configured to perform padding processing on the samples in the adjacent region of the matching template in response to the samples in the adjacent region of the matching template being used.

In some embodiments, the coefficients of the target filter are coefficients used by the target filter when a first error between output values obtained after processing is performed on the sample reference values in the matching template by the target filter and the sample reference values in the first template meets a first condition.

In some embodiments, the first condition is that the first error is minimum.

In some embodiments, the first condition is that the first error is within a first preset threshold range.

In some embodiments, the first condition is that variation magnitude of the first error is within a second preset threshold range.

In some embodiments, the first determining unit 2101 is further configured to determine an autocorrelation parameter according to the sample reference values in the matching template; determine a cross-correlation parameter according to the sample reference values in the first template and the sample reference values in the matching template; and determine the coefficients of the target filter according to the autocorrelation parameter and the cross-correlation parameter.

In some embodiments, a sample reference value includes at least one of: a sample reconstructed value, a sample gradient value or sample position information.

In some embodiments, a number of the coefficients of the target filter is equal to a first preset value.

In some embodiments, the first determining unit 2101 is further configured to determine a number of the coefficients of the target filter; and encode the number of the coefficients of the target filter, and signal an obtained encoded bit into a bitstream.

In some embodiments, the target filter is a one-dimensional or two-dimensional filter with a preset shape.

In some embodiments, the first determining unit 2101 is further configured to determine a shape of the target filter; and encode the shape of the target filter, and signal an obtained encoded bit into a bitstream.

In some embodiments, the first filtering unit 2102 is further configured to perform the filtering processing on the reference block according to the model parameter to determine a first output value of the target filter; and determine the filtered reference block based on the first output value of the target filter.

In some embodiments, the first filtering unit 2102 is further configured to perform padding processing on the samples in the adjacent region of the reference block in response to that the samples in the adjacent region of the reference block need to be used.

In some embodiments, the first filtering unit 2102 is further configured to calculate a respective product of each sample reconstructed value of the reference block and a corresponding coefficient of the target filter; and set the first output value of the target filter to be equal to a sum of n products; where n represents a number of the coefficients of the target filter, and n is a positive integer.

In some embodiments, the first filtering unit 2102 is further configured to determine a respective first value of each sample reconstructed value of the reference block under a first mapping relationship; calculate a respective product of the respective first value and a corresponding coefficient of the target filter; and set the first output value of the target filter to be equal to a sum of n products; where n represents a number of the coefficients of the target filter, and n is a positive integer.

In some embodiments, the first filtering unit 2102 is further configured to determine a first bias value; and perform addition operation according to the first output value and the first bias value to determine the filtered reference block.

In some embodiments, the first filtering unit 2102 is further configured to set the first bias value to be equal to a second preset value.

In some embodiments, the first filtering unit 2102 is further configured to determine an (n+1)-th coefficient of the target filter in response to a number of the coefficients of the target filter being n; and determine the first bias value according to the (n+1)-th coefficient and a second bias value.

In some embodiments, the first filtering unit 2102 is further configured to set the second bias value to be equal to a third preset value; or set the second bias value to be equal to a value of a sample reconstructed value of the reference block under a second mapping relationship.

In some embodiments, the first prediction unit 2103 is further configured to perform second processing on the filtered reference block to obtain the prediction value of the current block.

In some embodiments, the second processing is to set the prediction value of the current block to be equal to the filtered reference block.

In some embodiments, the second processing is a clip operation of limiting the filtered reference block to a preset numerical range.

In some embodiments, the first prediction unit 2103 is further configured to determine a plurality of groups of model parameters according to the first template and the matching template; construct a plurality of filter models according to the plurality of groups of model parameters, and perform the filtering processing on the reference block according to the plurality of filter models respectively, to determine a plurality of filtered reference blocks; and determine the prediction value of the current block according to the plurality of filtered reference blocks.

In some embodiments, the first predicting unit 2103 is further configured to perform weighted calculation on the plurality of filtered reference blocks to determine the prediction value of the current block.

In some embodiments, the first prediction unit 2103 is further configured to determine a target filter from the plurality of filter models; and perform the filtering processing on the reference block according to the target filter to determine the prediction value of the current block.

In some embodiments, the first prediction unit 2103 is further configured to determine a target model index value, where the target model index value is used for indicating an index number of the target filter in the plurality of filter models; and encode the target model index value, and signals an obtained encoded bit into a bitstream.

In some embodiments, the first prediction unit 2103 is further configured to determine an original value of the current block; perform rate-distortion cost calculation according to the original value of the current block and a plurality of initial prediction values of the current block respectively, to determine a respective rate-distortion cost value of each of the plurality of initial prediction values; determine a minimum rate-distortion cost value from the respective rate-distortion cost values of each of the plurality of initial prediction values; and take a filter model corresponding to the minimum rate-distortion cost value as the target filter.

In some embodiments, the first prediction unit 2103 is further configured to classify reconstructed samples in the first template and reconstructed samples in the matching template according to a preset method respectively, to obtain a plurality of groups of sub-templates and a plurality of groups of sub-matching templates; and determine the plurality of groups of model parameters according to the plurality of groups of sub-templates and the plurality of groups of sub-matching templates.

In some embodiments, the first determining unit 2101 is further configured to determine a value of first syntax element flag information, where the first syntax element flag information is used for indicating whether intra template matching is applied to the current block; and encode the value of the first syntax element flag information, and signals an obtained encoded bit into a bitstream.

In some embodiments, the first determining unit 2101 is further configured to determine that the value of the first syntax element flag information is a first value in response to the intra template matching being applied to the current block; or determine that the value of the first syntax element flag information is a second value in response to the intra template matching not being applied to the current block.

In some embodiments, the first determining unit 2101 is further configured to determine a value of second syntax element flag information, where the second syntax element flag information is used for indicating whether a filter model is applied to the current block; and encode the value of the second syntax element flag information, and signals an obtained encoded bits into the bitstream.

In some embodiments, the first determining unit 2101 is further configured to determine that the value of the second syntax element flag information is a first value in response to the filter model being applied to the current block; or determine that the value of the second syntax element flag information is a second value in response to the filter model being not applied to the current block.

In some embodiments, the first determining unit 2101 is further configured to performs, in response to the filter model being applied to the current block, the operation of performing the filtering processing on the reference block according to the model parameter to determine the filtered reference block and the operation of determining the prediction value of the current block according to the filtered reference block; or use, in response to the filter model being not applied to the current block, the reconstructed sample value in the reference block as the prediction value of the current block.

In some embodiments, the first determining unit 2101 is further configured to determine an original value of the current block; and determine the prediction residual of the current block according to the original value of the current block and the prediction value of the current block.

It may be understood that in the embodiments of the present disclosure, the “unit” may be part of a circuit, part of a processor, part of a program or software, or the like, and may also be a module or may be non-modular. Moreover, various components in the present embodiment may be integrated into one processing unit, or each unit may be physically present alone, or two or more units may be integrated into one unit. The above integrated units may be implemented in the form of hardware or software function modules.

The integrated unit may be stored in a computer readable storage when it is implemented in the form of software functional modules and is not sold or used as a separate product. Based on such understanding, the technical solutions of the embodiments essentially, or the part of the technical solutions that contributes to the related art, or all or part of the technical solutions, may be embodied in the form of a computer software product which is stored in a non-transitory storage medium and includes various instructions for causing a computer device (which may be a personal computer, a server, or a network device and so on) or a processor to perform all or part of the steps described in the various embodiments of the present disclosure. The above non-transitory storage medium includes various media that can store program codes, such as a USB flash drive (U disk), a mobile hard disk, a read only memory (ROM), a random access memory (RAM), a diskette, or an optical disk.

Therefore, the embodiments of the present disclosure provide a non-transitory computer-readable storage medium, which is applied to the encoder 210. The non-transitory computer-readable storage medium has a computer program stored thereon, and the computer program, when executed by the first processor, implements the encoding method described in any one of the above embodiments.

Based on a composition of the encoder 210 and the non-transitory computer-readable storage medium, referring to FIG. 22, a schematic diagram of a specific hardware structure of the encoder 210 provided by the embodiments of the present disclosure is illustrated. As illustrated in FIG. 22, the encoder 210 may include: a first communication interface 2201, a first memory 2202 and a first processor 2203. Each component is coupled together via a first bus system 2204. It may be understood that the first bus system 2204 is configured to achieve connection and communication between these components. In addition to a data bus, the first bus system 2204 further includes a power bus, a control bus and a status signal bus. However, for the sake of clarity, various buses are labeled as the first bus system 2204 in FIG. 22.

The first communication interface 2201 is configured to receive and transmit signals in the process of transmitting and receiving information with other external network elements.

The first memory 2202 is configured to store a computer program executable on the first processor 2103.

The first processor 2203 is configured to, when executing the computer program, perform:
determining a first template of a current block, and determining a reference template and a reference block;
in response to the reference template meeting a first preset condition, performing first processing on an adjacent region of the reference template to determine a matching template, and determining a model parameter according to the first template and the matching template;
performing filtering processing on the reference block according to the model parameter to determine a filtered reference block;
determining a prediction value of the current block according to the filtered reference block; and
determining a prediction residual of the current block according to the prediction value of the current block.

It can be understood that the first memory 2202 in the embodiments of the present disclosure may be a volatile memory or a non-volatile memory, or may include both volatile and non-volatile memories. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), which acts as an external cache memory. By way of example but not limitation, many forms of RAM are available, such as a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synchlink DRAM, SLDRAM), and a direct memory bus random access memory (Direct Rambus RAM, DRRAM). The first memory 2202 of the systems and methods described by the present disclosure is intended to include, but is not limited to, these and any other suitable types of memories.

The first processor 2203 may be an integrated circuit chip having a signal processing capability. In the implementation process, various steps of the above methods may be completed by an integrated logic circuit of hardware or an instruction in the form of software in the first processor 2203. The first processor 2203 mentioned above may be a general-purpose processor, a digital signal processor (DSP), an application-specific integrated circuit (ASIC), a field programmable gate array (FPGA) or other programmable logic devices, discrete gate or transistor logic devices, and discrete hardware components. Various methods, steps and logic diagrams disclosed in the embodiments of the present disclosure may be implemented or performed. A general purpose processor may be a microprocessor, or the processor may be any conventional processor or the like. The steps of the method disclosed according to the embodiments of the present disclosure may be directly implemented by a hardware decoding processor, or may be implemented by a combination of hardware and software modules in the decoding processor. The software module may be located in a random access memory, a flash memory, a read-only memory, a programmable read-only memory, or an electrically erasable programmable memory, a register, or other mature storage media in the art. The non-transitory storage medium is located in the first memory 2202, and the first processor 2203 reads the information in the first memory 2202 and completes the steps of the above methods in combination with its hardware.

It is to be understood that the embodiments described in the present disclosure may be implemented by hardware, software, firmware, middleware, microcode, or a combination thereof. For hardware implementation, the processing unit may be implemented in one or more application specific integrated circuits (ASIC), digital signal processing (DSP), digital signal processing devices (DSPD), programmable logic devices (PLD), field programmable gate arrays (FPGA), general-purpose processors, controllers, microcontrollers, microprocessors, other electronic units configured to perform the functions described in the present disclosure, or a combination thereof. For software implementation, the technology described in the present disclosure may be implemented through modules (e.g., procedures, functions) that perform the functions described in the present disclosure. The software codes may be stored in a memory and executed by a processor. The memory may be implemented within the processor or external to the processor.

Optionally, as another embodiment, the first processor 2203 is further configured to perform the encoding method described in any one of the above embodiments when executing the computer program.

The present embodiment provides an encoder. For the encoder, the model parameter is determined based on the first template and the matching template. The model parameter fully reflects the correlation between the matching template and the first template of the current block, and the correlation is applied to the reference block, which may effectively correct the prediction value based on the intra template matching technique, thereby improving the prediction accuracy and saving bit rate, while may further improve the encoding and decoding efficiency, thereby improving the encoding and decoding performance.

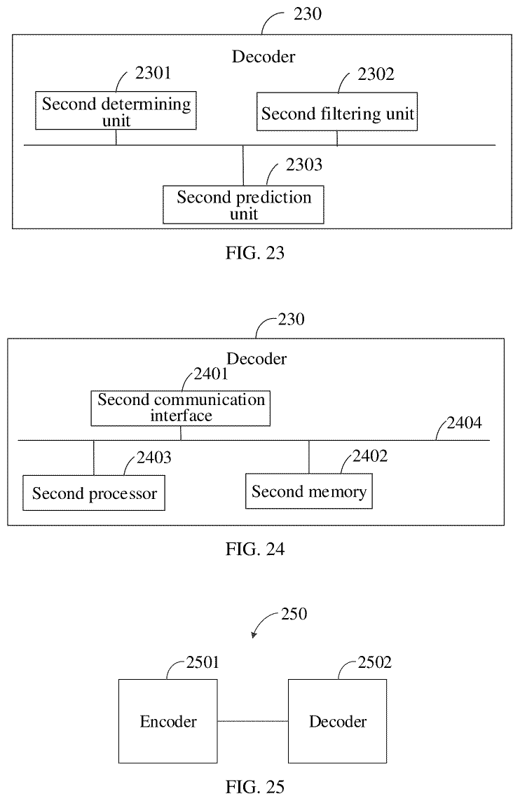

In still another embodiment of the present disclosure, based on the same inventive concept as the above embodiments, referring to FIG. 23, a schematic diagram of a composition structure of a decoder 230 provided by the embodiments of the present disclosure is illustrated. As illustrated in FIG. 23, the decoder 230 may include: a second determining unit 2301, a second filtering unit 2302 and a second prediction unit 2303; where
the second determining unit 2301 is configured to determine a first template of a current block, and determine a reference template and a reference block; and is further configured to perform first processing on an adjacent region of the reference template in response to the reference template meeting a first preset condition, to determine a matching template, and determine a model parameter according to the first template and the matching template;
the second filtering unit 2302 is configured to perform filtering processing on the reference block according to the model parameter to determine a filtered reference block;
the second prediction unit 2303 is configured to determine a prediction value of the current block according to the filtered reference block; and
the second determining unit 2301 is further configured to determine a reconstructed value of the current block according to the prediction value of the current block.

In some embodiments, the matching template includes: samples in the reference template and samples in the adjacent region of the reference template.

In some embodiments, the second determining unit 2301 is further configured to determine that the reference template meets the first preset condition in response to samples outside the reference template being used.

In some embodiments, the second determining unit 2301 is further configured to perform padding processing on samples in the adjacent region of the reference template in response to the samples outside the reference template being used.

In some embodiments, the second determining unit 2301 is further configured to determine whether the samples in the adjacent region of the reference template are available; and in response to the samples in the adjacent region of the reference template being available, directly use the samples in the adjacent region of the reference template; or in response to the samples in the adjacent region of the reference template being unavailable, perform the padding processing on the adjacent region of the reference template by copying reconstructed samples in a target matching template or a target reference block that are closest to the samples, to obtain samples in the adjacent region of the reference template.

In some embodiments, the second determining unit 2301 is further configured to that the samples in the adjacent region of the reference template being available includes at least one of:
the samples being within a boundary of a picture;
the samples being within a boundary of a tile; or
the samples having been reconstructed.

In some embodiments, the second determining unit 2301 is further configured to determine whether the samples in the adjacent region of the reference template exceed a preset search range; and in response to the samples in the adjacent region of the reference template not exceeding the preset search range, directly use the samples in the adjacent region of the reference template; or in response to the samples in the adjacent region of the reference template exceeding the preset search range, perform the padding processing on the adjacent region of the reference template by copying reconstructed samples in a target matching template or a target reference block that are closest to the samples, to obtain samples in the adjacent region of the reference template.

In some embodiments, the second determining unit 2301 is further configured to directly take, in response to the reference template meeting a second preset condition, the reference template as the matching template, and perform the operation of determining the model parameter according to the first template and the matching template.

In some embodiments, the reference template meeting the second preset condition includes: the reference template not meeting the first preset condition.

In some embodiments, the reference template meeting the second preset condition includes at least one of:
the reference template not being at a boundary of a picture;
the reference template not exceeding a preset search range;
all samples in the reference template having been reconstructed;
samples in the reference template being in a same tile with the current block; or
no samples outside the reference template being used.

In some embodiments, the second determining unit 2301 is further configured to perform padding processing on samples in the adjacent region of the reference block in response to the samples in the adjacent region of the reference block being used.

In some embodiments, the second determining unit 2301 is further configured to determine a template type of the current block; and determine the first template of the current block according to the template type of the current block.

In some embodiments, the second determining unit 2301 is further configured to determine the template type of the current block according to reference samples of the current block; where the reference samples of the current block include at least one of: left neighboring reference samples of the current block, top neighboring reference samples of the current block, top-left neighboring reference samples of the current block, bottom-left neighboring reference samples of the current block, or top-right neighboring reference samples of the current block.

In some embodiments, the second determining unit 2301 is further configured to determine that the template type of the current block is a first value in response to the left neighboring reference samples of the current block, the top neighboring reference samples of the current block and the top-left neighboring reference samples of the current block being all available; determine that the template type of the current block is a second value in response to the left neighboring reference samples of the current block being available; determine that the template type of the current block is a third value in response to the top neighboring reference samples of the current block being available; determine that the template type of the current block is a fourth value in response to the left neighboring reference samples of the current block and the top-left neighboring reference samples of the current block being all available; determine that the template type of the current block is a fifth value in response to the left neighboring reference samples of the current block and the bottom-left neighboring reference samples of the current block being all available; or determine that the template type of the current block is a sixth value in response to the top neighboring reference samples of the current block and the top-right neighboring reference samples of the current block being all available.

In some embodiments, the second determining unit 2301 is further configured to perform template matching within a preset search region according to the first template to determine the reference template; and determine the reference block according to the reference template.

In some embodiments, the second determining unit 2301 is further configured to perform a search within the preset search region based on the first template to determine a target block vector, and determine the reference template according to the target block vector.

In some embodiments, the second determining unit 2301 is further configured to decode a bitstream to determine a motion parameter; determine the reference block according to the motion parameter; and determine the reference template according to the first template and the reference block.

In some embodiments, the second determining unit 2301 is further configured to perform a first search within the preset search region to determine the target block vector; or perform a second search within the preset search region to determine the target block vector; where a search step corresponding to the first search is greater than a search step corresponding to the second search.

In some embodiments, the second determining unit 2301 is further configured to perform a first search within the preset search region to determine a first block vector, and determine an initial matching template according to the first block vector; and determine a first search region according to the initial matching template, and perform a second search within the first search region to determine the target block vector; where a search step corresponding to the first search is greater than a search step corresponding to the second search, and the first search region is smaller than the preset search region.

In some embodiments, the preset search region includes at least one sub-search region; and the second determining unit 2301 is further configured to perform the search within each of the at least one sub-search region respectively, to determine a respective best block vector of each sub-search region and a respective matching cost value corresponding to each sub-search region; determine a best block vector corresponding to a minimum matching cost value according to the respective best block vector of each sub-search region and the respective matching cost value corresponding to each sub-search region; and take the best block vector corresponding to the minimum matching cost value as the target block vector.

In some embodiments, the second determining unit 2301 is further configured to perform a first search within each of the at least one sub-search region respectively, to determine a respective best block vector of each sub-search region and a respective second search region corresponding to each sub-search region; perform region determination according to the respective best block vector of each sub-search region and the respective second search region corresponding to each sub-search region, to determine at least two target sub-search regions participating in a second search; perform the second search within the at least two target sub-search regions to determine a best block vector corresponding to the at least two target sub-search regions; and take the best block vector corresponding to the at least two target sub-search regions as the target block vector.

In some embodiments, the second determining unit 2301 is further configured to perform padding processing on the samples in the adjacent region of the matching template in response to that the samples in the adjacent region of the matching template need to be used.

In some embodiments, the model parameter includes coefficients of a target filter.

In some embodiments, the second determining unit 2301 is further configured to determine the coefficients of the target filter according to sample reference values in the first template and sample reference values in the matching template.

In some embodiments, the coefficients of the target filter are coefficients used by the target filter when a first error between output values obtained after processing is performed on the sample reference values in the matching template by the target filter and the sample reference values in the first template meets a first condition.

In some embodiments, the first condition is that the first error is minimum.

In some embodiments, the first condition is that the first error is within a first preset threshold range.

In some embodiments, the first condition is that variation magnitude of the first error is within a second preset threshold range.

In some embodiments, the second determining unit 2301 is further configured to determine an autocorrelation parameter according to the sample reference values in the matching template; determine a cross-correlation parameter according to the sample reference values in the first template and the sample reference values in the matching template; and determine the coefficients of the target filter according to the autocorrelation parameter and the cross-correlation parameter.

In some embodiments, a sample reference value includes at least one of: a sample reconstructed value, a sample gradient value or sample position information.

In some embodiments, a number of the coefficients of the target filter is equal to a first preset value.

In some embodiments, the second determining unit 2301 is further configured to decode a bitstream to determine a number of the coefficients of the target filter.

In some embodiments, the target filter is a one-dimensional or two-dimensional filter with a preset shape.

In some embodiments, the second determining unit 2301 is further configured to decode a bitstream to determine a shape of the target filter.

In some embodiments, the second filtering unit 2302 is further configured to perform the filtering processing on the reference block according to the model parameter to determine a first output value of the target filter; and determine the filtered reference block based on the first output value of the target filter.

In some embodiments, the second filtering unit 2302 is further configured to perform padding processing on the samples in the adjacent region of the reference block in response to that the samples in the adjacent region of the reference block need to be used.

In some embodiments, the second filtering unit 2302 is further configured to calculate a respective product of each sample reconstructed value of the reference block and a corresponding coefficient of the target filter; and set the first output value of the target filter to be equal to a sum of n products; where n represents a number of the coefficients of the target filter, and n is a positive integer.

In some embodiments, the second filtering unit 2302 is further configured to determine a respective first value of each sample reconstructed value of the reference block under a first mapping relationship; calculate a respective product of the respective first value and a corresponding coefficient of the target filter; and set the first output value of the target filter to be equal to a sum of n products; where n represents a number of the coefficients of the target filter, and n is a positive integer.

In some embodiments, the second filtering unit 2302 is further configured to determine a first bias value; and perform addition operation according to the first output value and the first bias value to determine the filtered reference block.

In some embodiments, the second filtering unit 2302 is further configured to set the first bias value to be equal to a second preset value.

In some embodiments, the second filtering unit 2302 is further configured to determine an (n+1)-th coefficient of the target filter in response to a number of the coefficients of the target filter being n; and determine the first bias value according to the (n+1)-th coefficient and a second bias value.

In some embodiments, the second filtering unit 2302 is further configured to set the second bias value to be equal to a third preset value; or set the second bias value to be equal to a value of a sample reconstructed value of the reference block under a second mapping relationship.

In some embodiments, the second prediction unit 2303 is further configured to perform second processing on the filtered reference block to obtain the prediction value of the current block.

In some embodiments, the second processing is to set the prediction value of the current block to be equal to the filtered reference block.

In some embodiments, the second processing is a clip operation of limiting the filtered reference block to a preset numerical range.

In some embodiments, the second prediction unit 2303 is further configured to determine a plurality of groups of model parameters according to the first template and the matching template; and construct a plurality of filter models according to the plurality of groups of model parameters, and perform the filtering processing on the reference block according to the plurality of filter models respectively, to determine a plurality of filtered reference blocks; and determine the prediction value of the current block according to the plurality of filtered reference blocks.

In some embodiments, the second prediction unit 2303 is further configured to perform weighted calculation on the plurality of filtered reference blocks to determine the prediction value of the current block.

In some embodiments, the second prediction unit 2303 is further configured to decode a bitstream to determine a target model index value; determine a corresponding target filter from the plurality of filter models according to the target model index value; and perform the filtering processing on the reference block according to the target filter to determine the prediction value of the current block.

In some embodiments, the second prediction unit 2303 is further configured to classify reconstructed samples in the first template and reconstructed samples in the matching template according to a preset manner respectively, to obtain a plurality of groups of sub-templates and a plurality of groups of sub-matching templates; and determine the plurality of groups of model parameters according to the plurality of groups of sub-templates and the plurality of groups of sub-matching templates.

In some embodiments, the second determining unit 2301 is further configured to decode a bitstream to determine a value of first syntax element flag information; and in response to the first syntax element flag information being used for indicating that intra template matching is applied to the current block, decode the bitstream to determine a value of second syntax element flag information; and in response to the second syntax element flag information being used for indicating that a filter model is applied to the current block, perform the operation of performing the filtering processing on the reference block according to the model parameter to determine the filtered reference block and the operation of determining the prediction value of the current block according to the filtered reference block.

In some embodiments, the second determining unit 2301 is further configured to take the reconstructed sample value in the reference block as the prediction value of the current block in response to the second syntax element flag information being used for indicating that the filter model is not applied to the current block.

In some embodiments, the second determining unit 2301 is further configured to decode a bitstream to determine a prediction residual of the current block; and determine the reconstructed value of the current block according to the prediction value of the current block and the prediction residual of the current block.

It may be understood that in the present embodiment, the “unit” may be part of a circuit, part of a processor, part of a program or software, or the like, and may also be a module or may be non-modular. Moreover, various components in the present embodiment may be integrated into one processing unit, or each unit may be physically present alone, or two or more units may be integrated into one unit. The above integrated units may be implemented in the form of hardware or software function modules.

The integrated unit may be stored in a computer readable storage when it is implemented in the form of software functional modules and is not sold or used as a separate product. Based on such understanding, the present embodiment provides a non-transitory computer-readable storage medium, which is applied to the decoder 230. The non-transitory computer-readable storage medium has a computer program stored thereon, and the computer program, when executed by the second processor, implements the decoding method described in any one of the above embodiments.

Based on a composition of the decoder 230 and the non-transitory computer-readable storage medium, referring to FIG. 24, a schematic diagram of a specific hardware structure of the decoder 230 provided by the embodiments of the present disclosure is illustrated. As illustrated in FIG. 24, the decoder 230 may include: a second communication interface 2401, a second memory 2402 and a second processor 2403. Each component is coupled together via a second bus system 2404. It may be understood that the second bus system 2404 is configured to achieve connection and communication between these components. In addition to a data bus, the second bus system 2404 further includes a power bus, a control bus and a status signal bus. However, for the sake of clarity, various buses are labeled as the second bus system 2404 in FIG. 24.

The second communication interface 2401 is configured to receive and transmit signals in the process of transmitting and receiving information with other external network elements.

The second memory 2402 is configured to store a computer program executable on the second processor 2403.

The second processor 2403 is configured to, when executing the computer program, perform:
determining a first template of a current block, and determining a reference template and a reference block;
in response to the reference template meeting a first preset condition, performing first processing on an adjacent region of the reference template to determine a matching template, and determining a model parameter according to the first template and the matching template;
performing filtering processing on the reference block according to the model parameter to determine a filtered reference block;
determining a prediction value of the current block according to the filtered reference block; and
determining a reconstructed value of the current block according to the prediction value of the current block.

Optionally, as another embodiment, the second processor 2403 is further configured to perform the decoding method described in any one of the above embodiments when executing the computer program.

It may be understood that the hardware functions of the second memory 2402 are similar to these of the first memory 2202, and the hardware functions of the second processor 2403 are similar to these of the first processor 2203, which will not be repeated here.

The present embodiment provides a decoder. For the decoder, the model parameter is determined based on the first template and the matching template. The model parameter fully reflects the correlation between the matching template and the first template of the current block, and the correlation is applied to the reference block, which may effectively correct the prediction value based on the intra template matching technique, thereby improving the prediction accuracy and saving bit rate, while may further improve the encoding and decoding efficiency, thereby improving the encoding and decoding performance.

In still another embodiment of the present disclosure, referring to FIG. 25, a schematic diagram of a composition structure of an encoding and decoding system provided by the embodiments of the present disclosure is illustrated. As illustrated in FIG. 25, the encoding and decoding system 250 may include an encoder 2501 and a decoder 2502.

In the embodiments of the present disclosure, the encoder 2501 may be the encoder described in any one of the above embodiments, and the decoder 2502 may be the decoder described in any one of the above embodiments.

It should be noted that, in the embodiments of the present disclosure, the terms “comprising”, “including” or any other variations thereof are intended to encompass a non-exclusive inclusion, so that a process, method, article or apparatus including a series of elements includes not only those elements, but also other elements not explicitly listed, or also includes elements inherent to such process, method, article or apparatus. Without more limitations, an element defined by the phrase “comprising a . . . ” does not exclude the presence of other identical elements in the process, method, article or apparatus comprising the element.

The serial numbers of the above embodiments of the present disclosure are for description only and do not represent the advantages or disadvantages of the embodiments.

The methods disclosed in several method embodiments provided in the present disclosure may be arbitrarily combined without conflict to obtain new method embodiments.

The features disclosed in several product embodiments provided in the present disclosure may be arbitrarily combined without conflict to obtain new product embodiments.

The features disclosed in several method or device embodiments provided in the present disclosure may be arbitrarily combined without conflict to obtain new method embodiments or device embodiments.

In a first clause, provided is a decoding method, which is applied to a decoder and includes: determining a first template of a current block, and determining a reference template and a reference block; in response to the reference template meeting a first preset condition, performing first processing on an adjacent region of the reference template to determine a matching template, and determining a model parameter according to the first template and the matching template; performing filtering processing on the reference block according to the model parameter to determine a filtered reference block; determining a prediction value of the current block according to the filtered reference block; and determining a reconstructed value of the current block according to the prediction value of the current block.

In a second clause, according to the method of the first clause, the matching template includes: samples in the reference template and samples in the adjacent region of the reference template.

In a third clause, according to the method of the first clause, the method further includes: in response to samples outside the reference template being used, determining that the reference template meets the first preset condition.

In a fourth clause, according to the method of the third clause, where in response to the reference template meeting the first preset condition, performing the first processing on the adjacent region of the reference template includes: in response to the samples outside the reference template being used, performing padding processing on samples in the adjacent region of the reference template.

In a fifth clause, according to the method of the fourth clause, where performing the padding processing on the samples in the adjacent region of the reference template includes: determining whether the samples in the adjacent region of the reference template are available; and in response to the samples in the adjacent region of the reference template being available, directly using the samples in the adjacent region of the reference template; or in response to the samples in the adjacent region of the reference template being unavailable, performing the padding processing on the adjacent region of the reference template by copying reconstructed samples in a target matching template or a target reference block that are closest to the samples, to obtain samples in the adjacent region of the reference template.

In a sixth clause, according to the method of the fifth clause, the samples in the adjacent region of the reference template being available includes at least one of: the samples being within a boundary of a picture; the samples being within a boundary of a tile; or the samples having been reconstructed.

In a seventh clause, according to the method of the fourth or fifth clause, where performing the padding processing on the samples in the adjacent region of the reference template includes: determining whether the samples in the adjacent region of the reference template exceed a preset search range; and in response to the samples in the adjacent region of the reference template not exceeding the preset search range, directly using the samples in the adjacent region of the reference template; or in response to the samples in the adjacent region of the reference template exceeding the preset search range, performing the padding processing on the adjacent region of the reference template by copying reconstructed samples in a target matching template or a target reference block that are closest to the samples, to obtain samples in the adjacent region of the reference template.

In an eighth clause, according to the method of the first clause, the method further includes: in response to the reference template meeting a second preset condition, directly taking the reference template as the matching template, and performing the operation of determining the model parameter according to the first template and the matching template.

In a ninth clause, according to the method of the eighth clause, the reference template meeting the second preset condition includes: the reference template not meeting the first preset condition.

In a tenth clause, according to the method of the eighth clause, where the reference template meeting the second preset condition includes at least one of: the reference template not being at a boundary of a picture; the reference template not exceeding a preset search range; all samples in the reference template having been reconstructed; samples in the reference template being in a same tile with the current block; or no samples outside the reference template being used.

In an eleventh clause, according to the first clause, where performing the filtering processing on the reference block according to the model parameter to determine the filtered reference block includes: in response to samples in the adjacent region of the reference block being used, performing padding processing on the samples in the adjacent region of the reference block.

In a twelfth clause, according to the method of the first clause, where determining the first template of the current block includes: determining a template type of the current block; and determining the first template of the current block according to the template type of the current block.

In a thirteenth clause, according to the method of the twelfth clause, where determining the template type of the current block includes: determining the template type of the current block according to reference samples of the current block; where the reference samples of the current block include at least one of: left neighboring reference samples of the current block, top neighboring reference samples of the current block, top-left neighboring reference samples of the current block, bottom-left neighboring reference samples of the current block, or top-right neighboring reference samples of the current block.

In a fourteenth clause, according to the method of the thirteenth clause, where determining the template type of the current block includes at least one of: determining that the template type of the current block is a first value in response to the left neighboring reference samples of the current block, the top neighboring reference samples of the current block and the top-left neighboring reference samples of the current block being all available; determining that the template type of the current block is a second value in response to the left neighboring reference samples of the current block being available; determining that the template type of the current block is a third value in response to the top neighboring reference samples of the current block being available; determining that the template type of the current block is a fourth value in response to the left neighboring reference samples of the current block and the top-left neighboring reference samples of the current block being all available; determining that the template type of the current block is a fifth value in response to the left neighboring reference samples of the current block and the bottom-left neighboring reference samples of the current block being all available; or determining that the template type of the current block is a sixth value in response to the top neighboring reference samples of the current block and the top-right neighboring reference samples of the current block being all available.

In a fifteenth clause, according to the method of the first clause, where determining the reference template and the reference block includes: performing template matching within a preset search region according to the first template to determine the reference template; and determining the reference block according to the reference template.

In a sixteenth clause, according to the method of the fifteenth clause, where performing the template matching within the preset search region according to the first template to determine the reference template includes: performing a search within the preset search region based on the first template to determine a target block vector, and determining the reference template according to the target block vector.

In a seventeenth clause, according to the first clause, where determining the reference template and the reference block includes: decoding a bitstream to determine a motion parameter; determining the reference block according to the motion parameter; and determining the reference template according to the first template and the reference block.

In an eighteenth clause, according to the method of the sixteenth clause, where performing the search within the preset search region based on the first template to determine the target block vector includes: performing a first search within the preset search region to determine the target block vector; or performing a second search within the preset search region to determine the target block vector; where a search step corresponding to the first search is greater than a search step corresponding to the second search.

In a nineteenth clause, according to the method of the sixteenth clause, where performing the search within the preset search region based on the first template to determine the target block vector includes: performing a first search within the preset search region to determine a first block vector, and determining an initial matching template according to the first block vector; and determining a first search region according to the initial matching template, and performing a second search within the first search region to determine the target block vector; where a search step corresponding to the first search is greater than a search step corresponding to the second search, and the first search region is smaller than the preset search region.

In a twentieth clause, according to the method of the sixteenth clause, where the preset search region includes at least one sub-search region, and performing the search within the preset search region based on the first template to determine the target block vector includes: performing the search within each of the at least one sub-search region respectively, to determine a respective best block vector of each sub-search region and a respective matching cost value corresponding to each sub-search region; determining a best block vector corresponding to a minimum matching cost value according to the respective best block vector of each sub-search region and the respective matching cost value corresponding to each sub-search region; and taking the best block vector corresponding to the minimum matching cost value as the target block vector.

In a twenty-first clause, according to the method of the twentieth clause, where performing the search within the preset search region based on the first template to determine the target block vector includes: performing a first search within each of the at least one sub-search region respectively, to determine a respective best block vector of each sub-search region and a respective second search region corresponding to each sub-search region; performing region determination according to the respective best block vector of each sub-search region and the respective second search region corresponding to each sub-search region, to determine at least two target sub-search regions participating in a second search; performing the second search within the at least two target sub-search regions to determine a best block vector corresponding to the at least two target sub-search regions; and taking the best block vector corresponding to the at least two target sub-search regions as the target block vector.

In a twenty-second clause, according to the method of the first clause, the model parameter includes coefficients of a target filter.

In a twenty-third clause, according to the method of the twenty-second clause, the method further includes: determining the coefficients of the target filter according to sample reference values in the first template and sample reference values in the matching template.

In a twenty-fourth clause, according to the method of the twenty-third clause, the coefficients of the target filter are coefficients used by the target filter when a first error between output values obtained after processing is performed on the sample reference values in the matching template by the target filter and the sample reference values in the first template meets a first condition.

In a twenty-fifth clause, according to the method of the twenty-fourth clause, the first condition is that the first error is minimum.

In a twenty-sixth clause, according to the method of the twenty-fourth clause, the first condition is that the first error is within a first preset threshold range.

In a twenty-seventh clause, according to the method of the twenty-fourth clause, the first condition is that variation magnitude of the first error is within a second preset threshold range.

In a twenty-eighth clause, according to the method of the twenty-third clause, where determining the coefficients of the target filter according to the sample reference values in the first template and the sample reference values in the matching template includes: determining an autocorrelation parameter according to the sample reference values in the matching template; determining a cross-correlation parameter according to the sample reference values in the first template and the sample reference values in the matching template; and determining the coefficients of the target filter according to the autocorrelation parameter and the cross-correlation parameter.

In a twenty-ninth clause, according to the method of the twenty-third clause, a sample reference value includes at least one of: a sample reconstructed value, a sample gradient value or sample position information.

In a thirtieth clause, according to the method of the twenty-second clause, a number of the coefficients of the target filter is equal to a first preset value.

In a thirty-first clause, according to the method of the twenty-second clause, the method further includes: decoding a bitstream to determine a number of the coefficients of the target filter.

In a thirty-second clause, according to the method of the twenty-second clause, the target filter is a one-dimensional or two-dimensional filter with a preset shape.

In a thirty-third clause, according to the method of the twenty-second clause, the method further includes: decoding a bitstream to determine a shape of the target filter.

In a thirty-fourth clause, according to the method of the twenty-second clause, where performing the filtering processing on the reference block according to the model parameter to determine the filtered reference block includes: performing the filtering processing on the reference block according to the model parameter to determine a first output value of the target filter; and determining the filtered reference block based on the first output value of the target filter.

In a thirty-fifth clause, according to the method of the thirty-fourth clause, where performing the filtering processing on the reference block according to the model parameter to determine the first output value of the target filter includes: calculating a respective product of each sample reconstructed value of the reference block and a corresponding coefficient of the target filter; and setting the first output value of the target filter to be equal to a sum of n products; where n represents a number of the coefficients of the target filter, and n is a positive integer.

In a thirty-sixth clause, according to the method of the thirty-fourth clause, where performing the filtering processing on the reference block according to the model parameter to determine the first output value of the target filter includes: determining a respective first value of each sample reconstructed value of the reference block under a first mapping relationship; calculating a respective product of the respective first value and a corresponding coefficient of the target filter; and setting the first output value of the target filter to be equal to a sum of n products; where n represents a number of the coefficients of the target filter, and n is a positive integer.

In a thirty-seventh clause, according to the method of the thirty-fourth clause, where determining the filtered reference block based on the first output value of the target filter includes: determining a first bias value; and performing addition operation according to the first output value and the first bias value to determine the filtered reference block.

In a thirty-eighth clause, according to the method of the thirty-seventh clause, where determining the first bias value includes: setting the first bias value to be equal to a second preset value.

In a thirty-ninth clause, according to the method of the thirty-seventh clause, where determining the first bias value includes: determining an (n+1)-th coefficient of the target filter in response to a number of the coefficients of the target filter being n; and determining the first bias value according to the (n+1)-th coefficient and a second bias value.

In a fortieth clause, according to the method of the thirty-ninth clause, the method further includes: setting the second bias value to be equal to a third preset value; or setting the second bias value to be equal to a value of a sample reconstructed value of the reference block under a second mapping relationship.

In a forty-first clause, according to the method of the first clause, where determining the prediction value of the current block according to the filtered reference block includes: performing second processing on the filtered reference block to obtain the prediction value of the current block.

In a forty-second clause, according to the method of the forty-first clause, the second processing being to set the prediction value of the current block to be equal to the filtered reference block.

In a forty-third clause, according to the method of the forty-first clause, the second processing is a clip operation of limiting the filtered reference block to a preset numerical range.

In a forty-fourth clause, according to the method of the first clause, the method further includes: determining a plurality of groups of model parameters according to the first template and the matching template; constructing a plurality of filter models according to the plurality of groups of model parameters, and performing the filtering processing on the reference block according to the plurality of filter models respectively, to determine a plurality of filtered reference blocks; and determining the prediction value of the current block according to the plurality of filtered reference blocks.

In a forty-fifth clause, according to the method of the forty-fourth clause, where determining the prediction value of the current block according to the plurality of filtered reference blocks includes: performing weighted calculation on the plurality of filtered reference blocks to determine the prediction value of the current block.

In a forty-sixth clause, according to the method of the forty-fourth clause, the method further includes: decoding a bitstream to determine a target model index value; determining a corresponding target filter from the plurality of filter models according to the target model index value; and performing the filtering processing on the reference block according to the target filter to determine the prediction value of the current block.

In a forty-seventh clause, according to the method of the forty-fourth clause, where determining the plurality of groups of model parameters according to the first template and the matching template includes: classifying reconstructed samples in the first template and reconstructed samples in the matching template according to a preset manner respectively, to obtain a plurality of groups of sub-templates and a plurality of groups of sub-matching templates; and determining the plurality of groups of model parameters according to the plurality of groups of sub-templates and the plurality of groups of sub-matching templates.

In a forty-eighth clause, according to the method of the first clause, the method further includes: decoding a bitstream to determine a value of first syntax element flag information; and in response to the first syntax element flag information being used for indicating that intra template matching is applied to the current block, decoding the bitstream to determine a value of second syntax element flag information; and in response to the second syntax element flag information being used for indicating that a filter model is applied to the current block, performing the operation of performing the filtering processing on the reference block according to the model parameter to determine the filtered reference block and the operation of determining the prediction value of the current block according to the filtered reference block.

In a forty-ninth clause, according to the method of the forty-eighth clause, the method further includes: in response to the second syntax element flag information being used for indicating that the filter model is not applied to the current block, taking the reconstructed sample value in the reference block as the prediction value of the current block.

In a fiftieth clause, according to the method of the any one of the first to forty-ninth clauses, where determining the reconstructed value of the current block according to the prediction value of the current block includes: decoding a bitstream to determine a prediction residual of the current block; and determining the reconstructed value of the current block according to the prediction value of the current block and the prediction residual of the current block.

In a fifty-first clause, provided is an encoding method, which is applied to an encoder and includes: determining a first template of a current block, and determining a reference template and a reference block; in response to the reference template meeting a first preset condition, performing first processing on an adjacent region of the reference template to determine a matching template, and determining a model parameter according to the first template and the matching template; performing filtering processing on the reference block according to the model parameter to determine a filtered reference block; determining a prediction value of the current block according to the filtered reference block; and determining a prediction residual of the current block according to the prediction value of the current block.

In a fifty-second clause, according to the method of the fifty-first clause, the matching template includes: samples in the reference template and samples in the adjacent region of the reference template.

In a fifty-third clause, according to the method of the fifty-first clause, the method further includes: in response to samples outside the reference template being used, determining that the reference template meets the first preset condition.

In a fifty-fourth clause, according to the method of the fifty-third clause, where in response to the reference template meeting the first preset condition, performing the first processing on the adjacent region of the reference template includes: in response to the samples outside the reference template being used, performing padding processing on samples in the adjacent region of the reference template.

In a fifty-fifth clause, according to the method of the fifty-fourth clause, where performing the padding processing on the samples in the adjacent region of the reference template includes: determining whether the samples in the adjacent region of the reference template are available; and in response to the samples in the adjacent region of the reference template being available, directly using the samples in the adjacent region of the reference template; or in response to the samples in the adjacent region of the reference template being unavailable, performing the padding processing on the adjacent region of the reference template by copying reconstructed samples in a target matching template or a target reference block that are closest to the samples, to obtain samples in the adjacent region of the reference template.

In a fifty-sixth clause, according to the method of the fifty-fifth clause, the samples in the adjacent region of the reference template being available includes at least one of: the samples being within a boundary of a picture; the samples being within a boundary of a tile; or the samples having been reconstructed.

In a fifty-seventh clause, according to the method of the fifty-fourth or fifty-fifth clause, where performing the padding processing on the samples in the adjacent region of the reference template includes: determining whether the samples in the adjacent region of the reference template exceed a preset search range; and in response to the samples in the adjacent region of the reference template not exceeding the preset search range, directly using the samples in the adjacent region of the reference template; or in response to the samples in the adjacent region of the reference template exceeding the preset search range, performing the padding processing on the adjacent region of the reference template by copying reconstructed samples in a target matching template or a target reference block that are closest to the samples, to obtain samples in the adjacent region of the reference template.

In a fifty-eighth clause, according to the method of the fifty-first clause, the method further includes: in response to the reference template meeting a second preset condition, directly taking the reference template as the matching template, and performing the operation of determining the model parameter according to the first template and the matching template.

In a fifty-ninth clause, according to the method of the fifty-eighth clause, the reference template meeting the second preset condition includes: the reference template not meeting the first preset condition.

In a sixtieth clause, according to the method of the fifty-eighth clause, the reference template meeting the second preset condition includes at least one of: the reference template not being at a boundary of a picture; the reference template not exceeding a preset search range; all samples in the reference template having been reconstructed; samples in the reference template being in a same tile with the current block; or no samples outside the reference template being used.

In a sixty-first clause, according to the method of the fifty-first clause, where performing the filtering processing on the reference block according to the model parameter to determine the filtered reference block includes: in response to samples in the adjacent region of the reference block being used, performing padding processing on the samples in the adjacent region of the reference block.

In a sixty-second clause, according to the method of the fifty-first clause, where determining the first template of the current block includes: determining a template type of the current block; and determining the first template of the current block according to the template type of the current block.

In a sixty-third clause, according to the method of the sixty-second clause, where determining the template type of the current block includes: determining the template type of the current block according to reference samples of the current block; where the reference samples of the current block include at least one of: left neighboring reference samples of the current block, top neighboring reference samples of the current block, top-left neighboring reference samples of the current block, bottom-left neighboring reference samples of the current block, or top-right neighboring reference samples of the current block.

In a sixty-fourth clause, according to the method of the sixty-third clause, where determining the template type of the current block includes: determining that the template type of the current block is a first value in response to the left neighboring reference samples of the current block, the top neighboring reference samples of the current block and the top-left neighboring reference samples of the current block being all available; determining that the template type of the current block is a second value in response to the left neighboring reference samples of the current block being available; determining that the template type of the current block is a third value in response to the top neighboring reference samples of the current block being available; determining that the template type of the current block is a fourth value in response to the left neighboring reference samples of the current block and the top-left neighboring reference samples of the current block being all available; determining that the template type of the current block is a fifth value in response to the left neighboring reference samples of the current block and the bottom-left neighboring reference samples of the current block being all available; or determining that the template type of the current block is a sixth value in response to the top neighboring reference samples of the current block and the top-right neighboring reference samples of the current block being all available.

In a sixty-fifth clause, according to the method of the fifty-first clause, where determining the matching template and the reference block includes: performing template matching within a preset search region according to the first template to determine the matching template; and determining the reference block according to the matching template.

In a sixty-sixth clause, according to the method of the sixty-fifth clause, where performing the template matching within the preset search region according to the first template to determine the matching template includes: performing a search within the preset search region based on the first template to determine a target block vector, and determining the matching template according to the target block vector.

In a sixty-seventh clause, according to the method of the fifty-first clause, where determining the matching template and the reference block includes: determining a motion parameter and a corresponding reference block; and determining the matching template according to the first template and the reference block; accordingly, the method further includes: encoding the motion parameter, and signalling an obtained encoded bit into a bitstream.

In a sixty-eighth clause, according to the method of the sixty-sixth clause, where performing the search within the preset search region based on the first template to determine the target block vector includes: performing a first search within the preset search region to determine the target block vector; or performing a second search within the preset search region to determine the target block vector; where a search step corresponding to the first search is greater than a search step corresponding to the second search.

In a sixty-ninth clause, according to the method of the sixty-sixth clause, where performing the search within the preset search region based on the first template to determine the target block vector includes: performing a first search within the preset search region to determine a first block vector, and determining an initial matching template according to the first block vector; and determining a first search region according to the initial matching template, and performing a second search within the first search region to determine the target block vector; where a search step corresponding to the first search is greater than a search step corresponding to the second search, and the first search region is smaller than the preset search region.

In a seventieth clause, according to the method of the sixty-sixth clause, where the preset search region includes at least one sub-search region, and performing the search within the preset search region based on the first template to determine the target block vector includes: performing the search within each of the at least one sub-search region respectively, to determine a respective best block vector of each sub-search region and a respective matching cost value corresponding to each sub-search region; determining a best block vector corresponding to a minimum matching cost value according to the respective best block vector of each sub-search region and the respective matching cost value corresponding to each sub-search region; and taking the best block vector corresponding to the minimum matching cost value as the target block vector.

In a seventy-first clause, according to the method of the seventieth clause, where performing the search within the preset search region based on the first template to determine the target block vector includes: performing a first search within each of the at least one sub-search region respectively, to determine a respective best block vector of each sub-search region and a respective second search region corresponding to each sub-search region; performing region determination according to the respective best block vector of each sub-search region and the respective second search region corresponding to each sub-search region to determine at least two target sub-search regions participating in a second search; performing the second search within the at least two target sub-search regions to determine a best block vector corresponding to the at least two target sub-search regions; and taking the best block vector corresponding to the at least two target sub-search regions as the target block vector.

In a seventy-second clause, according to the method of the fifty-first clause, the model parameter includes coefficients of a target filter.

In a seventy-third clause, according to the method of the seventy-second clause, the method further includes: determining the coefficients of the target filter according to sample reference values in the first template and sample reference values in the matching template.

In a seventy-fourth clause, according to the method of the seventy-third clause, the coefficients of the target filter are coefficients used by the target filter when a first error between output values obtained after processing is performed on the sample reference values in the matching template by the target filter and the sample reference values in the first template meets a first condition.

In a seventy-fifth clause, according to the method of the seventy-fourth clause, the first condition is that the first error is minimum.

In a seventy-sixth clause, according to the method of the seventy-fourth clause, the first condition is that the first error is within a first preset threshold range.

In a seventy-seventh clause, according to the method of the seventy-fourth clause, the first condition is that variation magnitude of the first error is within a second preset threshold range.

In a seventy-eighth clause, according to the method of the seventy-third clause, where determining the coefficients of the target filter according to the sample reference values in the first template and the sample reference values in the matching template includes: determining an autocorrelation parameter according to the sample reference values in the matching template; determining a cross-correlation parameter according to the sample reference values in the first template and the sample reference values in the matching template; and determining the coefficients of the target filter according to the autocorrelation parameter and the cross-correlation parameter.

In a seventy-ninth clause, according to the method of the seventy-third clause, a sample reference value includes at least one of: a sample reconstructed value, a sample gradient value or sample position information.

In an eightieth clause, according to the method of the seventy-second clause, a number of the coefficients of the target filter is equal to a first preset value.

In an eighty-first clause, according to the method of the seventy-second clause, the method further includes: determining a number of the coefficients of the target filter; and encoding the number of the coefficients of the target filter, and signalling an obtained encoded bit into a bitstream.

In an eighty-second clause, according to the method of the seventy-second clause, the target filter is a one-dimensional or two-dimensional filter with a preset shape.

In an eighty-third clause, according to the method of the seventy-second clause, the method further includes: determining a shape of the target filter; and encoding the shape of the target filter, and signalling an obtained encoded bit into a bitstream.

In an eighty-fourth clause, according to the method of the seventy-second clause, where performing the filtering processing on the reference block according to the model parameter to determine the filtered reference block includes: performing the filtering processing on the reference block according to the model parameter to determine a first output value of the target filter; and determining the filtered reference block based on the first output value of the target filter.

In an eighty-fifth clause, according to the method of the eighty-fourth clause, where performing the filtering processing on the reference block according to the model parameter to determine the first output value of the target filter includes: calculating a respective product of each sample reconstructed value of the reference block and a corresponding coefficient of the target filter; and setting the first output value of the target filter to be equal to a sum of n products; where n represents a number of the coefficients of the target filter, and n is a positive integer.

In an eighty-sixth clause, according to the method of the eighty-fourth clause, where performing the filtering processing on the reference block according to the model parameter to determine the first output value of the target filter includes: determining a respective first value of each sample reconstructed value of the reference block under a first mapping relationship; calculating a respective product of the respective first value and a corresponding coefficient of the target filter; and setting the first output value of the target filter to be equal to a sum of n products; where n represents a number of the coefficients of the target filter, and n is a positive integer.

In an eighty-seventh clause, according to the method of the eighty-fourth clause, where determining the filtered reference block based on the first output value of the target filter includes: determining a first bias value; and performing addition operation according to the first output value and the first bias value to determine the filtered reference block.

In an eighty-eighth clause, according to the method of the eighty-seventh clause, where determining the first bias value includes: setting the first bias value to be equal to a second preset value.

In an eighty-ninth clause, according to the method of the eighty-seventh clause, where determining the first bias value includes: determining an (n+1)-th coefficient of the target filter in response to a number of the coefficients of the target filter being n; and determining the first bias value according to the (n+1)-th coefficient and a second bias value.

In a ninetieth clause, according to the method of the eighty-ninth clause, the method further includes: setting the second bias value to be equal to a third preset value; or setting the second bias value to be equal to a value of a sample reconstructed value of the reference block under a second mapping relationship.

In a ninety-first clause, according to the method of the fifty-first clause, where determining the prediction value of the current block according to the filtered reference block includes: performing second processing on the filtered reference block to obtain the prediction value of the current block.

In a ninety-second clause, according to the method of the ninety-first clause, the second processing is to set the prediction value of the current block to be equal to the filtered reference block.

In a ninety-third clause, according to the method of the ninety-first clause, the second processing is a clip operation of limiting the filtered reference block to a preset numerical range.

In a ninety-fourth clause, according to the method of the fifty-first clause, the method further includes: determining a plurality of groups of model parameters according to the first template and the matching template; constructing a plurality of filter models according to the plurality of groups of model parameters, and performing the filtering processing on the reference block according to the plurality of filter models respectively, to determine a plurality of filtered reference blocks; and determining the prediction value of the current block according to the plurality of filtered reference blocks.

In a ninety-fifth clause, according to the method of the ninety-fourth clause, where determining the prediction value of the current block according to the plurality of filtered reference blocks includes: performing weighted calculation on the plurality of filtered reference blocks to determine the prediction value of the current block.

In a ninety-sixth clause, according to the method of the ninety-fourth clause, the method further includes: determining a target filter from the plurality of filter models; and performing the filtering processing on the reference block according to the target filter to determine the prediction value of the current block.

In a ninety-seventh clause, according to the method of the ninety-sixth clause, the method further includes: determining a target model index value, where the target model index value is used for indicating an index number of the target filter in the plurality of filter models; and encoding the target model index value, and signalling an obtained encoded bit into a bitstream.

In a ninety-eighth clause, according to the method of the ninety-sixth clause, where determining the target filter from the plurality of filter models includes: determining an original value of the current block; performing rate-distortion cost calculation according to the original value of the current block and a plurality of initial prediction values of the current block respectively, to determine a respective rate-distortion cost value of each of the plurality of initial prediction values; determining a minimum rate-distortion cost value from the respective rate-distortion cost values of each of the plurality of initial prediction values; and taking a filter model corresponding to the minimum rate-distortion cost value as the target filter.

In a ninety-ninth clause, according to the method of the ninety-fourth clause, where determining the plurality of groups of model parameters according to the first template and the matching template includes: classifying reconstructed samples in the first template and reconstructed samples in the matching template according to a preset method respectively, to obtain a plurality of groups of sub-templates and a plurality of groups of sub-matching templates; and determining the plurality of groups of model parameters according to the plurality of groups of sub-templates and the plurality of groups of sub-matching templates.

In a hundredth clause, according to the method of the fifty-first clause, the method further includes: determining a value of first syntax element flag information, where the first syntax element flag information is used for indicating whether intra template matching is applied to the current block; and encoding the value of the first syntax element flag information, and signalling an obtained encoded bit into a bitstream.

In a one hundred and first clause, according to the method of the hundredth clause, where determining the value of the first syntax element flag information includes: in response to the intra template matching being applied to the current block, determining that the value of the first syntax element flag information is a first value; or in response to the intra template matching not being applied to the current block, determining that the value of the first syntax element flag information is a second value.

In a one hundred and second clause, according to the method of the hundredth clause, in response to the first syntax element flag information being used for indicating that the intra template matching is applied to the current block, the method further includes: determining a value of second syntax element flag information, where the second syntax element flag information is used for indicating whether a filter model is applied to the current block; and encoding the value of the second syntax element flag information, and signalling an obtained encoded bits into the bitstream.

In a one hundred and third clause, according to the method of the one hundred and second clause, where determining the value of the second syntax element flag information includes: in response to the filter model being applied to the current block, determining that the value of the second syntax element flag information is a first value; or in response to the filter model being not applied to the current block, determining that the value of the second syntax element flag information is a second value.

In a one hundred and fourth clause, according to the method of the one hundred and second clause, the method further includes: in response to the filter model being applied to the current block, performing the operation of performing the filtering processing on the reference block according to the model parameter to determine the filtered reference block and the operation of determining the prediction value of the current block according to the filtered reference block; or in response to the filter model being not applied to the current block, using the reconstructed sample value in the reference block as the prediction value of the current block.

In a one hundred and fifth clause, according to the method of the any one of the fifty-first to one hundred and fourth clauses, where determining the prediction residual of the current block according to the prediction value of the current block includes: determining an original value of the current block; and determining the prediction residual of the current block according to the original value of the current block and the prediction value of the current block.

In a one hundred and sixth clause, provided is a bitstream, where the bitstream is generated by bit encoding according to information to be encoded; where the information to be encoded includes at least one of: a prediction residual of a current block, a number of coefficients of a target filter, a shape of a target filter, a value of first syntax element flag information or a value of second syntax element flag information; where the first syntax element flag information is used for indicating whether intra template matching is applied to the current block, and the second syntax element flag information is used for indicating whether a filter model is applied to the current block.

In a one hundred and seventh clause, provided is an encoder, which includes: a first determining unit, a first filtering unit and a first prediction unit; where the first determining unit is configured to determine a first template of a current block, and determine a reference template and a reference block; and further configured to perform first processing on an adjacent region of the reference template in response to the reference template meeting a first preset condition, to determine a matching template, and determine a model parameter according to the first template and the matching template; the first filtering unit is configured to perform filtering processing on the reference block according to the model parameter to determine a filtered reference block; the first prediction unit is configured to determine a prediction value of the current block according to the filtered reference block; and the first determining unit is further configured to determine a prediction residual of the current block according to the prediction value of the current block.

In a one hundred and eighth clause, provided is an encoder, which includes: a first memory and a first processor; where the first memory is configured to store a computer program executable on the first processor; and the first processor is configured to perform the method according to any one of the fifty-first to one hundred and fifth clauses when executing the computer program.

In a one hundred and ninth clause, provided is a decoder, which includes: a second determining unit, a second filtering unit and a second prediction unit; where the second III determination unit is configured to determine a first template of a current block, and determine a reference template and a reference block; and further configured to perform first processing on an adjacent region of the reference template in response to the reference template meeting a first preset condition, to determine a matching template, and determine a model parameter according to the first template and the matching template; the second filtering unit is configured to perform filtering processing on the reference block according to the model parameter to determine a filtered reference block; the second prediction unit is configured to determine a prediction value of the current block according to the filtered reference block; and the second determining unit is further configured to determine a reconstructed value of the current block according to the prediction value of the current block.

In a one hundred and tenth clause, provided is a decoder, which includes: a second memory and a second processor; where the second memory is configured to store a computer program executable on the second processor; and the second processor is configured to perform the method according to any one of the first to fiftieth clauses when executing the computer program.

In a one hundred and eleventh clause, provided is a computer-readable storage medium, having a computer program stored thereon, where the computer program, when executed, implements the method according to any one of the first to fiftieth clauses, or implements the method according to any one of the fifty-first to one hundred and fifth clauses.

The foregoing are merely specific implementations of the present disclosure, but the protection scope of the present disclosure is not limited thereto. Any person skilled in the art may readily conceive variations or substitutions within the technical scope disclosed by the present disclosure, which should be included within the protection scope of the present disclosure. Therefore, the protection scope of the present disclosure shall be subject to the protection scope of the claims.

### INDUSTRIAL APPLICABILITY

Whether at an encoding side or a decoding side, the first template of the current block is determined, and the reference template and the reference block are determined; in response to the reference template meeting the first preset condition, the first processing is performed on the adjacent region of the reference template to determine the matching template, and the model parameter is determined according to the first template and the matching template; the filtering processing is performed on the reference block according to the model parameter to determine the filtered reference block; and the prediction value of the current block is determined according to the filtered reference block. In this way, at the encoding side, the prediction residual of the current block may be determined according to the prediction value of the current block; so that at the decoding side, the reconstructed value of the current block may be determined according to the prediction value of the current block. That is, the model parameter is determined according to the first template and the matching template, the model parameter fully reflects the correlation between the matching template and the first template of the current block, the correlation is applied to the reference block, and then, by performing filtering and correction on the reconstructed sample of the reference block, the filtered reconstructed sample is used as the prediction sample of the current block. As such, the prediction accuracy may be improved and bit rate may be reduced, while the encoding and decoding efficiency may also be improved, thereby enhancing the encoding and decoding performance.

What is claimed is:

1. A decoding method, applied to a decoder and comprising:
determining a first template of a current block, and determining a reference template and a reference block;
in response to the reference template meeting a first preset condition, performing first processing on an adjacent region of the reference template to determine a matching template, and determining a model parameter according to the first template and the matching template;
performing filtering processing on the reference block according to the model parameter to determine a filtered reference block;
determining a prediction value of the current block according to the filtered reference block; and
determining a reconstructed value of the current block according to the prediction value of the current block.

2. The method according to claim 1, wherein the matching template comprises: samples in the reference template and samples in the adjacent region of the reference template.

3. The method according to claim 1, further comprising:
in response to samples outside the reference template being used, determining that the reference template meets the first preset condition.

4. The method according to claim 3, wherein in response to the reference template meeting the first preset condition, performing the first processing on the adjacent region of the reference template comprises:
in response to the samples outside the reference template being used, performing padding processing on samples in the adjacent region of the reference template;
wherein performing the padding processing on the samples in the adjacent region of the reference template comprises:
determining whether the samples in the adjacent region of the reference template are available; and
in response to the samples in the adjacent region of the reference template being available, directly using the samples in the adjacent region of the reference template; or
in response to the samples in the adjacent region of the reference template being unavailable, performing the padding processing on the adjacent region of the reference template by copying reconstructed samples in a target matching template or a target reference block that are closest to the samples, to obtain samples in the adjacent region of the reference template.

5. The method according to claim 4, wherein the samples in the adjacent region of the reference template being available comprises at least one of:
the samples being within a boundary of a picture;
the samples being within a boundary of a tile; or
the samples having been reconstructed.

6. The method according to claim 4, wherein performing the padding processing on the samples in the adjacent region of the reference template comprises:
determining whether the samples in the adjacent region of the reference template exceed a preset search range; and
in response to the samples in the adjacent region of the reference template not exceeding the preset search range, directly using the samples in the adjacent region of the reference template; or
in response to the samples in the adjacent region of the reference template exceeding the preset search range, performing the padding processing on the adjacent region of the reference template by copying reconstructed samples in a target matching template or a target reference block that are closest to the samples, to obtain samples in the adjacent region of the reference template.

7. The method according to claim 1, wherein performing the filtering processing on the reference block according to the model parameter to determine the filtered reference block comprises:
in response to samples in the adjacent region of the reference block being used, performing padding processing on the samples in the adjacent region of the reference block.

8. The method according to claim 1, wherein determining the first template of the current block comprises:
determining a template type of the current block; and
determining the first template of the current block according to the template type of the current block;
wherein determining the template type of the current block comprises:
determining the template type of the current block according to reference samples of the current block;
wherein the reference samples of the current block comprise at least one of: left neighboring reference samples of the current block, top neighboring reference samples of the current block, top-left neighboring reference samples of the current block, bottom-left neighboring reference samples of the current block, or top-right neighboring reference samples of the current block.

9. The method according to claim 8, wherein determining the template type of the current block comprises at least one of:
determining that the template type of the current block is a first value in response to the left neighboring reference samples of the current block, the top neighboring reference samples of the current block and the top-left neighboring reference samples of the current block being all available;
determining that the template type of the current block is a second value in response to the left neighboring reference samples of the current block being available;
determining that the template type of the current block is a third value in response to the top neighboring reference samples of the current block being available;
determining that the template type of the current block is a fourth value in response to the left neighboring reference samples of the current block and the top-left neighboring reference samples of the current block being all available;
determining that the template type of the current block is a fifth value in response to the left neighboring reference samples of the current block and the bottom-left neighboring reference samples of the current block being all available; or
determining that the template type of the current block is a sixth value in response to the top neighboring reference samples of the current block and the top-right neighboring reference samples of the current block being all available.

10. The method according to claim 1, wherein determining the reference template and the reference block comprises:
performing template matching within a preset search region according to the first template to determine the reference template; and
determining the reference block according to the reference template;
wherein performing the template matching within the preset search region according to the first template to determine the reference template comprises:
performing a search within the preset search region based on the first template to determine a target block vector, and determining the reference template according to the target block vector.

11. The method according to claim 10, wherein performing the search within the preset search region based on the first template to determine the target block vector comprises:
performing a first search within the preset search region to determine the target block vector; or
performing a second search within the preset search region to determine the target block vector;
wherein a search step corresponding to the first search is greater than a search step corresponding to the second search.

12. The method according to claim 10, wherein performing the search within the preset search region based on the first template to determine the target block vector comprises:
performing a first search within the preset search region to determine a first block vector, and determining an initial matching template according to the first block vector; and
determining a first search region according to the initial matching template, and performing a second search within the first search region to determine the target block vector;
wherein a search step corresponding to the first search is greater than a search step corresponding to the second search, and the first search region is smaller than the preset search region.

13. The method according to claim 10, wherein the preset search region comprises at least one sub-search region, and performing the search within the preset search region based on the first template to determine the target block vector comprises:
performing the search within each of the at least one sub-search region respectively, to determine a respective best block vector of each sub-search region and a respective matching cost value corresponding to each sub-search region;
determining a best block vector corresponding to a minimum matching cost value according to the respective best block vector of each sub-search region and the respective matching cost value corresponding to each sub-search region; and
taking the best block vector corresponding to the minimum matching cost value as the target block vector.

14. The method according to claim 13, wherein performing the search within the preset search region based on the first template to determine the target block vector comprises:
performing a first search within each of the at least one sub-search region respectively, to determine a respective best block vector of each sub-search region and a respective second search region corresponding to each sub-search region;
performing region determination according to the respective best block vector of each sub-search region and the respective second search region corresponding to each sub-search region, to determine at least two target sub-search regions participating in a second search;
performing the second search within the at least two target sub-search regions to determine a best block vector corresponding to the at least two target sub-search regions; and
taking the best block vector corresponding to the at least two target sub-search regions as the target block vector.

15. The method according to claim 1, wherein
the model parameter comprising coefficients of a target filter; and
the method further comprises:
determining the coefficients of the target filter according to sample reference values in the first template and sample reference values in the matching template;
wherein the coefficients of the target filter are coefficients used by the target filter when a first error between output values obtained after processing is performed on the sample reference values in the matching template by the target filter and the sample reference values in the first template meets a first condition.

16. The method according to claim 15, wherein determining the coefficients of the target filter according to the sample reference values in the first template and the sample reference values in the matching template comprises:
determining an autocorrelation parameter according to the sample reference values in the matching template;
determining a cross-correlation parameter according to the sample reference values in the first template and the sample reference values in the matching template; and
determining the coefficients of the target filter according to the autocorrelation parameter and the cross-correlation parameter.

17. The method according to claim 15, wherein performing the filtering processing on the reference block according to the model parameter to determine the filtered reference block comprises:
performing the filtering processing on the reference block according to the model parameter to determine a first output value of the target filter; and
determining the filtered reference block based on the first output value of the target filter.

18. The method according to claim 17, wherein performing the filtering processing on the reference block according to the model parameter to determine the first output value of the target filter comprises:
calculating a respective product of each sample reconstructed value of the reference block and a corresponding coefficient of the target filter; and
setting the first output value of the target filter to be equal to a sum of n products; wherein n represents a number of the coefficients of the target filter, and n is a positive integer;
or
wherein performing the filtering processing on the reference block according to the model parameter to determine the first output value of the target filter comprises:
determining a respective first value of each sample reconstructed value of the reference block under a first mapping relationship;
calculating a respective product of the respective first value and a corresponding coefficient of the target filter; and
setting the first output value of the target filter to be equal to a sum of n products; wherein n represents a number of the coefficients of the target filter, and n is a positive integer.

19. The method according to claim 17, wherein determining the filtered reference block based on the first output value of the target filter comprises:
determining a first bias value; and
performing addition operation according to the first output value and the first bias value to determine the filtered reference block.

20. The method according to claim 1, wherein determining the prediction value of the current block according to the filtered reference block comprises:
performing second processing on the filtered reference block to obtain the prediction value of the current block;
wherein the second processing is a clip operation of limiting the filtered reference block to a preset numerical range.

21. The method according to claim 1, wherein determining the reconstructed value of the current block according to the prediction value of the current block comprises:
decoding a bitstream to determine a prediction residual of the current block; and
determining the reconstructed value of the current block according to the prediction value of the current block and the prediction residual of the current block.

22. An encoding method, applied to an encoder and comprising:
determining a first template of a current block, and determining a reference template and a reference block;
in response to the reference template meeting a first preset condition, performing first processing on an adjacent region of the reference template to determine a matching template, and determining a model parameter according to the first template and the matching template;
performing filtering processing on the reference block according to the model parameter to determine a filtered reference block;
determining a prediction value of the current block according to the filtered reference block; and
determining a prediction residual of the current block according to the prediction value of the current block.

23. A non-transitory computer-readable storage medium, having a computer program and a bitstream stored thereon, wherein the computer program, when executed by a processor, enables the processor to perform following steps to generate the bitstream:
determining a first template of a current block, and determining a reference template and a reference block;
in response to the reference template meeting a first preset condition, performing first processing on an adjacent region of the reference template to determine a matching template, and determining a model parameter according to the first template and the matching template;
performing filtering processing on the reference block according to the model parameter to determine a filtered reference block;
determining a prediction value of the current block according to the filtered reference block; and
determining a prediction residual of the current block according to the prediction value of the current block.
